(19) United States
(12) Patent Application Publication
(10) Pub. No.: US 2003/0086829 A1
(43) Pub. Date: May 8, 2003

(54) High throughput chemical synthesizer

(76) Inventors: Eric A. Livesay, Fort Worth, TX (US); Joel P. Irick, Durham, NC (US); Ying-Horng Liu, Dallas, TX (US); Kevin J. Luebke, Dallas, TX (US); Stephen A. Johnston, Dallas, TX (US); Yuri Belosludstev, The Woodlands, TX (US)

Correspondence Address: Gardere Wynne Sewell LLP, 3000 Thanksgiving Tower, Suite 3000, 1601 Elm Street, Dallas, TX, 75201-4767, US

(21) Appl. No.: 10/004,487

(22) Filed: Oct. 24, 2001

(51) Int. Cl. B01J 19/00

(52) U.S. Cl. 422/102; 422/130; 422/131; 216/12

(57) ABSTRACT

A high throughput oligonucleotide synthesizer is described that includes masks for selectively deblocking of oligonucleotide synthesis sites and the simultaneous addition of reagents to all wells of the plate. The synthesizer includes a multi-well plate, each well of which contains a substrate for oligonucleotide synthesis. The use of masks expedites oligonucleotide synthesis by allowing for rapid delivery of reagents to all wells simultaneously.

### TECHNICAL FIELD OF THE INVENTION

The invention relates generally to oligonucleotide synthesizers and specifically to a high throughput oligonucleotide synthesizer that uses “flooding” and one or more masks to perform oligonucleotide synthesis.

### BACKGROUND OF THE INVENTION

The present surge in genomic research, concomitant with the completion of several genome projects, and the anticipated investigation of several new organisms requires rapid oligonucleotide synthesis. In general, each gene requires two oligonucleotides for its amplification. As an example, 100,000 oligonucleotides would be needed to study gene expression in an organism having 50,000 genes. This quantity of oligonucleotides exceeds greatly the capacity of present oligonucleotide synthesizers.

One example of the chemical synthesis of DNA proceeds by sequential addition of one of four monomer bases (adenine (A), guanine (G), thymine (T), and cytosine (C)) to a growing chain of DNA. In vitro synthesis is initiated on a solid support (typically, controlled pore glass, CPG) that has been derivatized with a selectively cleavable linker that often includes the first monomer unit. The first reaction “deprotects” or “deblocks” the linker, thereby making it available for reaction with the next monomer unit, which is in the form of, e.g., a base phosphoramidite. The next monomer unit is coupled to the deblocked end as a reactive phosphoramidite, and unreacted termini are subsequently acetylated to prevent unwanted additions that may occur in future rounds of synthesis. The new chemical bond formed with the phosphoramidite is oxidized to create a stable linkage. Each new round of synthesis adds a monomer in the chain. At the completion of synthesis, the oligonucleotide is cleaved from the solid support.

Current synthesizers generally use one of two methods to deliver reagents for oligonucleotide or peptide synthesis. In one method, reagents enter a fixed column of CPGs through a common port. The columns can be loaded simultaneously, and each column produces a unique oligonucleotide. A second method uses an XY positioning system to move a multi-well plate under a series of reagent injection heads or valves. Each well contains the CPG-oligonucleotide substrate. The plates are moved under the injection heads in such a way that the appropriate base is added to each well. In this manner, unique oligonucleotide synthesis occurs in each well. The time involved in plate movement, however, limits both the rate of synthesis and the well density of the plates that can be used. Further, the large number of injection heads increases the likelihood for failure, as blockage of valves is likely to occur.

### SUMMARY OF THE INVENTION

Currently, the rate of high throughput DNA synthesis is either limited by the rate at which a multi-well filter plate can be positioned under a series of injection heads or by the number of columns that can be simultaneously loaded. The present invention uses one or more “masks” that allow for rapid, simultaneous delivery of reagents to the wells of the plate while allowing for selective deprotection of the CPG substrate within some wells of the plate. With these masks, the capacity for high throughput DNA synthesis is increased while still allowing unique oligonucleotide synthesis to occur in each well.

In one embodiment, the apparatus includes a substrate, e.g., a plate, containing one or more wells, a mask containing one or more holes, a series of linear delivery heads, injectors or injection heads in a manifold, and a linear drive to move the plate and/or the delivery heads. The substrate is mounted on a movable stand. The plate may be made of a chemically nonreactive material, e.g., Delrin or other similar polymers. Each delivery head or manifold may include one or more one inlet and one or more outlets, which will generally match the number of positions on the substrate, e.g., holes in a plate and/or the mask.

The one or more masks are positioned between the substrate and the delivery heads at distinct time points. The one or more masks may be flexible or hard and may even be disposable. The mobility of the masks will generally be conferred by a machine that positions the mask over a car and removes the mask from the plate. The masks may be made of, e.g., Teflon™ or another chemically resistant material in which holes can be punched, and can range in thickness from, e.g. 0.002 to 0.25 inches.

In one embodiment, the apparatus uses a substrate that is a multi-well filter plate. The multi-well filter plate may further include a semi-permeable membrane, a top plate and a bottom plate arranged in such a way that the membrane is sandwiched between the top and bottom plates. The top and bottom plates contain one or more wells. Each well contains a substrate for chemical synthesis. Each well may further include, e.g., two ledges that support two frits, one positioned at the bottom of the well and the other frit positioned at the top of the well. The top frit may serve to retain the substrate in the well. In this embodiment, the plate may be attached to a vacuum source to allow the removal of reagents from the wells. Each well of the plate may contain one or more substrate with synthesis intermediates. The synthesis intermediates may include a reactive group with a removable protecting linker. One such synthesis intermediate may be, e.g., derivatized controlled pore glass (CPG).

In one embodiment, the apparatus may be used for multimer synthesis, wherein the wells of the plate contain a CPG derivative as a substrate and the synthesis intermediate is an oligonucleotide, a peptide, a carbohydrate, an inorganic polymer, an organic polymer or combinations thereof. In one embodiment, the apparatus includes one or more movable masks. One or more linear rows of delivery heads may be used to direct polymer synthesis by the individual addition of monomers to a polymer chain.

A method of the present invention may include the step of attaching a mask to a substrate, e.g., a plate. Next, a deblocking reagent is flooded over the surface of the plate to remove the protecting linker from the synthesis intermediate in the wells not covered by the mask. The mask is then moved away from the plate. For example, an A, G, C, T and/or U phosphoramidite is added to all the wells. A mix of cap A and B reagents is added to all wells, and the wells are flooded with oxidizing reagent. The control of the synthesis in this example is controlled at the deblocking step. Alternatively, the control of the monomer addition may be under the control of the mask positioned on the plate, wherein the mask protect the substrate in the well from the addition of the monomer that is to be excluded from being added to the lengthening polymer chain. Algorithms that ensure that the minimal number of masks is used are also described herein.

### BRIEF DESCRIPTION OF THE DRAWINGS

For a more complete understanding of the features and advantage of the particular invention, reference is now made to the detailed description of the invention along with accompanying Figures.

FIG. 1 is a representation of basic phosphoramidite chemistry for use with the invention;

FIG. 2 is an isometric view of a high throughput oligonucleotide synthesizer;

FIGS. 3a-3c is a side view of a well in the plate of the oligonucleotide synthesizer;

FIGS. 4a-4b show valve configurations for use with the present invention;

FIGS. 5a-5b are also valve configurations for use with the present invention;

FIGS. 6a-6b are a side view and a cross sectional view, respectively, of a plate of the present invention;

FIGS. 7a-7b are cross sectional views of a mask of the present invention;

FIGS. 8a-8c are cross sectional views of a mask of the present invention;

FIGS. 9a-9e are cross sectional views of a mask of the present invention;

FIGS. 10a-10b are cross sectional views of a mask of the present invention;

FIGS. 11a-11b are cross sectional views of a mask and well angles of the present invention;

FIGS. 12a-12d are cross sectional views of a mask of the present invention and fluid accumulation therein;

FIGS. 13a-13b are cross sectional views of a mask and the well angle of the present invention;

FIGS. 14a-14b are cross sectional views of a mask and divots in the well head of the present invention;

FIGS. 15a-15c are cross sectional views of mask of the present invention;

FIGS. 16a-16c are cross sectional views of mask plugs of the present invention;

FIGS. 17a-17c are cross sectional views of a dynamically adjustable mask of the present invention;

FIGS. 18a-18d are cross sectional views of a well in a plate of the present invention;

FIGS. 19a-19d are cross sectional views of a well in a plate of the present invention;

FIG. 20 is a top view of plate drains and vacuum lines for use with the plate of the present invention;

FIGS. 21a-21c are cross sectional views of mask-plate interface configurations of the present invention;

FIG. 22 is a side view of plates of the present invention;

FIGS. 23a-23b are cross sectional views of a well-plate interface of the present invention;

FIGS. 24a-24d are isometric and side-view cross sectional views of a pushing frame for mask removal;

FIGS. 25a-25b are a cross sectional view and an isometric view of a pushing fram for pushing down a mask on a plate;

FIG. 26 is a cross sectional view of a well for the plate of the present invention;

FIGS. 27 is a cross sectional view of a well for the plate of the present invention with fluid;

FIGS. 28a-28b are cross sectional views of injector manifolds of the present invention;

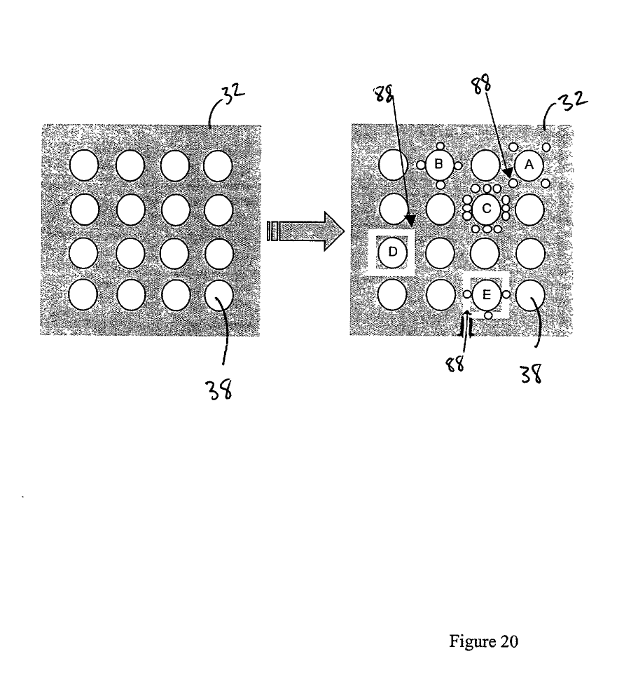

FIGS. 20a-29b are cross sectional views of injector manifolds of the present invention;

FIGS. 30a-30d are cross sectional views of injector manifolds and grooves of the present invention;

FIG. 31 is an isometric view of a roller injector manifold;

FIG. 32 is a synthesis order of the present invention;

FIG. 33 is a side view that demonstrates plate positions relative to the injector manifolds of the present invention;

FIG. 34 is a flow chart for the mask deblock method of the present invention;

FIG. 35 is a flow chart for the mask deblock method from FIG. 34;

FIG. 36 is a flow chart of the mask phosphoramidite method of the present invention;

FIG. 37 is a side view of a mask making apparatus of the present invention;

FIG. 38 is a side view of a mask making apparatus of the present invention;

FIGS. 39a-39b are a side and a top view of a mask punching apparatus of the present invention;

FIG. 40 is a top view of the injector position for the mask punching apparatus;

FIG. 41 is a flow chart for controlling the mask making apparatus of the present invention;

FIGS. 42a-42b show the results of the use of a naive or a non-naïve synthesis algorithm;

FIG. 43 is a flow chart of the “best sequence” algorithm;

FIG. 44 is a table that shows the array of the “best sequence” algorithm;

FIG. 45 is a comparison of the “1-base greedy” and the “2-base greedy” algorithms;

FIG. 46 is a comparison of the results of the “1-base greedy” and the “2-base greedy” algorithms;

FIG. 47 is a flow chart of the “1-base greedy” algorithm;

FIG. 48 is a flow chart of the “2-base greedy” algorithm;

FIG. 49 is a side view of a mask-changing machine of the present invention;

FIG. 50 is an isometric view of vacuum-mask of the present invention

FIGS. 51a-51h are side views of the operations of the mask-changing machine of the present invention;

FIGS. 52a-52g are side views of the operations of the mask-changing machine of the present invention;

### DETAILED DESCRIPTION OF THE INVENTION

While the invention has been described in reference to illustrative embodiments, the description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

Basic Description of the Invention

Custom-made oligonucleotides are increasingly in high demand, in particular as primers for PCR amplification, as hybridization probes and for de novo synthesis of genes. Current DNA synthesis technologies, however, cannot meet this demand. A project aimed at investigating each of these 35,000 genes of the recently completed Human Genome Project serves to illustrate the extent of the demand for oligonucleotide. Assuming two primers per gene (an underestimate) 70,000 primers would be required to amplify all of the genes. Current state-of-the-art, high-throughput synthesizers have an output of roughly 200 oligonucleotides, each 20 bases in length (i.e., 20-mers), in about 10 hours. It would take at least five months (based on only two primers per gene—an underestimate) to generate all the PCR primers necessary to investigate these genes running one current synthesizer 24 hours-a-day, 7 days-a-week. In addition, a tremendous number of other organisms are currently, or shortly will be the subject of, similar investigations. Other applications of peptides and oligonucleotides, including microarrays and gene-building, increase this demand. Thus, an increase in the throughput of, e.g., DNA synthesis is needed and will allow more labs to undertake comprehensive genomic research programs.

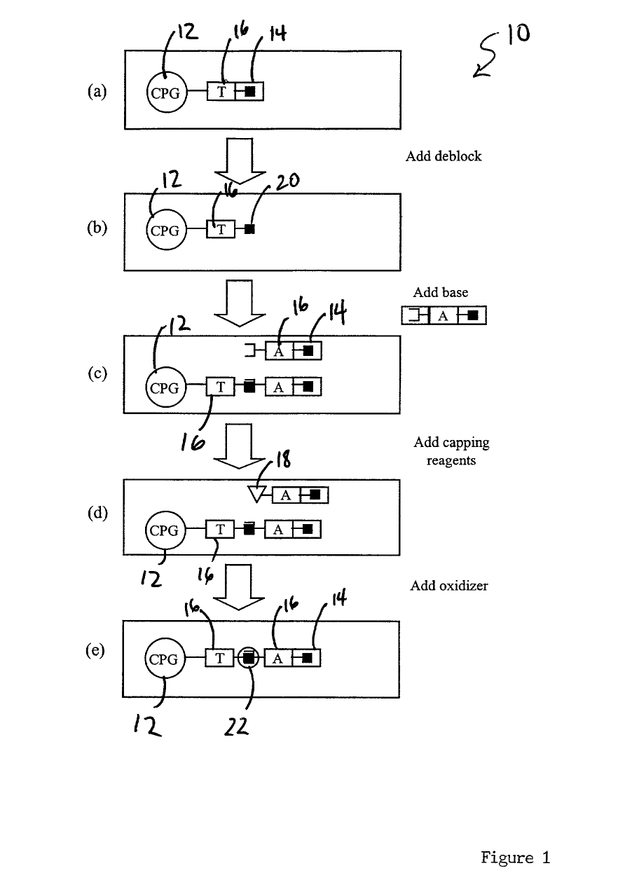

Chemical synthesis of DNA is typically carried out with a series of chemical reactions that are repeated sequentially for each monomer unit (adenine (A), guanine (G), cytosine (C), Uracil (U) and thymine (T)) that is added to the growing chain of DNA (FIG. 1). Synthesis 10 is initiated (FIG. 1a) on a solid support 12 (typically controlled pore glass, CPG) that has been derivatized with, e.g., a cleavable linker 14, and the first monomer unit 16. The first reaction “deblocks”, or deprotects, the protecting group on the first monomer 16, in this case a base T, making it available for reaction with the next monomer unit (FIG. 1b). The next monomer unit 16 is coupled to the deblocked end 20 as a reactive phosphoramidite and unreacted termini are subsequently acetylated 18 to prevent propagation of synthesis failures in later steps (FIGS. 1c and 1d). The new chemical bond formed with the phosphoramidite is oxidized 22 to create a stable linkage (FIG. 1e). Another cycle of coupling is begun by deblocking the terminus of the new strand. The cycle is repeated for each monomer 16 in the chain. Upon completion of the synthesis 10, the oligonucleotide is cleaved from the solid support 12, and protecting groups are removed from the bases and phosphates.

Currently available state-of-the-art, high-throughput DNA synthesizers use this cycle of chemical reactions in one of two ways: Either the solid support is immobilized in a column and a system of valves and tubing is used to deliver the appropriate reagents (e.g., an Applied Biosystems synthesizer—see U.S. Pat. No. 5,681,534) or an XY positioning system is used to move a multi-well plate, with wells containing CPG, beneath reagent injector valves (e.g., the Mermade system—see U.S. Pat. No.'s 5,368,823 and 5,541,314). Currently, the highest throughput is afforded by machines using the latter approach. In such a machine unique oligonucleotides are synthesized in each well by directing the injection of the correct base into those wells by appropriate movement of the plate into positions beneath the injectors. This method of synthesis can be scaled up for the parallel production of several oligonucleotides at once. However, as the number of individually addressable wells increases beyond 96, the time required for the positioning of the wells makes the synthesis time similar to that of other methods (i.e., the advantage gained by synthesizing into a multi-well plate is lost). In order to increase substantially the throughput of DNA synthesis, a method is required to allow the parallel and simultaneous addressing of reagents to the synthesis sites.

The present invention is an apparatus, system and method for performing parallel, stepwise chemical synthesis in a multi-well plate format. The present invention will be described using one example, namely, a 384-well high-throughput DNA synthesizer. The present invention has a much wider application as will be appreciated by those of skill in the art of polymer synthesis in light of the present disclosure. Although the present invention is based on phosphoramidite chemistry, it is in no way restricted by the actual chemistry, viz., it is amenable to implementation using photo-, acid- or any other monomer, dimmer, trimer or multimer addition chemistry based generally on solid supports. Furthermore, unlike existing synthesizers the present invention has the distinct advantage of enabling very large economy of scale.

The apparatus, method and system of the present invention separates the determination of which oligonucleotides are intended to receive a given reagent from the actual delivery of that reagent. The separation described herein is accomplished by performing selective deprotection (alternatively, selective coupling is also possible) using a set of “masks”. All synthesis reagents are delivered, e.g., sprayed or flooded, over the array of wells or locations for the synthesis of polymers, e.g., oligonucleotides from an injector manifold. The synthesis reagents are delivered to all the wells that are unprotected by the mask.

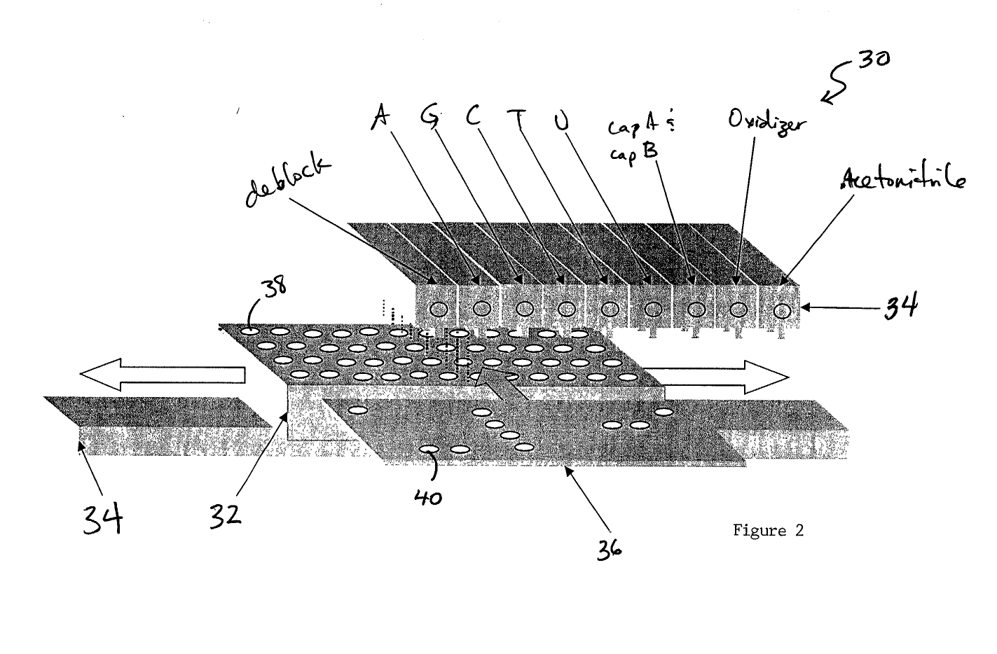

One embodiment of the present invention is a high-throughput oligonucleotide synthesizer that is designed to make, e.g., 384 unique oligonucleotides in parallel. The synthesis format may be scaled up to higher well densities (864 or 1,536—both commercially available sizes). The present invention may use, e.g., standard phosphoramidite chemistry carried out in each well (on CPG solid supports) of a custom made 384-well plate. The apparatus 30 in FIG. 2 shows one example of the present invention entire 384-well plate 32, or “car”, is mounted on a single linear motion table 34 that allows it to be moved under a series of injectors or injector heads 34 not unlike a “car wash” (FIG. 2). These injector heads 34 dispense the necessary reagents in the correct order as the “car” passes underneath the “car wash” spray. Each injector row may include, e.g., a single inlet and a number of outlets (e.g., a unique inlet and multiple outlets for all reagents. An exception may be acetonitrile, which may have one inlet and more outlets than the manifolds) and is designed to flood the entire surface of the plate, including the edges of the plate and also filling each well with a given reagent. Wells may be emptied by applying a vacuum beneath them, which pulls the reagent through but not the substrate. A semi-permeable support (“frit”) may be used to support the substrate, e.g., CPG.

For a unique oligonucleotide to be synthesized in each well, the present invention uses masks 36 to control the “flooding” of reagents into some wells 38 and not others. The simplest mask 36 is a sheet of material with holes 40 punched in it (i.e., similar to old computer punch cards), the positions of which are specific to a given set of polymers (e.g., oligonucleotides) and the technique in which those positions are chosen (described hereinbelow). Because oligonucleotides that have not been deprotected (i.e., have not been bathed in deblock reagent) are unreactive with all of the other reagents, it is sufficient to develop a method to direct deblock into individual wells and to let all other reagents flood into all the wells. Alternatively, all the wells may be flooded with deblock and four masks may be used (if necessary), one right after the other, to direct the delivery of each phosphoramidite to one or more individual wells.

The synthesis cycles for these two methods are similar and are described below. Each of the flood steps are representative of a number of flood steps done in succession. PATENT Also, each of these groups of flood steps are generally followed by several acetonitrile wash steps.

Mask the Deblock Step

(i) Move a mask into place over the plate;

(ii) Flood deblock reagent over the surface of the plate—only certain wells (i.e., those sitting below a hole in the mask) will receive deblock reagent;

(iii) Move the mask out of the way—take it off the plate;

(iv) Flood a mix of activator (e.g., tetrazole) and a reactive monomer (either A, G, C, T or U phosphoramidite) into all wells;

(v) Flood a mix of cap A and B reagents into all wells; and

(vi) Flood oxidizing reagent into all wells.

Mask the Phosphoramidite Steps

(i) Flood deblock reagent into all the wells of a plate;

(ii) Move the mask for A phosphoramidite into place over the plate;

(iii) Flood A (and activator (e.g., tetrazole)) over the car—only those wells sitting below holes in the mask will receive A;

(iv) Move the A phosphoramidite mask out of the way—take it off the plate;

(v) Move the mask for G phosphoramidite into place over the plate;

(vi) Flood G (and activator (e.g., tetrazole)) over the plate—only those wells sitting below holes in the mask will receive G;

(vii) Move the G phosphoramidite mask out of the way—take it off the plate;

(viii) Move the mask for C phosphoramidite into place over the plate;

(ix) Flood C (and activator (e.g., tetrazole)) over the plate—only those wells sitting below holes in the mask will receive C;

(x) Move the C phosphoramidite mask out of the way—take it off the plate;

(xi) Move the mask for T phosphoramidite into place over the plate;

(xii) Flood T (and activator (e.g., tetrazole)) over the plate—only those wells sitting below holes in the mask will receive T;

(xiii) Move the T phosphoramidite mask out of the way—take it off the plate;

(xiv) Flood a mix of cap A and B reagents into all wells; and

(xv) Flood oxidizing reagent into all wells.

The first method uses a unique mask for each deblock step. For example, suppose steps (i)-(vi) were performed such that A was added during step (iv), then the cycle was repeated again but with G added during step (iv), then again with C added and finally with T added. Then 80 (=4×20) unique masks would be required to make a plate of 20-mers.

Using the second method, four masks are needed for each cycle but now only ¼ of the deblock, cap and oxidizer steps performed in the first method are necessary. In practice, a computer algorithm optimizes usage of phosphoramidites in the first method, which leads to less that 80 masks being necessary (see section on computer code) and although no such optimization can take place in the second method it has the advantage of requiring fewer deblock, cap and oxidizer steps. That is, in the first method for every deblock step there are one couple, one cap and one oxidizer step (1:1:1:1) while in the second method for every deblock step there are four couple, one cap and one oxidizer step (1:4:1:1).

The mask-based synthesizer has several advantages over previous designs. First, is the use of one or more masks to direct reagents to certain wells, which separates addressing individual wells (others move the synthesis plate using an XY positioning system) from delivery of the reagents that are simply flooded over the wells. Because a set of masks for a future synthesis can be made prior to or concurrently with an ongoing synthesis, the mask-based synthesizer can easily be scaled up to accommodate larger well densities (i.e., 864, 1,536 or more) without an increase in synthesis time. This advantage is not lost unless the time to punch a set of masks surpasses the synthesis time. Based on synthesis and punching times of one working model, punching time will not exceed synthesis time, conservatively until approximately 4,000 20-mers are made at once (based on a time of 2 minutes to make a mask for a 384-well plate, 15 minutes to add one base and 60 masks required for the 20-mer). Another distinct advantage of the present invention is the lack of a large number of valves. This reduction in valve number is made possible by the technique of “flooding” and is in fact a design factor due to the inherent problems with blockage of valves that proves prohibitive with a large number of valves.

A number of the techniques described herein have been developed for use with the present invention. The solid supports and the chemistry used in this synthesizer are considered. Work on a “continuous membrane” and frits is described. Mask design is also explored. The design of the plate or “car”, which immobilizes the CPG, and the “car washes”, which flood the reagents are also described. The system and computer implementation of the program that controls the synthesizer is described. Also described are the methods of making masks and of moving those masks into place over the plate during a synthesis run.

Solid Support and Linker Chemistry

The mask-based synthesizer of the present invention may use, e.g., standard phosphoramidite chemistry (PC) (see FIG. 1 of the introduction) or other chemical step-wise synthesis chemistry or chemistries that permit generally the stepwise addition of one or more monomer subunits to a lengthening chain or branches. PC is one example of a solid phase organic synthesis: a process that requires a solid support (a medium on which chemical reactions can occur). A solid support, e.g., controlled pore glass (CPG) may be used with or without a linker molecule that binds the chemical groups to the solid support.

There are two major types of solid substrates or supports: bead-based and polymer-based, although others may be used with the present invention. The type of solid substrate used determines the design of some components of the apparatus and method of the present invention, however, the basic modifications needed to implement the synthesizer chemistry and design will be apparent to those of skill in the art in light of the present disclosure. For example, if bead technology is used, bead immobilization will generally be required. Typically, the beads are held inside individual wells with a bottom and/or top filter. Polymer-based substrates are typically much larger (e.g., a sheet of material) and can alleviate the need for a top and bottom filter altogether, which leads to reduced pre-synthesis preparation time.

To evaluate whether a support is useful the loading density (LD) of a substrate may be determined. The loading density was determined by trityl group analysis; trityl groups on the bases (A, G, C, U and T) were chemically removed and color formation (orange at 498 nm) was observed. Quantitative determinations were made using UV absorbance. Various types of supports were tested to ensure that a reasonable synthesis scale could be achieved.

The type of linker used on a substrate affects the post-synthesis procedures. The linker commonly used for DNA synthesis is the succinate linker, which takes about one hour to cleave (the process of removing the DNA from the solid support) in concentrated ammonium hydroxide. Other linkers exist that can be cleaved much quicker (approximately 2 minutes) or by a different mechanism (e.g., UV light).

Control Pore Glass (CPG). CPG are made of silica glass and are the standard support used in DNA synthesis because of their high loading density, typically 30 micromole per gram. In the mask-based synthesizer of the present invention, CPG may be loaded manually into the wells. CPG are powdery and flaky (with a diameter of about 80-120 micron). CPG may even be used in which a base (A, G, C, U or T) has already been derivatized on the substrate and have the highest loading density of all the supports tested.

Magnetic CPG (MPG). MPG have a loading density similar to that of CPG but are composed of a silicate glass and a paramagnetic material. As such MPG can be moved using an electromagnet or a permanent magnet. This is an attractive property because it may be exploited to hold the MPG down against the bottom frit thereby alleviating the need for a top frit. Using the present invention, a base was added to an MPG and was used successfully as a solid support in a simple DNA synthesis study. Each gram of unmodified MPG is twice as expensive as modified CPG, however, using the linker technology of Pon, et al., (Pon, et al., Nucleic Acids Research 97:25 (18) 3629-35) a Q-linker-MPG may be reused. For example, Pon tested this Q-linker using CPG to synthesizing DNA, cleaving off the DNA and then reattaching the first base. A modified MPG was created with the present invention and reused. Studies showed that the loading density of the MPGs dropped about 10% after the first usage.

Glass Micro Fiber Filters (GMFF). GMFF is a polymer-based support that, as disclosed herein, may be used for DNA synthesis. Various types of GMFF were obtained from different manufactures including S&S, Whatman, and Pall Gelman. The glass surface of the GMFF were chemically modified to add the first base and then tested the loading density of each. All the GMFF used so far had a loading density that was too low for quantitative DNA synthesis.

Glass Frits. Glass frits, typically used in chemistry columns, were modified and tested as substrates. Glass frits are physically harder than polymer materials and are much easier to handle than CPG or GMFF. Glass frits eliminate the powdery, flaky CPGs. The method of adding a base and determining the loading density was the same as the MPG analysis procedures, but yielded relatively low loading density (0.3 micromole).

Polystyrene Beads. Other supports may be used, e.g., polystyrene beads have been used in combinatorial chemistry. These beads do not swell during peptide synthesis and are not significant different from CPG in DNA synthesis.

Nylon. A sheet of nylon as a polymer-based support may also be used. Nylon may not be resistant, however, to all the harsh synthesis chemicals, in particular the dichloromethane used during the deblock step. Depending on the chemicals used in the chemical synthesis, nylon and other polymers may be useful for conducting chemical synthesis using the present invention.

Polyacrylamide Gel. Gels may be used as solid support in combinatorial chemistry, however, since gels contain water and water terminates DNA synthesis, using the standard chemistry the use of polyacrylamide gels may be limited to the synthesis of polymers in an aqueous environment.

Linkers. The succinate linker is widely used as a standard DNA synthesis linker. The cleaving process for this linker takes about one hour using concentrated ammonium hydroxide at room temperature. The Q-Linker has a cleavage time of roughly 2 minutes using concentrated ammonium hydroxide. The Q-link molecule was synthesized and tested based on Pon's literature and proved to be an effective linker.

Covalent Attachment. Another possible way to circumvent top/bottom filters is to covalently attach CPG on modified surfaces. These studies required partially deprotecting CPG (using a shorter deprotection time than usual) and then reacting the trityl-off sites on the CPG with a modified surface using a phosphorylation reaction to physically immobilize the CPG with covalent bonds.

Membrane Support

The present invention may use a solid phase organic synthesis to produce, e.g., oligonucleotides. Solid phase synthesis uses typically inert beads with a diameter of approximately 100 μm. The solid support is immobilized in individual wells of a filter plate, chemical reagents are delivered to the filter plate, the wells are filled with molecules that react on the solid support. Each well of filter plates available commercially contains a frit (or filter) which has the dual purpose of physically supporting the solid support (i.e., the frit must stop the solid support from falling out of the bottom of the well) while at the same time allowing the chemical reagents to flow through it slowly (i.e., it must be permeable to the reagents but not so permeable that the reagents flow out of the well before they have time to react). While simple gravity may be used to draw the chemicals through the well, a vacuum may be applied generally below the plate to pull the reagents through the frit/filter quickly.

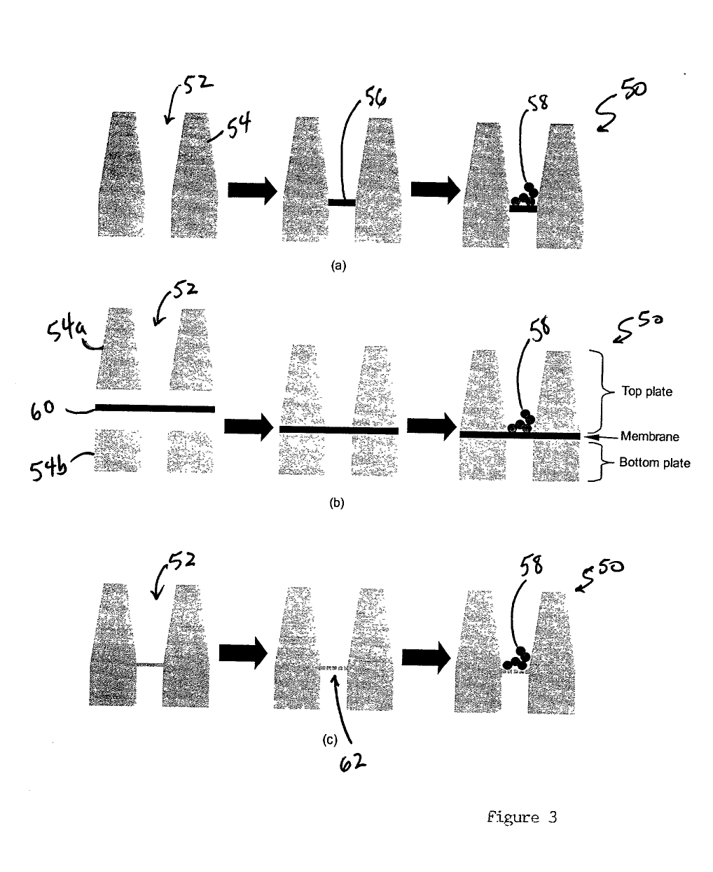

FIGS. 3a-3b show three variations of substrate supports or plate 50. Filter plates are available with porous (pore size of 40-60 μm) polyethylene frits positioned in the bottom of V-shaped wells, however, in order to increase throughput, filter plates with higher well densities were needed. The mask-based synthesizer may use a custom machined 384-well plate made of, e.g., Delrin (or materials with similar properties to Teflon™). Porous polyethylene frits (pore size of 40-60 μm) are cut from a sheet and inserted into each well. FIG. 3a shows a side view of a substrate support or plate 50. CPG was used as a solid support and, in one example, was manually 58 loaded into each well 52 of the plate 54 after the frits 56 have been inserted.

An alternative method is to use a continuous membrane 60 sandwiched between a top 54a and bottom plate 54b (FIG. 3b). A three-piece filter plate was assembled using silicon adhesive and fluid flow was tested. It was found that reagent delivered to one well 52 of this plate (54a, 54b) could travel to neighboring wells 52 via a mechanism referred to as wicking. The fluid was traveling within the membrane 60 along its constituent fibers by capillary action (i.e., not along the interfaces between the membrane and the plates). In some chemical synthesis this may not be a problem or may even be beneficial.

Several methods to impede the fluid flow along the fibers of the membrane 60. The first of these included administering silicon adhesive between the wells. This method showed some success, however, it was inconsistent and difficult to reproduce. Delrin plates melted slightly may also be used. Alternatively, a small circular region may be melted around each well to bind the fibers of the membrane together. Though some of these techniques showed promise, none were 100% effective (some leakage was observed in all some cases).

In general, there are many requirements for this membrane when used for standard oligonucleotide synthesis. These requirements for the membrane include: (1) the membrane/filter must be chemically resistant to all the solvents in DNA synthesis, e.g., dichloromethane; (2) the membrane/filter needs to be porous to allow fluid flow during each synthesis steps; (3) the membrane/filter needs to allow fluid to flow readily when vacuum is applied; and (4) there must not be any cross-contamination of wells due to wicking.

A variety of commercially available filters (with a range of screen sizes from 75 to 250 μm) and membranes (with a limited range of pore sizes, typically<0.5 μm) were tested and are described below. The methods used to test the above criteria are as follows. The flow Rate of a fixed volume was deposited on the membrane and the time required for all of it to flow through the membrane, both with and without vacuum applied, was recorded. The wicking of one drop of deblock (visibly orange because it was mixed with activated phosphoramidite) was deposited on the membrane and observed to determine if it diffused readily. Finally, chemical compatibility was tested by observing the membrane as it soaked in a bath of each of the synthesis reagents (deblock, activator, cap A, cap B, and oxidizer). The ideal material should have a slow flow rate (without vacuum applied), should not wick and will be chemically resistant to all synthesis reagents.

‘Single piece’ filter plate. FIG. 3c is a side view of a filter plate 50 made completely out of one solid piece of material with no membrane or frits to physically support the CPG 58 (FIG. 3c) may be used. Instead of the frits, a thin piece of Delrin is left blocking each well when the plate is machined. This thin piece is then perforated 62 (many times) using either a small drill or a laser. The perforated 62 Delrin must meet the same criteria as the frits (i.e., the perforations 62 must be small enough to allow fluid flow but not so big as to rob the CPG 58 of their support). It is likely that special equipment is required to drill such small perforations 62 (i.e., approximately 50 μm diameter), however, these may be drilled using a laser.

TABLE 1

| | | | Chemical | |
|---|---|---|---|---|
| | Flow | | Compati- | |
| Materials | Rate | Wicking? | bility | Notes |
| Polyester | N/A | N/A | Low | The membrane dis- |
| | | | | solves in acetonitrile |
| | | | | within minutes. |
| Nylon | N/A | No | Low | Nylon is not resistant |
| Membrane | | | | to the reagents. It dis- |
| | | | | solves in hours. |
| Nylon Screen | Varied | No | Low | Flow rate depends on |
| Filter | | | | the screen size, giving |
| | | | | a wider range of |
| | | | | opportunities to inves- |
| | | | | tigate. |
| | | | | Variety of pore sizes |
| | | | | not commercial avail- |
| | | | | able. |
| | | | | Nylon is not resistant |
| | | | | to the reagents. It |
| | | | | dissolves in hours. |
| Polypropylene | Varied | Yes | Excellent | A variety of membrane |
| Membrane | | | | pore sizes were tested |
| | | | | (0.1 μm, 2.5 μm, |
| | | | | 10 μm, 30 μm). |
| | | | | Polypropylene is |
| | | | | hydrophobic, fluid |
| | | | | tends to form aggre- |
| | | | | gates on the surface of |
| | | | | the membrane and |
| | | | | diffusion occurs. |
| | | | | 8″ × 11″ 0.1 μm pore |
| | | | | size sheet is available |
| | | | | in rectangular sheets. |
| | | | | With this pore size, |
| | | | | fluid would not readily |
| | | | | flow through the mem- |
| | | | | brane unless vacuum is |
| | | | | pulled. |
| Polypropylene | Fast | Yes | Excellent | Various sizes were |
| Screen Filter | | | | tested (70, 90, 100, |
| | | | | and 125 μm). Fluids |
| | | | | wick through the fiber |
| | | | | and contaminate the |
| | | | | neighboring wells. |
| | | | | Fluid flow in this |
| | | | | case is too fast. Not |
| | | | | enough reaction time |
| | | | | once the reagents are |
| | | | | deposited into the |
| | | | | wells due to high |
| | | | | flow rate. |
| Glass Micro | Ideal | Yes | Excellent | CPG inside a cotton- |
| Filter | | | | like fiber, and rolled it |
| | | | | into a ball. |
| Polyethylene | Ideal/ | No | Excellent | These frits have |
| Frits | Varied | | | 40-60 μm diameter |
| | | | | pore sizes. |
| | | | | Tests showed that the |
| | | | | flow rate could be |
| | | | | varied with frit |
| | | | | diameter and thick- |
| | | | | ness. |

Valves

Solenoid valves are an integral part of both the synthesizer and the mask-making machine and are chosen generally based on their chemical resistivity and lifetime. Further, the total number of valves used in both machines should be generally minimized to reduce the possibility of valve failure and thus the premature termination of a synthesis run. The valves used in the apparatus, system and method of the present invention may be used to deliver the various synthesis reagents. For the synthesis of oligonucleotides, for example, the valves will adhere generally to strict chemical resistivity requirements and, additionally, will not generally have metal as a wetted material (i.e., none of the parts of the valve that come in contact with the fluid being passed through it can be metal). A number of commercially available valves were tested, e.g., Teflon™ solenoid valves. Great variation in performance was observed. The fluid delivery valves of the synthesizer need to meet the following general requirements: (1) the valves must deliver consistent reagent volumes; (2) the valves must not leak; (3) the reagent delivery volume must be sufficient to supply the apparatus and method of the present invention (i.e., approximately 15 ml in one second at approximately 10 psi); (4) the valves must have a long lifetime (i.e., at least approximately one year); and (5) valves will have generally a small size.

Likewise, in the apparatus and method for making masks disclosed herein, holes were made in the mask by driving an object through the mask. The force to do this is delivered by air cylinders that are actuated by valve control. These valves have similar lifetime requirements to those used in the synthesizer but, unlike those valves, handle only inert gases. As a result the chemical resistivity requirements of the mask making valves are much less severe. Also, metal is an acceptable “wetted” material. The gas valves for the air cylinders of the mask-making machine need to meet the following requirements: (1) the valves must deliver consistent gas volumes; (2) the valves must not leak; (3) the valves must have a long lifetime (i.e., at least approximatelyone year); and (4) valves with smaller sizes are preferred.

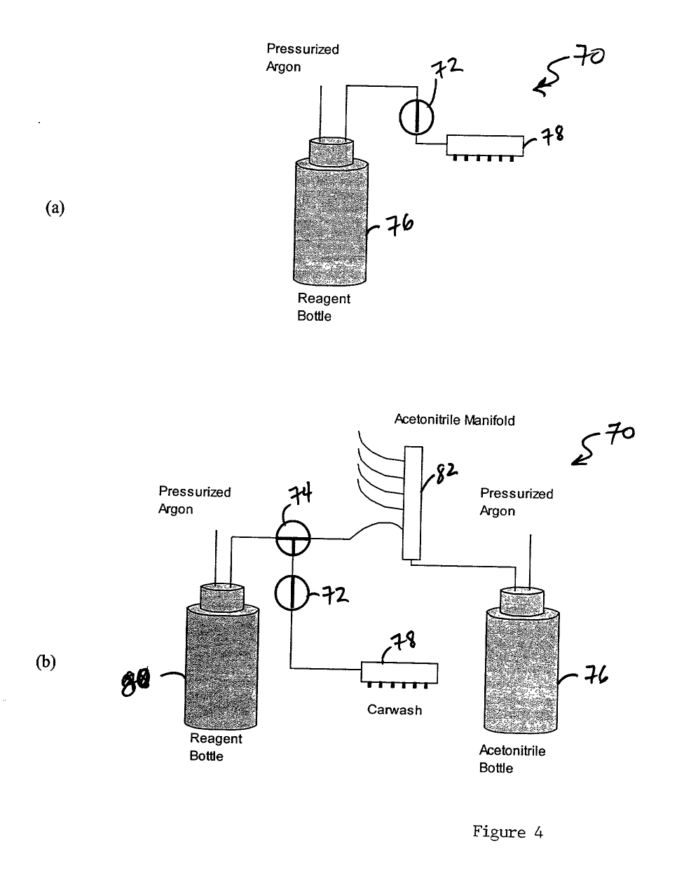

FIG. 4 shows alternative valve arrangements 70 for use with the mask-based synthesizer and may include 2-way 72 and/or 3-way 74 valves. The latter act in a very familiar way; when actuated by a 12 VDC input fluid flows through, otherwise fluid is stopped (this is a normally-closed (NC) 2-way valve). The 3-way valves 74 have one output and two inputs; fluid normally flows from input A (normally-open (NO) connection) to the output but when the valve is actuated, again by a 12VDC input, fluid flows from input B the (normally-closed (NC) connection) to the output. That is, there is always an open path from one of the inputs to the output of a 3-way valve 74. The 3-way valves 74 are essential for cleaning all the components that follow it with, e.g., acetonitrile. This is accomplished by connecting acetonitrile to input A and the synthesis reagent to be delivered by the injectors to input B.

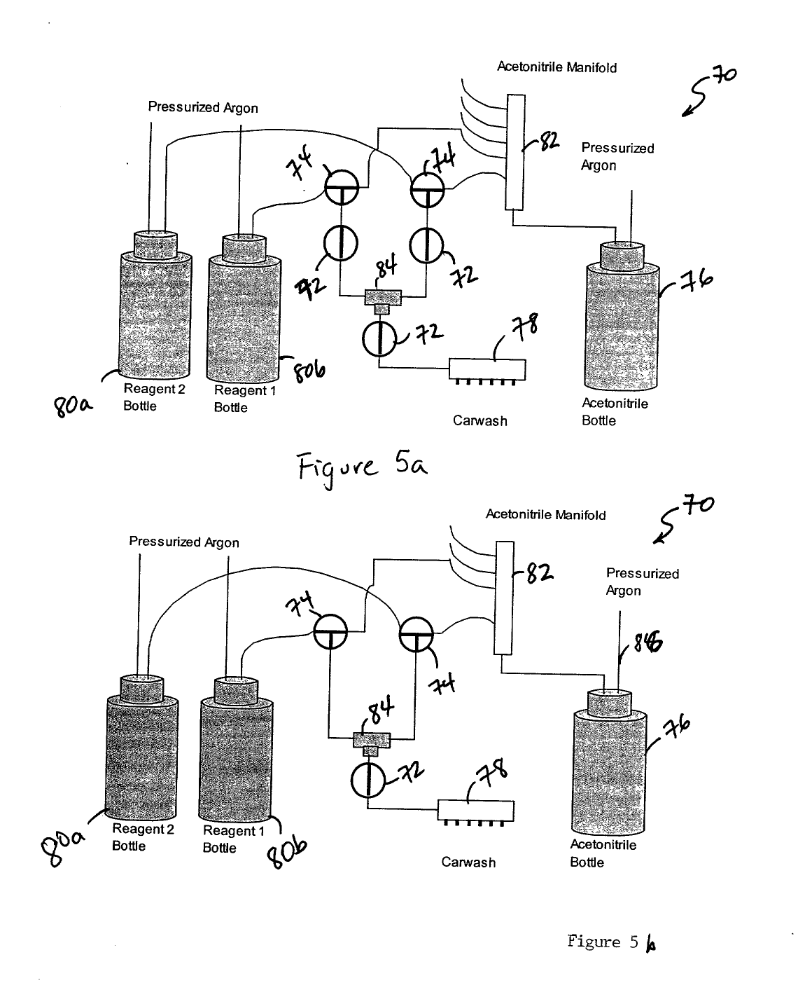

The valve arrangement for the acetonitrile “car wash” is shown in FIG. 4a and includes a 2-way valve 72 between the acetonitrile 76 source and the injectors 78. In FIG. 4b the arrangement for both deblock and oxidizer car washes is shown. As described above, the 3-way valve 74 has acetonitrile 76 connected to input A and the reagent 80 (i.e., either deblock or oxidizer) attached to input B. The 2-way valve 72 connected to the output of the 3-way valve 74 controls the flow of fluid out of the 3-way valve. Without it, fluid would continually flow out of the 3-way valve 74 from either input A or input B. The remaining injectors 78 deliver a mix of two reagents. Excess reagent and volatile compounds may be vented using a gas manifold 82. FIG. 5a shows a multiple reagent embodiment in which either a phosphoramidite and activator (e.g., tetrazole) (an activator) or cap A and cap B. The valve arrangement for all of these is the same and includes two 3-way valves 74, one for the first reagent 80a (e.g., cap A) and one for the second 80b (e.g., cap B). Below each of these is a 2-way valve 72, the outputs of which combine in a “T” junction 84. The output of the “T” junction connects to the car wash.

All the valve arrangements that include a 3-way valve (i.e., all but that for the acetonitrile “car wash” injectors), acetonitrile is attached to input A, the normally open connection. Thus, when the reagent (or reagents) connected to the input B connections are to be delivered by the injectors, all the 3-way valves and all the 2-way valves are actuated. When the plate is to be washed with acetonitrile only the 2-way valves are actuated.

As seen in FIG. 5b, the valve arrangements used to deliver a mix of two reagents (80a, 80b) may be further simplified. To do this, the two 2-way valves 72 just above the “T” junction 84 could be removed, the outputs of the 3-way valves 74 could be hooked directly to the “T” junction 84 and the output of the “T” junction 84 could be connected to the lower 2-way valve 72 (see FIG. 5b). However, with this arrangement, if even one of the 3-way valves 74 leak the acetonitrile manifolds 82 that supply all the 3-way valves 74 may be contaminated. More reliable 2-way valves 72 are piggybacked on the 3-way valves 74 as shown in FIG. 5a, even though removing them would simplify the electronics and reduce the total number of valves in the system. If connecting acetonitrile 76 to the normally open connection of the 3-way valves 74 is not followed and the piggy-backed 2-way valves 72 are removed, then the reagent connected to input B of the first 3-way valve 74 has an unimpeded path into the bottle of the reagent connected to input B of the second 3-way valve 74. Because the total vapor pressure in either reagent bottle may include not only of the Argon pressure 86 (the same for both bottles) but also the vapor pressure of the reagent in the bottle, one reagent may flow from one bottle to another if the vapor pressures of the two reagents (80a, 80b) are not the same (a force on the fluid in one bottle results from the difference in pressure). The problem was encountered early in the development of the machine by the flow of cap B into cap A.

Bubbles have been observed in the fluidic lines of the synthesizer. These bubbles, which include gas in the synthesis chamber, leads to two problems: inconsistent reagent delivery and contamination of the reagent in lines; harmed most by humidity or water in the gas. This problem with bubbles resulted from not tightening the valve fittings properly.

A number of ways were developed to prolong valve life. First, the valve should not be constantly under pressure. If the pressure differential is always engaged (reagent line open, wash line closed), the pressure difference leads to a shortened valve life. Inline filters were also added and should be cleaned-out of particulates.

Lee Reagent Valves. Lee valves INKX0502450A and LFVA1210320H were also tested. Though fairly reliable, the fluid delivery capacity is generally too small to control the flow for a “carwash” delivery of reagents by the injectors to the plate (it can only deliver approximately 1 ml per second at 10 psi).

Cole Parmer Reagent Valves. Cole Parmer valves rated to a pressure of 30 psi (i.e., a “30 psi valve”), were used to deliver DNA synthesis reagents. 30 psi valves were tested for capacity and the electronics to control them. Multiple and frequent failures were observed, e.g., with deblock and oxidizer. 100 psi valves were found to be more reliable than those rated to 30 psi.

Valves for Mask Making Machine: The mask-making machine may use 100 psi Cole Parmer or 150 psi MAC valves to control the pressure supplied to its air cylinders. These valves require generally about 100 to about 150 psi (i.e., the maximum pressure to which these valves are rated) to properly punch a thin piece (0.020″ thick) of polypropylene (i.e., a simulation of the hard mask).

Adhesives

A variety of adhesives have been tested for use in conjunction with the masks of the present invention, and in particular, their chemical compatibility with DNA synthesis reagents. There are two main uses for adhesives: sticking Delrin plates to polypropylene membranes; and as the adhesive of an adhesive mask. Tests were performed by depositing approximately 5 ml of the adhesive in 20 ml vials and allowing it to cure based on factory suggested curing conditions (e.g., time, temperature, etc.) Once the adhesive had cured, either 15 ml of deblock solution (3% trichloroacetic acid in dichloromethane, Table 2) or acetonitrile (Table 3) were deposited on the adhesive to test the chemical resistance of the adhesives against two of the common organic synthesis reagents. The time for adhesive decomposition was noted.

None of the adhesives (not even an epoxy) resisted dichloromethane for an indefinite period of time, however, both silicon glue and epoxy adhesives resisted deblock for approximately 24 hours. Since each plate will not be immersed in deblock for this long, these adhesives will most likely be suitable as plate sealers.

TABLE 2
The chemical resistivity of each adhesive tested in deblock solution.

| Adhesive Name | Hrs cured | Results |
|---|---|---|
| 1. GE RTV 110 Silicon Rubber | 24 hrs. | Dissolved in 20 hrs. |
| Adhesive | | |
| 2. Dow Corning White Silicon | 24 hrs. | Dissolved in 48 hrs. |
| Rubber Sealant | | |
| 3. Project Design Services' | n/a (solid) | Starts to crack in |
| Epoxy | | 24 hrs. Cracks in |
| | | pieces in 48 hrs. |
| 4. Instant glue | 12 hrs. | Dissolved in less |
| | | than 1 hr. |
| 5. 3M Epoxy 2216 A/B | 48 hrs. with 6 hrs. | Dissolved in 24 hrs. |
| | heating @ 200 F. | |
| 6. 3M 1099 | 24 hrs. | Dissolved in 6 hrs. |
| 7. 3M 857 | 24 hrs. | Dissolved in 6 hrs. |
| 8. Devcon Epoxy | 48 hrs. with 6 hrs | Dissolved in 6 hrs. |
| | of heating @ | |
| | 200 F. | |
| 9. Loctite Flowable Silicon | 24 hrs. | Swollen, a small |
| | | piece broke off, |
| | | generally OK. |
| 10. Master Bond EP41S-4 | 48 hrs. with 6 hrs. | Starts to crack in |
| | of 200 F. heating | 24 hrs. |
| | | Cracks in pieces in |
| | | 48 hrs. |

TABLE 3
The chemical resistivity of each adhesive tested in acetonitrile.

| Glue Name | Hrs cured | Results |
|---|---|---|
| 1. GE RTV 110 Silicon Rubber | 24 hrs. | No change |
| Adhesive | | |
| 2. Dow Corning White Silicon | 24 hrs. | No change |
| Rubber Sealant | | |
| 3. Project Design Services' Epoxy | n/a (solid) | No change |
| 4. Instant glue | 12 hrs. | Dissolved in less |
| | | than 1 hr. |
| 5. 3M Epoxy 2216 A/B | 48 hrs with 6 hrs | No change |
| | heating @ 200 F. | |
| 6. 3M 1099 | 24 hrs. | No change |
| 7. 3M 857 | 24 hrs. | No change |
| 8. Devcon Epoxy | 48 hrs with 6 hrs. | No change |
| | of heating @ | |
| | 200 F. | |
| 9. Loctite Flowable Silicon | 24 hrs. | No change |
| 10. Master Bond EP41S-4 | 48 hrs with 6 hrs | No change |
| | of 200 F. heating | |

Masks

Another aspect of the present invention is the use of masks to direct the timing and location of reagents delivery. One important difference between the present invention and current synthesizer design is the control of reagent delivery at the deblock stage or at the addition of individual monomers (e.g., nucleotides or amino acids). The present invention overcomes the problem inherent in the use of large numbers of valves, namely, the inherent chemical and physical limitation of the valves as well as the increased costs associated with increasing the number of valves. Furthermore, large numbers of valves present spacial problems because of the increased miniaturization of synthesizers.

The present invention may use two different types of masks, namely, soft and hard. Soft masks have the advantage of being able to be rolled up in a continuous sheet like a “piano roll” or a roll of paper towels. In this embodiment the holes that permit the entry of reagents into the reaction site within the plate may be punched immediately before use and may even be positioned at the reaction site in a rolling manner.

Hard masks are individual pieces, much like the lids of canisters. Unlike soft masks, hard masks cannot be rolled up to save space but their rigidity lends them to different handling methods and design ideas. Both types of masks have been investigated, including injection-molded masks.

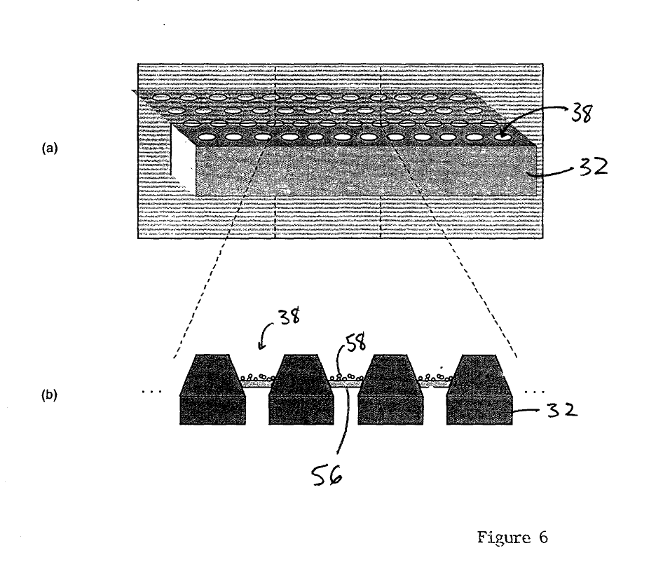

Mask materials will comply generally with the following requirements. The masks must provide a sufficient seal with the edges of the plate at the wells to prevent wicking (i.e., transfer of fluid by capillary action) of reagent between the wells in the plate and the mask. Limiting or preventing wicking reduced the amount of spurious reagent delivery into adjacent wells that should not receive reagent. Prevention of wicking between the mask and the plate required special considerations. Design parameters for the seal between the mask and the wells in the plate may include: (1) reshaping the geometry of the mask/well interface; (2) selecting materials and/or shapes that prevent cross contamination; (3) providing regions in the mask and/or the wells that redirect excess reagents into a waste line, including both passive and active drainage; and (4) providing a generally planar mask with surfaces at the interface with the plate and wells that permit the mask to be “stuck-down” into the plate with force. The various embodiments of these ideas will be discussed below. FIG. 6 illustrates a cross-sectional view of the plate 32 that has wells 38 for use in the discussions of the different mask types below. The formation of bubbles may also be taken into consideration when designing masks. Bubbles in the mask and at the mask/well interface can alter fluid flow and, as a result, affect the results of the synthesis run.

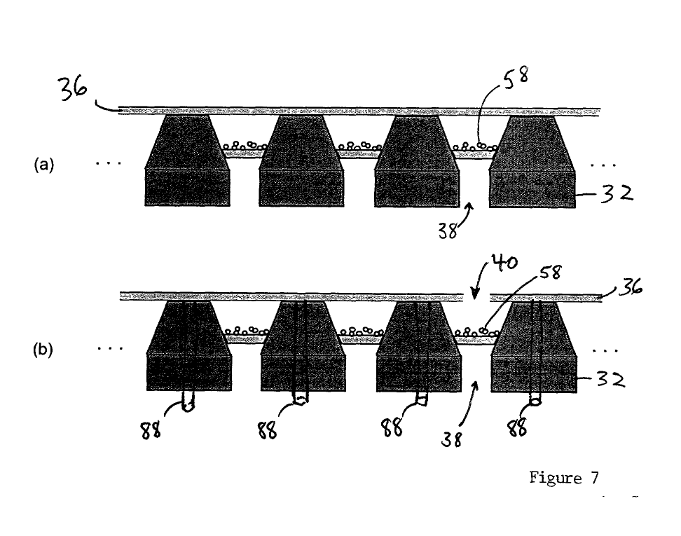

Teflon™ sheet—flat and shaped. FIGS. 7a and 7b show a cross-sectional view of a soft mask for use with the present invention, e.g., a roll of Teflon™ (McMaster Carr, USA) that come in various thicknesses including 0.002″, 0.003, 0.005″, 0.010″ and 0.015″ (FIG. 7). Masks 36 with a dimension of approximately 5″×6″ were cut from these rolls and had holes 40 (various diameters were tried) punched in them. A mask 36 was then positioned on top of the plate 32 and vacuum, pulled constantly through the wells 38 of the plate 32, held the mask 36 down tightly in an effort to stop reagent wicking between the mask 36 and the plate 32. Pulling a vacuum constantly during the addition of reagent limited the amount of time that the reagents interacted with the substrate in the wells 38, that is, the reaction did not have enough time to complete.

An alternative method is to provide vacuum lines 88 or drain adjacent the wells 38 that would permit a seal between the mask 36 and the plate 32 that limits wicking and cross-contamination, while at the same time holding the mask 36 in place. A second vacuum line or system may be provided that draws reagents through the wells only after the reaction has had time to complete.

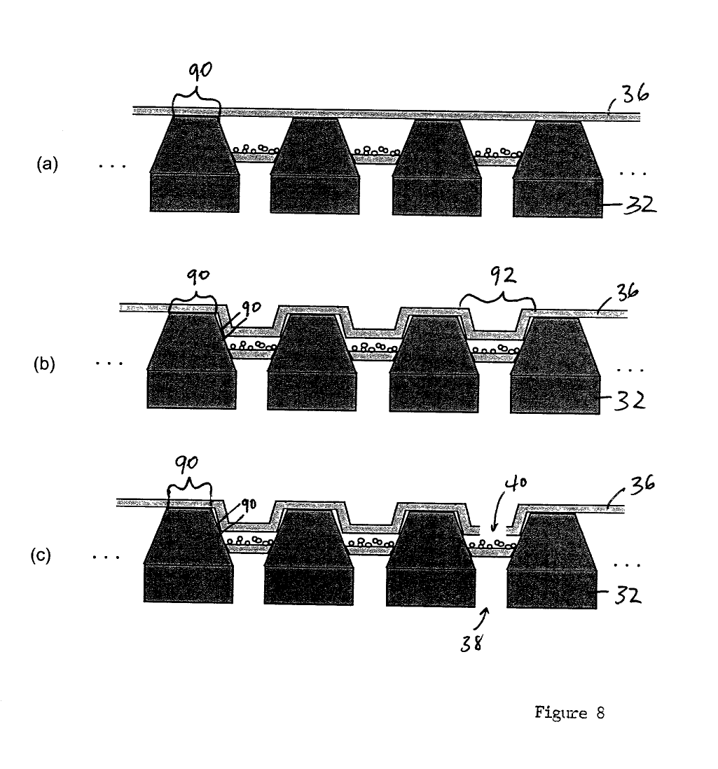

FIGS. 8a-8c show variations in the geometry of the mask/car interface 90 may also be used to extend the reaction time. Reshaping the mask 36 may include deforming the surface, e.g., a rivet, file handle, etc., so that it had divots or indentions 92, that fit snugly into the wells 38 of the plate 32, i.e., “imprinting” the mask 36. The mask 36 may be imprinted on the plate 32 itself or it may be pre-imprinted. Once an imprinted mask 36 is lifted off a plate 32 it will often not make a good second seal. One method to improve the re-sealing capability of the soft, imprinted mask 36 is to press divots 92 with, e.g., a rounded instrument (e.g., a rivet) into the wells 38.

Another alternative soft mask is a blow molded mask, e.g., blow molded 0.005″ thick Teflon™ sheets. Thin injection molded masks, e.g., polypropylene or Delrin, may be shaped into rolls and used as a “soft mask.”

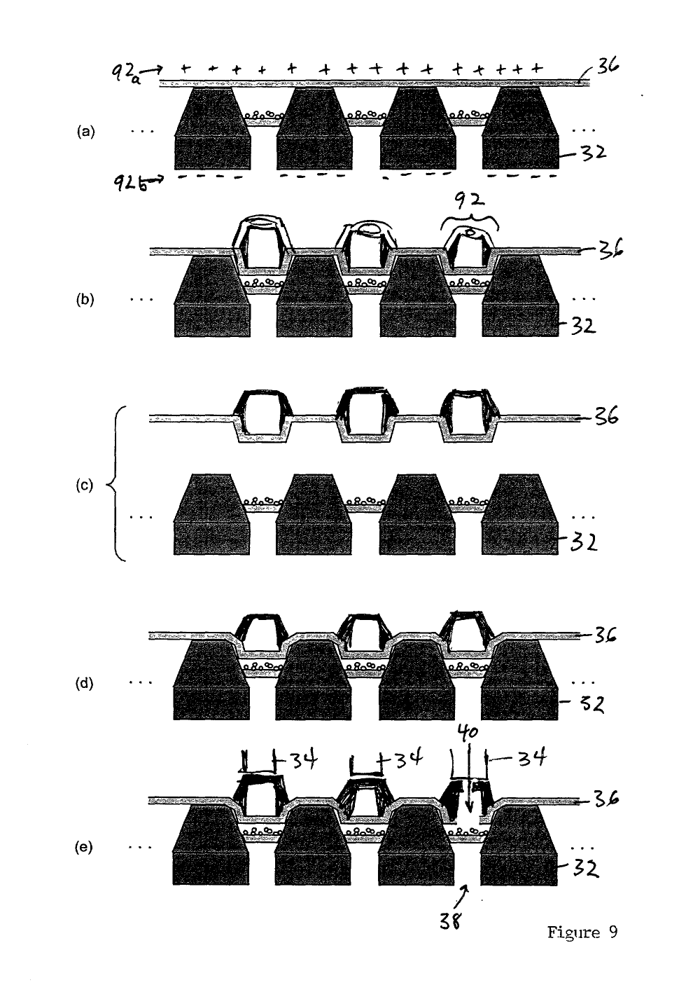

FIGS. 9a-9e show yet another type of mask 36 may be a mask that interfaces and/or “adheres” to the surface of the plate 32, which may be, e.g., a film, sheet, gel or a gel-like material. The plate and/or the soft mask may be doped with chemically non-reactive charge groups 92a and 92b that rely on static electric attraction to improve the seal. Gel-like masks may even contain toroidal divots 92 on one or both sides, that is between the plate 32 and the mask 36 and between the mask 36 and the injector or delivery head 34. Having one or both toroidal divots 92 permit a tight interface 90 from the injector or delivery head 34, through the mask 36 at opening 40 into the well 38. It also allows for better alignment of the mask and the wells of the plate and provides a discrete location and reinforcement to the openings in the mask for “punch out.”

To improve holding down the mask, a set of holes in the plate that have a vacuum system independent of that used to pull reagent out of the wells of the plate may be used. These “dedicated vacuum holes” have the advantage of holding the mask down firmly on the car without pulling reagents out of the wells prematurely. One such design was tested by drilling holes surrounding the wells of an early test car and pulling vacuum through the wells and the dedicated vacuum holes. Some wicking has been experienced between the mask and the plate. To reduce cross-over, troughs or rings connected to dedicated vacuum holes may be machined into the mask and/or the plate. These troughs or holes are intended to guide reagents that were wicking into the dedicated vacuum holes.

Adhesive masks. Adhesives may also be used to hold down the mask on the plate. The mask material may have the adhesive pre-applied and pre-rolled for use. An alternative is for the adhesive to be applied to the mask material just prior to use. In situ adhesive deposition may be accomplished by rolling or spraying the adhesive onto the flexible mask (e.g., aerosol glue particles). The adhesive must generally satisfy the dual requirements of withstanding, e.g, deblock while at the same time having a reasonable curing time (i.e., one which can come off a roll and be used immediately.

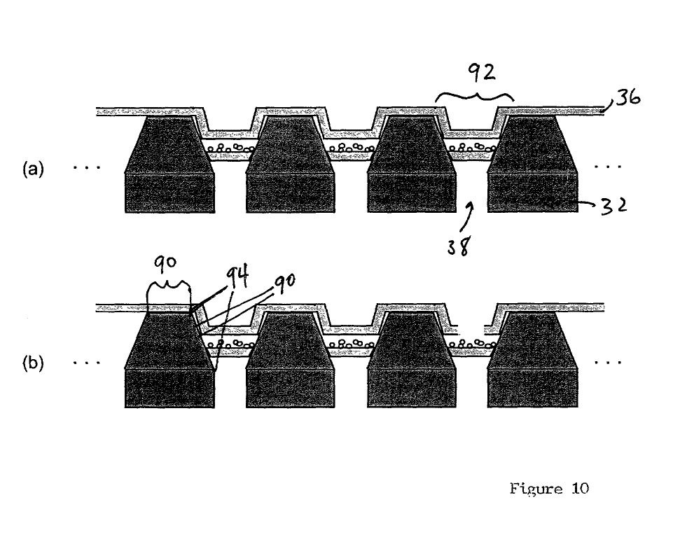

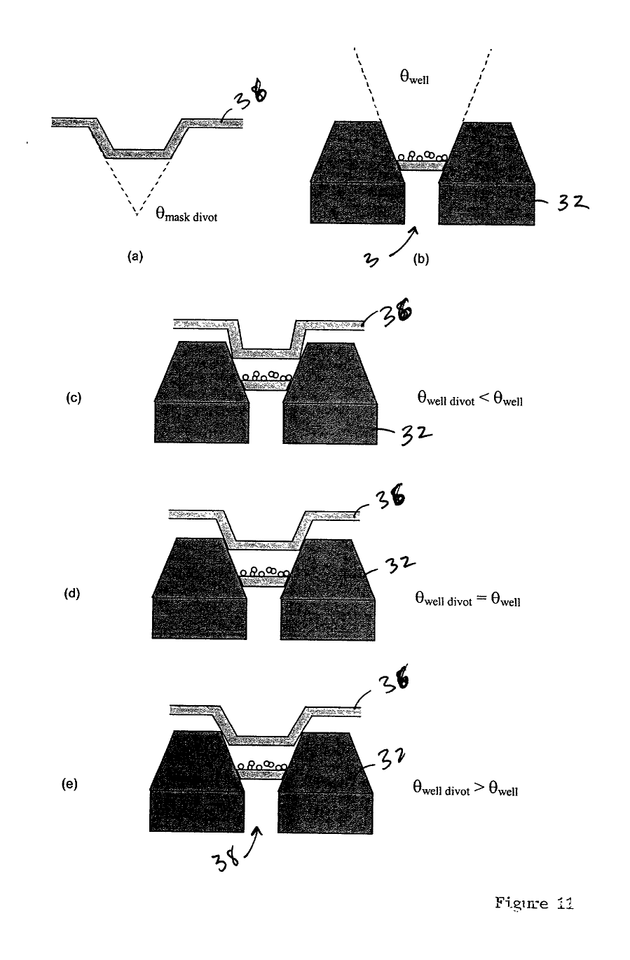

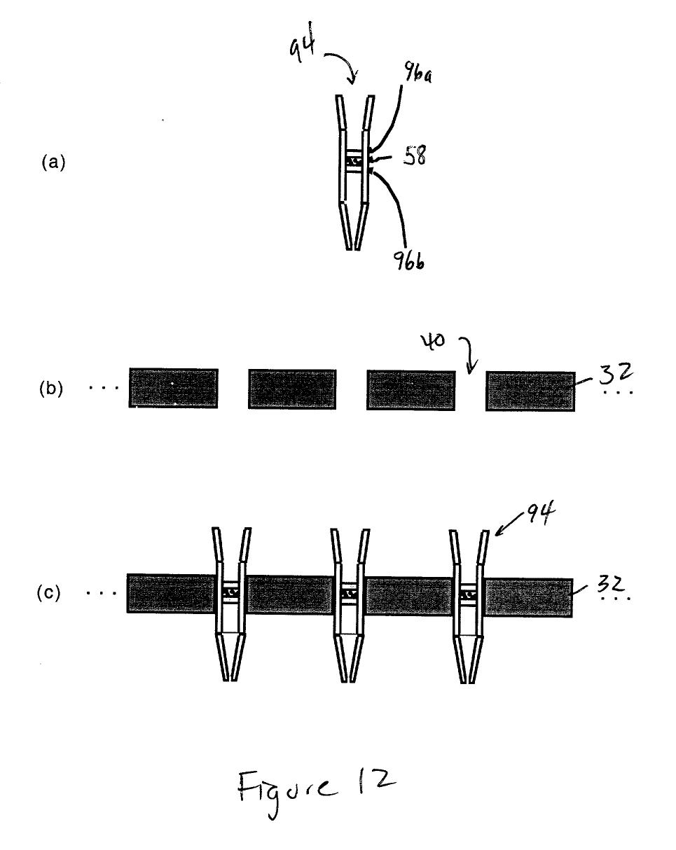

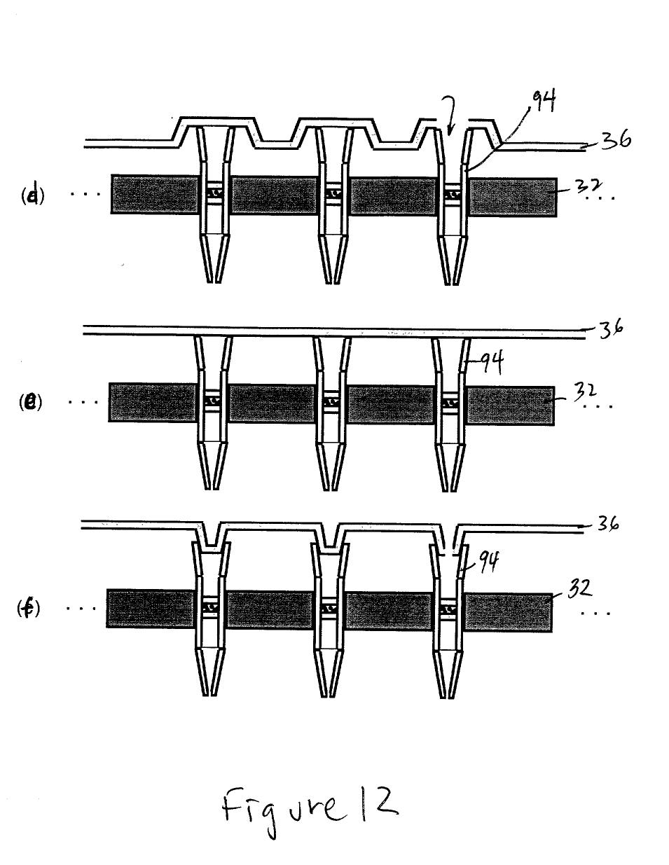

Injection Molded Masks. FIG. 10 shows another alternative for the mask 36 design is the use of an injection-molded mask 36. Divots 92 may be added to the mask 36 using a material that compress into the wells 38 of the plate 32. The amount of compression is determined by two factors: (1) the relative geometry of the mask divots 92 and the wells 38 of the plate 32 and (2) the materials that the mask 36 and plate 32 are made from. Both the divots 92 and the wells 38 may have conical cross sections 94 but their angles may be varied. As shown in FIGS. 11a-11e, for example, the well 38 angle may be greater than, equal to or less than the divot 92 angle. All three designs have been tested and found to work, however, the more solid the materials the less compressible and the weaker the seal. When the well 38 angle is less than the divot 92 angle, instead of compressing the disk at the bottom of the divot 92, the divot 92 is being compressed some distance up the side of the divot 92 wall. Here the divot 92 can be compressed, a snug-fit results and the mask 36 seals. In one embodiment of the mask 36, the divots 92 have an included angle of 6° (i.e., 30 per side) and 8° (i.e., 4° per side) respectively. The plate 32 may be, e.g., Delrin and the mask 36 a polypropylene homopolymer, which is a material softer than Delrin. The masks 36 may also be made from a copolymer polypropylene that is softer than holopolymer polypropylene.

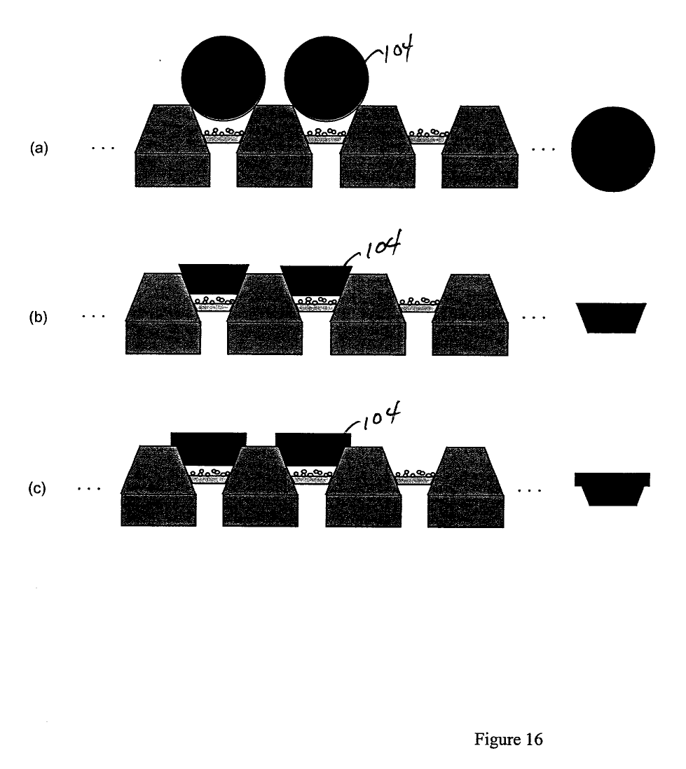

As shown in FIGS. 12a through 12f, another alternative to machining wells 52 into or from a plate 32 is to use a very simple plate 32 design in which circular wells 52 are drilled with a straight cross-section—FIG. 12b) with, e.g., commercially available columns 94, FIG. 12a, in which CPG pre-packed in columns 94 are inserted into the openings 40 of the plate. As shown in cross-section in FIG. 12a, the columns 94 contain a substrate 58, e.g., CPG, for polymer formation between a top frit 96a and bottom frit 96b. The columns are placed into the wells of the plate 32. This design has been tested on the current synthesizer with a mask 36 with inverted divots (as discussed hereinbelow—FIG. 16a). Both a flat mask 36 and one with divots 92 that penetrate into the columns 92 or wells 52, as shown in FIGS. 12d, 12e and 12f, may be used with a plate 32 with columns 92, just as they may with the machined plates 32 discussed earlier and throughout the disclosure. Among the parameters that may be changes are: different mask materials, different divot geometries and a different atmosphere for the reaction, e.g., instead of air (approximately 78% Nitrogen) Argon or Helium may be used.

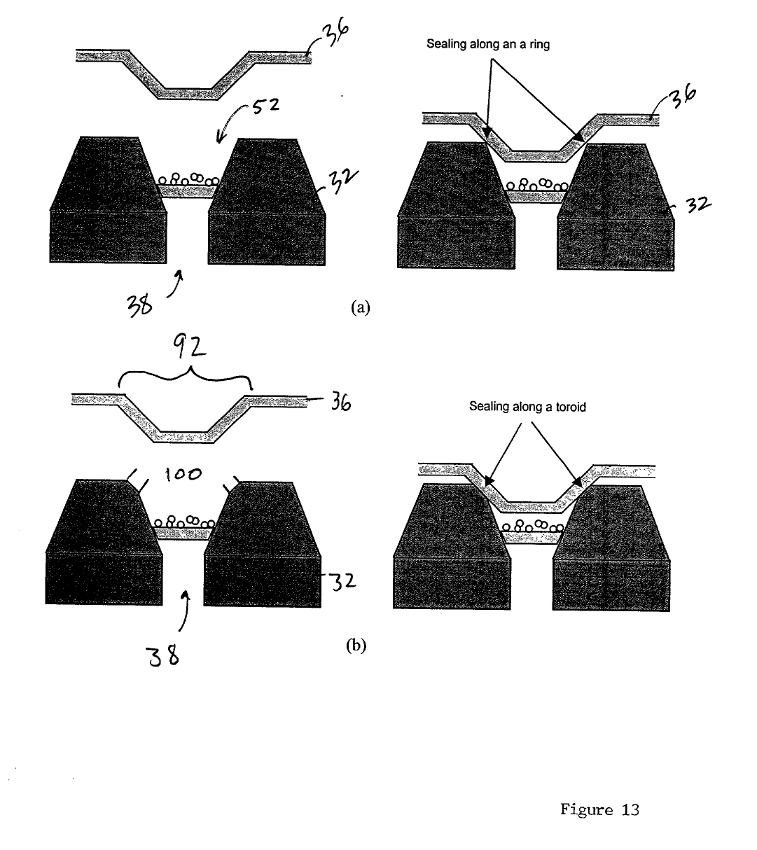

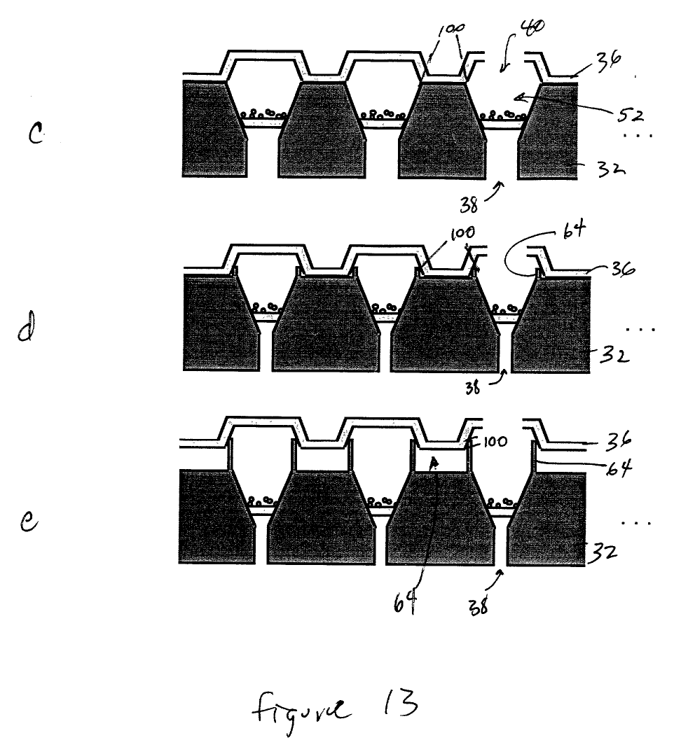

FIGS. 13a and 13b show an extension of the above designs and materials, namely, adding a small ring 100 around the top of the well 38 of the plate 32 that has an angle that matches the angle of the divot 92 exactly. This mask 36 divot 92 to well 38 interface 90 design increases effectively the probability of the divot 92 and well 38 making a good seal because the contact area between them has been increased from a ring 100 (defined by the circumference of the top of the well) to a toroid around the top of the well 38. The seal is still made by compressing the wall of the divot 92, not the disk at the bottom of the divot 92.

In FIG. 13c the divots 92 of a hard mask are shown penetrating into the wells of the plate 32. The seal between the mask 36 and the plate 32 is either a ring 100 (FIG. 13a) or a toroid (FIG. 13b) around the top of each well of the plate 32. An alternative way to use a mask 36 is to invert the mask 36 so that the divots 92 protrude up above the wells 52 of the plate 32 as shown in FIG. 13c. In this orientation the seal between the mask 36 and the plate 32 is now the flat interface 100 between the mask 36 and the plate 32 made up of the non-divot and non-well regions of the mask 36 and plate 32 respectively. A similar type of seal made by simply lying a flat piece of Teflon™ sheet on the plate 32 and the mask 36. This type of seal often permits fluids to wick between the mask 36 and the plate 32, a process that leads to cross-contamination between the wells 52. To deal with this problem a lip 62 around the top of each well 52 may be added to the plate 32 (FIG. 13d). The lip 62 serves two purposes; it prevents fluid from exiting one well 52 and also prevents fluid from an adjacent well 52 entering another well 52. In fact, the lip 62 may be made high enough that the mask 36 is not in contact with the flat surface of the plate 32 at all (FIG. 13e). With the mask 36 lifted higher any fluid that leaks past the seal at the at the well/divot interface 100, must either travel down the outside of the lip, along the bottom of the mask to the next well/divot interface 100 or may even be drawn or sucked out via vacuum pulling through the opening 64. It may be more energetically favorable for a drop of fluid to exit the surface of the plate 32 along the outside of the lip if the surface of the plate is, canted or slanted. The use of lips 62 reduced cross contamination of the wells.

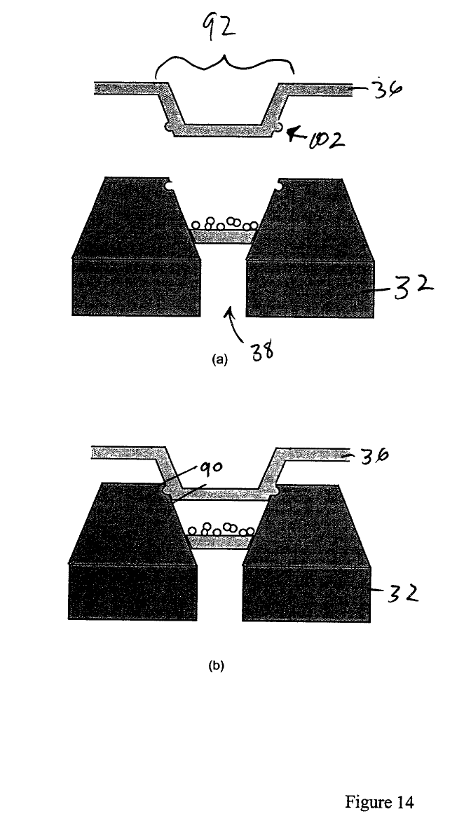

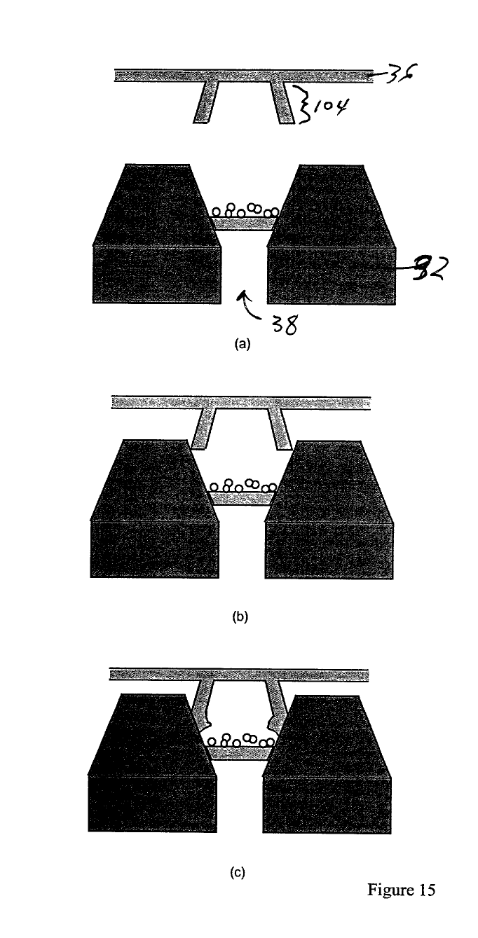

FIGS. 14a and 14b show another divot 92 design with a “built-in o-ring” 102 at the interface 90. As described above, a divot angle greater than the well angle may be used so that the wall of the divot 92 is compressed. The plate 32 may be machined with a receptacle for the o-ring 102 in each well 38. FIG. 15 shows another design in which the disk of material at the bottom of the divots 92 in the mask 36 is compressed at the top of the divot 92 (referred to as the “Eppendorf-tube” design). The divots 92 of this mask 36 have sides 104 that flare outward so that when the divots 92 are pushed down into the wells 38 the sides 104 are compressed. Because in this design there is not a disk of material at the bottom of the divot 92, significant compression takes place and the mask 36 seals.

Super-Adsorbent masks. An interesting effort to avoid the problem with wicking was to simply adsorb all the reagent that could possibly wick. Extremely adsorbent mask were tested and one embodiment in which a ‘sandwich’ of materials was used proved useful.

Magnetic Masks. The use of a magnetic mask is very similar to the use of dedicated vacuum holes to hold a sheet of Teflon™ down against the plate. The force that holds the mask down results from the difference in pressure above and below the Teflon™ areas that fit above the dedicated vacuum holes. Here the mask is made of, e.g., a ferromagnetic sheet (e.g., sheet magnet material used commonly for refrigerator-magnets) coated a chemically resistant material (e.g., Teflon™). The plate may contain a magnetic metal such as iron that is coated with a chemically resistant material.

A wide variety of permanent magnets may be used with the present invention such as rare earth magnets, ceramic magnets, alnico magnets, which may be rigid, semi-rigid and flexible magnets. Flexible magnets are made by impregnating a flexible material such as neoprene rubber, vinyl, nitrile, nylon or a plastic with a material such as iron flakes having magnetic characteristics and will find use with the present invention.

Other examples of magnets for use as described hereinabove, are rare earth magnets include neodymium iron boron (NdFeB) and Samarium Cobalt (SmCo) classes of magnets. Within each of these classes are a number of different grades that have a wide range of properties and application requirements. Rare earth magnets are available in sintered as well as in bonded form.

Ceramic magnets are sintered permanent magnets composed of Barium Ferrite (BaO (Fe₂O₃)ₙ) or Strontium Ferrite (SnO (Fe₂O₃)ₙ), where n is a variable quantity of ferrite. Also known as anisotropic hexaferrites, this class of magnets is useful due to its good resistance to demagnetization and its low cost. While ceramic magnets tend to be hard and brittle, requiring special machining techniques, these magnets can be used in magnetic holding devices having very precise specifications. Anisotropic grades are oriented during manufacturing, and must be magnetized in a specified direction. Ceramic magnets may also be isotropic, and are often more convenient due to their lower cost. Ceramic magnets are useful in a wide range of applications and can be pre-capped or formed for use with the present invention.

Flexible magnets are magnets made of materials that are flexible and bonded with a magnetic material. Flexible magnets offer the product designer a uniquely desirable combination of properties at a low cost. The advantage of materials that are flexible and bonded with a magnetic compound is that they may be bent, twisted, coiled, die punched, and otherwise machined into almost any shape without loss of the magnetic field. Under normal working conditions, flexible magnets are desirable due to their lack of a need for coating, are corrosion resistant, are easily machined, are easily handled, and may be bonded with a magnetic material having a high magnetic energy.

Yet another magnetic material, e.g., rare earth metal magnets, may be incorporated into or even coated onto a flexible backing material, such as plastic, nylon or polypropylene, and will provide excellent magnetic strength and flexibility. In addition, the flexible magnets may be made very thin, e.g., with thicknesses of 1/18th of an inch or less.

Flexible magnets may also be attached to the magnetic holding device of the present invention using adhesives that are suitable for a wide range of environments. The type of adhesive used to attach the flexible magnet will depend on the particular application, for example, the adhesive may be pressure sensitive. The magnet(s) may be laminated with, e.g., a pressure sensitive adhesive. Adhesives for use with the present invention will be known to those of skill in the art.

Alnico magnets are composed primarily of alloys of aluminum, nickel and cobalt and are characterized by excellent temperature stability, high residual inductions, and relatively high energies. Alnico magnets are manufactured through either a casting or sintering process. Cast magnets can be manufactured to very high specifications and can have very specific shapes. Sintered alnico magnets offer slightly lower magnetic properties but better mechanical characteristics than cast magnets.

Alnico magnets are very corrosion resistant. While Alnico magnets are easily demagnetized, this problem may be overcome with simple handling instructions. Advantage of alnico magnets is the smaller effect that temperature has on its magnetic properties.

Plate Plugs. FIGS. 16a-16c show the use of mechanical and/or electrical openings to control entry of reagents into the wells 38 of the plate 32. Teflon™, molded sheet, and magnetic sheet, may even include individual plugs 104 that fit into the wells that are not intended to receive a given reagent just before that reagent is delivered and removes them just after delivery. Suitable plug 104 (e.g., stainless steel ball bearings and glass balls) may be used that are made of hard sheets of reusable mask material (with 384 holes in it) that are plugged prior to a synthesis run and then used just like the sheet type masks discussed above.

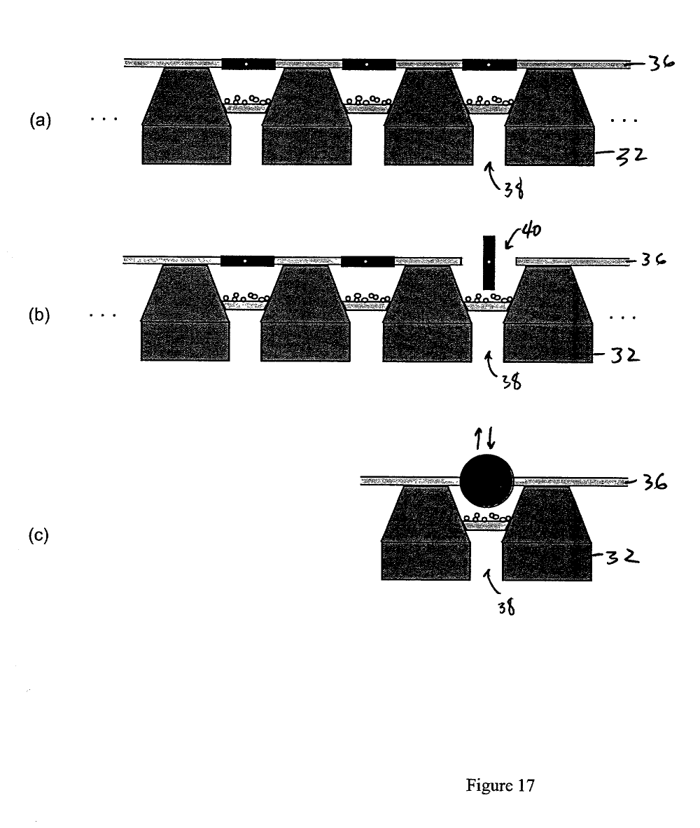

Mask with dynamically adjustable openings. FIGS. 17a-17c show other types of masks 36 provide a reusable mask that has some way of directing fluid away from the openings 40 of mask 36 at the wells 38 that are not intended to receive fluid (e.g., being closed electrostatically, etc.). In FIG. 17a all the openings 40 are closed and in FIG. 17b only the right-most opening 40 is open. The white circles in the center of the openings 40 in 17a and 17b and the white line in FIG. 17c indicate the rotation axis of the opening 40. When the right-most well 38 is rotated by 90° (FIG. 17c) the cross section of the opening 40 is shown, the lid may have a circular cross-section. The mask 36 uses dynamically adjustable openings 40 that may be individually addressed not unlike a DRAM or other electronic device.

For example, a mask for a 384-well plate may use one or more rows of dynamically adjustable openings that allow each of the 384 wells to be covered or open individually. The wells that are to be covered may be computer controlled for each step in the synthesis process. The use of dynamically adjustable openings alleviates the need to change the masks. The dynamically adjustable mask could stay in place during the entire synthesis run. Further, it simplifies the design of the machine and may have a smaller foot-print depending on the controlling electronics for the mask.

Plate Designs

Several different plate designs were studied that had to address the following criteria: (1) each well must have some type of a bottom filter to support a substrate, e.g., CPG; (2) reagents must reside in the wells long enough to react quantitatively; (3) addition of reagents must not trap bubbles in the wells; (4) CPG should stay inside the wells (with or without top filter); (5) the design must minimize reagent usage; and (6) masks (soft or hard) must seal without leakage between wells.

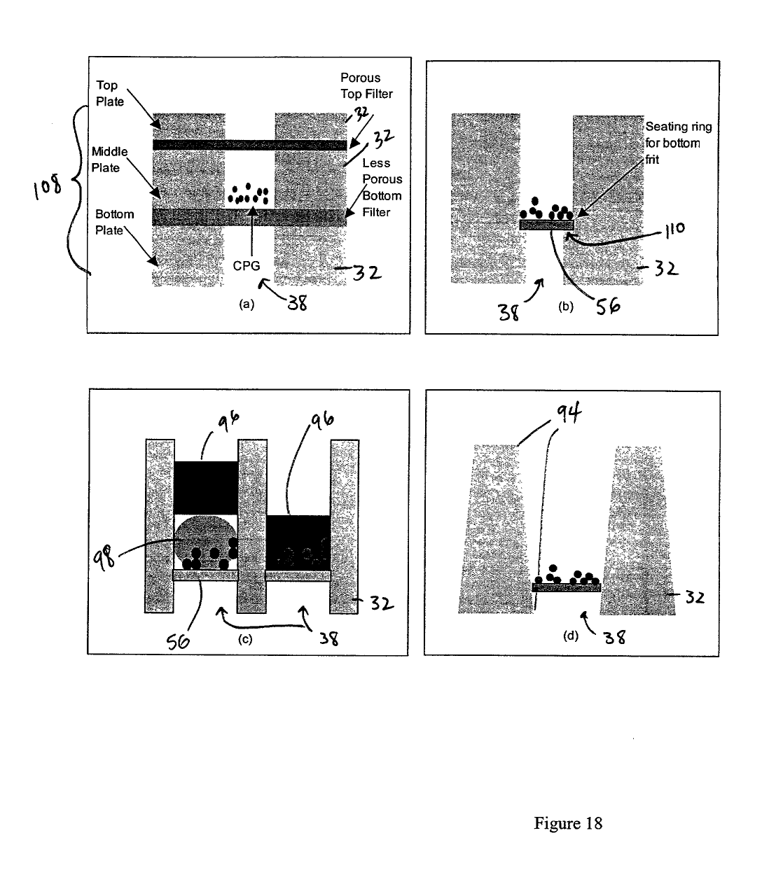

FIG. 18a shows plate designs using different plates 32 and membrane 60 configurations to sandwich 108 the substrate 58 into each well 38. These sandwich 108 designs were based on the expectation that the sandwiched membranes 60 would not allow leakage between wells 38. Some wicking was observed (i.e., fluid transfer by capillary action) through the filters.

Straight wells. FIG. 18b shows a plate 32 with straight cylindrical wells 38 (i.e., that had a straight cross-section), however, it was observed with the chemicals used that a lip was needed inside each well 38 to properly position the frit 56. Study of this design showed that bubbles 98 became trapped occasionally inside the wells 38 (FIG. 18c). Bubbles block reagents from reaching the synthesis substrate 58 and may cause overflow of the well 38. The bubble problem occurred frequently, about 10 random wells in one fluid pass became blocked, in particular when fluid 96 hits the bottom of the frit 56.

Angled Wells. The problem with bubbles, discussed above, was reduced greatly by changing the well design from cylindrical to conical (i.e., to an angled cross section) as shown in FIG. 18d. It was observed that since the wells 38 are conical 94, reagent or fluid 96 streams hit the sides of the wells 38 before reaching their bottom. The angled design reduced greatly the amount of bubble formation. In addition, nearly all of the bubbles that did form float readily to the upper surface of the fluid and burst. Well 38 sizes, frit 56 depth, exit hole sizes and plate 32 material may also be varied to minimize the occurrence of bubbles.

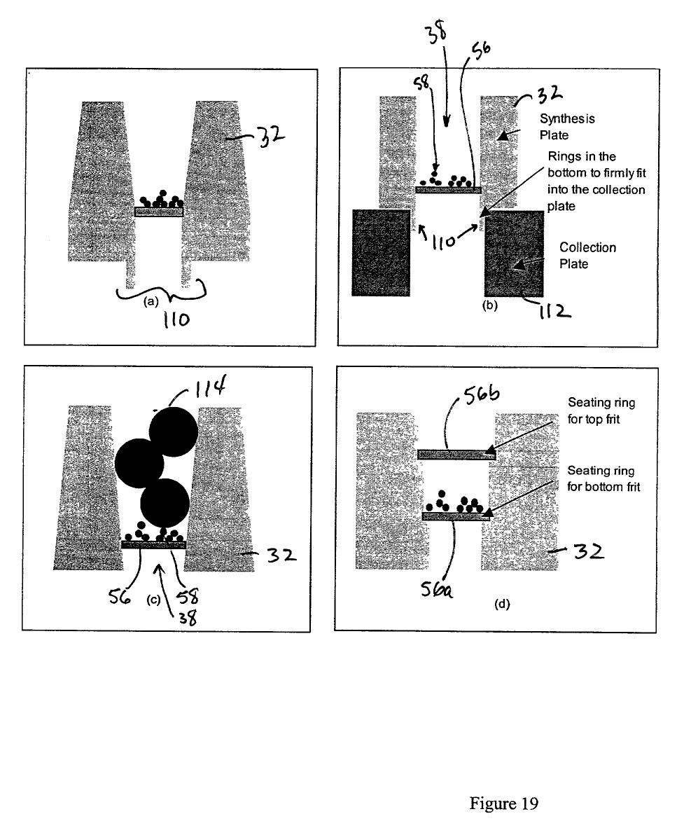

Improved Collection Design. Straightening the bottom of the well 38 further ensured proper seating of the frits 56 (FIG. 19a). After synthesis, DNA is removed from the support by passing a cleavage solution, typically aqueous ammonium hydroxide, across the support. The cleaved DNA dissolves in the cleavage solution that is separated from the support and collected. Product collection without cross-contamination or product loss was also found to be facilitated by appropriate well design. FIG. 19b shows one such design that includes a ring on the bottom of each well. The outer diameter of the ring 110 is approximately the same as the inner diameter of wells 38 in a collection plate 112. Thus, the synthesis plate 32 and collection plate 112 fit snuggly together, allowing liquid flow from synthesis plate 32 to collection plate 112 without material loss or cross-contamination.

Substrate Displacement. The streams from the injectors are delivered at a pressure that may lead to individual CPG being displaced from the wells of the plate. This displacement results in product loss or cross-contamination. To prevent substrate loss the following designs were investigated.

Top Frit/Filter. A top frit/filter 56b was inserted into the wells 38 of the plate 32 to prevent the substrate, e.g., CPG, from being displaced from the wells 38 when reagents were delivered to the plate 32. The top frit 56b design may be either a continuous sheet (FIG. 18a) or individual frit (56a, 56b) pieces placed into each well 38 (FIG. 19d). The top filter will generally be porous enough that synthesis reagents pass through, but not so porous that CPG is not retained. Some wicking from well to well occurred with the continuous filter. With the top filter is more porous than the bottom filter and the rate of fluid flow through the well was too slow, which led to poor mixing inside the reaction volume.

Glass Beads. FIG. 19c shows another idea to control substrate 58 loss that includes multiple glass beads 114 (e.g., approximately 2.5 mm in diameter for a 386-well plate) inserted into each well 38 on top of the substrate 58 (FIG. 19c). These beads 114 prevent the reagent streams hitting the substrate 58 directly. CPG did adhere to the glass beads during the synthesis run, with CPG migration to the top of the glass beads (due to filling the well with reagent over and over again), thereby reducing the contact with the synthesis reagents.

Deeper Wells. Another design is the use of increased well depth. The deeper wells led to additional acetonitrile wash steps in the protocol to ensure that CPG were not adhering to the walls, which could have caused poor synthesis results. With proper adjustment of the streams coming out of the injectors, the CPG was not displaced from these deeper wells.

Soft Teflon™ Mask. Another well design incorporates soft Teflon™ masks. Soft Teflon™ masks have great chemical compatibility and are easy to handle. The design parameters for the use of soft masks have already been described hereinabove, in particular the need to seal the plate with no cross contamination.

Dedicated Vacuum Holes/Grooves. In this design several vacuum holes 88 in various positions surrounding the synthesis wells 38 (FIG. 20) are added. These vacuum holes 88 allowed vacuum to pull a mask down in positions between the wells 38 thereby leading to a good seal between the mask and the plate 32. FIG. 20 shows various designs that may be used to provide vacuum holes 88 and/or grooves or troughs. The grooves serve as a drainage device by directing fluid flow so that reaction chemicals does wick between the mask and the plate 32 into the dedicated vacuum holes 88 of the wells 38. Vacuum holes 88 both with and without grooves permitted some cross-contaminations between wells 38 and may be angled, horizontal and/or vertical with respect to the plane of the plate 32.

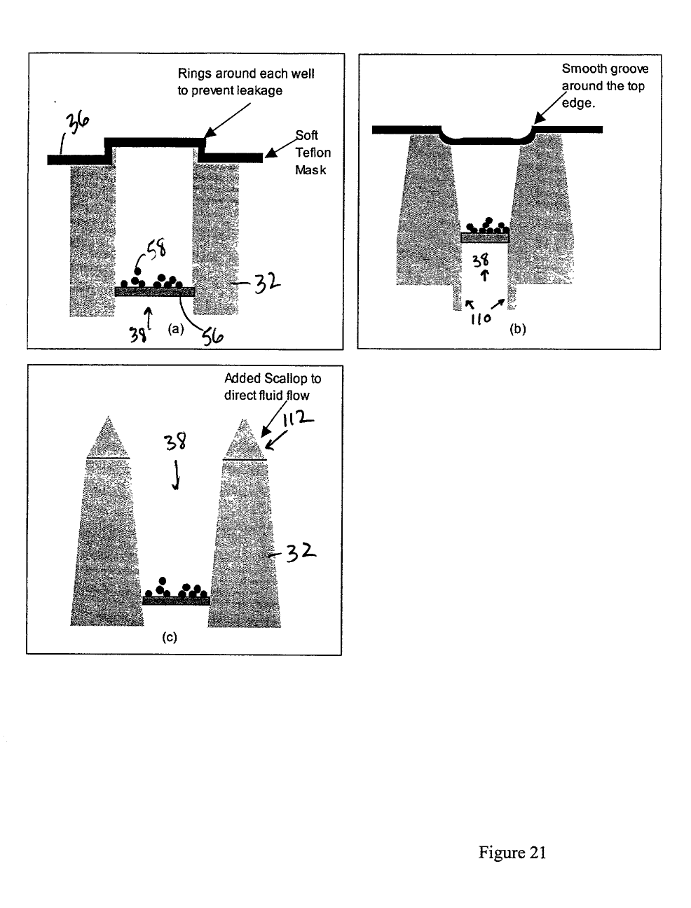

Indentation. A plate 32 with rings around each well 38 was designed to improve the seal between the mask 36 and the plate 32 and thus prevent leakage (FIG. 21a). Some cross-contamination was observed with this design with the reagents used.

Grooves. Another alternative is to use wells 38 that have a rounded top edge (FIG. 21b). Soft mask 38 are deformed slightly by vacuum and form a good seal in this edge. Some cross-contamination was observed with this design with the reagents used.

Scallop. After reagent deposition, it was discovered that some reagents were left sitting on top of the plate 32 between the wells 38. In order to minimize reagent usage, a plate 38 was designed with scallops 112 around the top of each well 38 to direct this fluid into the wells 38 (FIG. 21c). This design led to some difficulties sealing the mask.

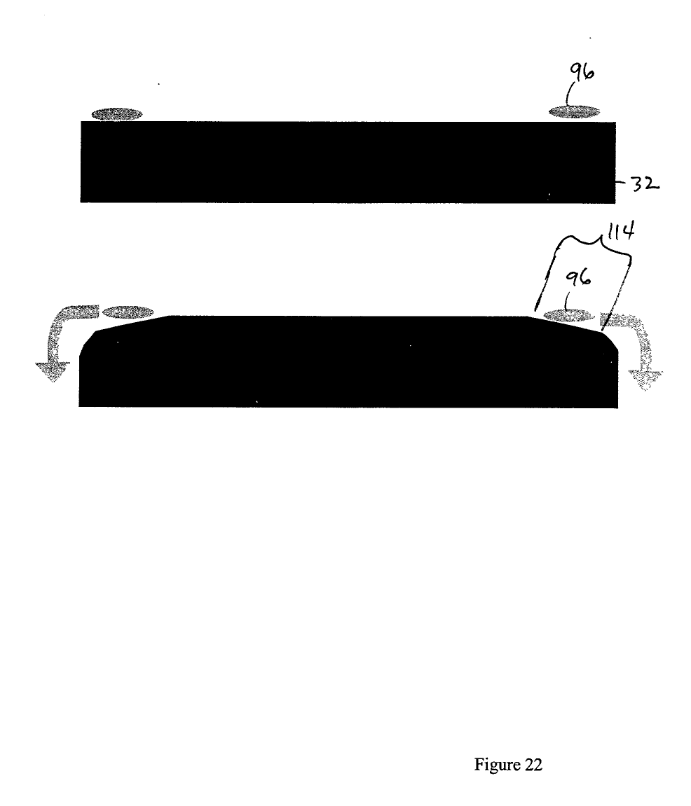

Angled Plate. Occasionally, it was found that excess reagent of fluid 96 was left sitting on the edges of the plate 32 (FIG. 22). Most of these reagents were rinsed away with subsequent acetonitrile washes, however, sometimes left over reagents remained on the top of the plate 32. To reduce fluid build-up, smooth end edges 114 were added to the plate 32. The slanted edge design helped drain off excess reagents and prevented left over reagents from interfering with the next synthesis step.

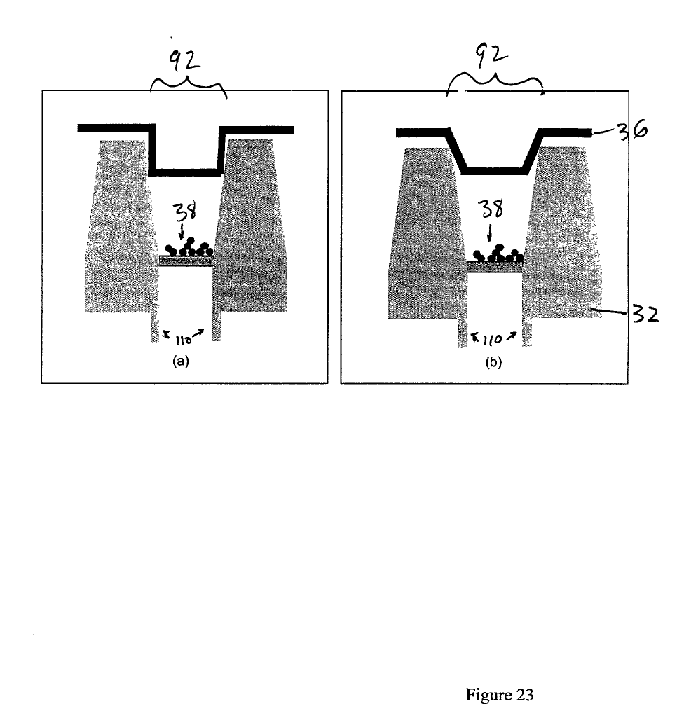

Molded Mask Design. A hard-mask mold 36 design was tested using Delrin (a material similar to Teflon™), in which the Delrin masks 36 had divots 92 and included an angle that was slightly larger, equal to and less than the angle of the wells 38 (FIGS. 23a and 23b). The design in which the mask 36 divot 92 has a total included angle that is greater that that of the included angle of the well of the plate showed the least amount of leakage. A plate 32 that has wells 38 that have a total internal angle of 6° provided a good seal with pipette tips on the injectors, which had an internal 80 angle.

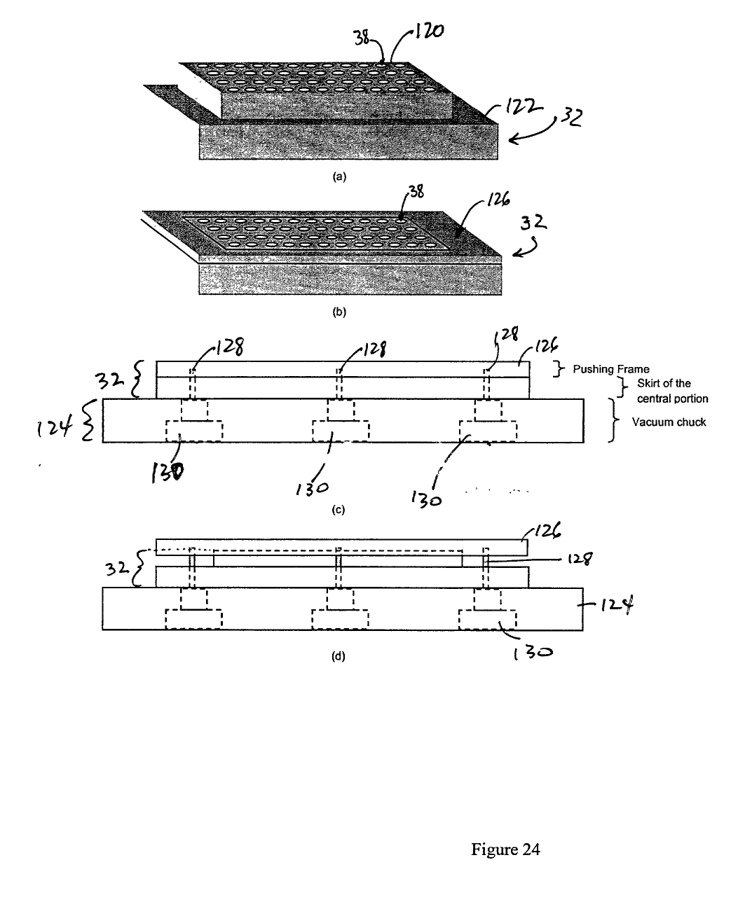

A mechanism for molded-mask removal that uses a “pushing frame” was also developed. The plate 32 may be modified further so that it may push a mask off of its top surface. The removal of the mask was accomplished by making the plate in two separate pieces (FIGS. 24a-24d). The first system used a plate 32 with central portion 120 that houses the synthesis sites (e.g., 384-wells) and a skirt 122 that wraps around some or all of the central portion 120. The skirt 122 allows, e.g., the plate 32 to be screwed down on to the vacuum chuck 124. Another part of the plate 32 is a continuous rectangular ring 126 (referred to as the pushing-frame), which wraps around some or all of the first part and sits on top of the skirt 122. Plungers 128 of air cylinders 130 (not unlike those to punch masks) are embedded in the vacuum chuck 124 that extends through the skirt 122 of the plate 32 and are rigidly connected to the ring 126. When the air cylinders 130 are actuated the ring 126 is lifted up off the plate 32 (FIGS. 24a and 24b). It is this upward movement that pushes a mask (not depicted) off the surface of the plate 32, thereby removing the divots of a hard mask from the wells of the plate 32.

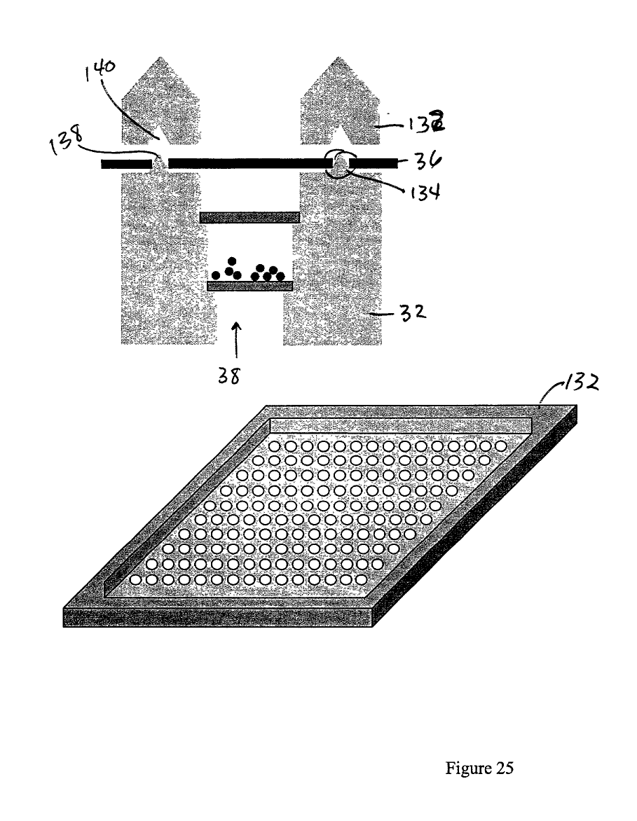

Sealing Aid. FIG. 25 shows an improved sealing system with soft Teflon™ masks 36 may be achieved by using a specially designed pushing frame 132. In this design the pushing frame 132 would have 384 holes situated above the 384 wells 38 of the plate 32 and would have supplied a force on the mask directed toward the plate. The mask is pressed into the plate hard enough to form a physical seal 134 that would prevent wicking between the mask 36 and the plate 32. In addition, sharp rings 138 may surround each well 38 of the plate 32. These rings may be aligned with complimentary indentations 140 on the pushing frame 132 to form a physical barrier between wells 38 and thus prevent fluid flow between wells.

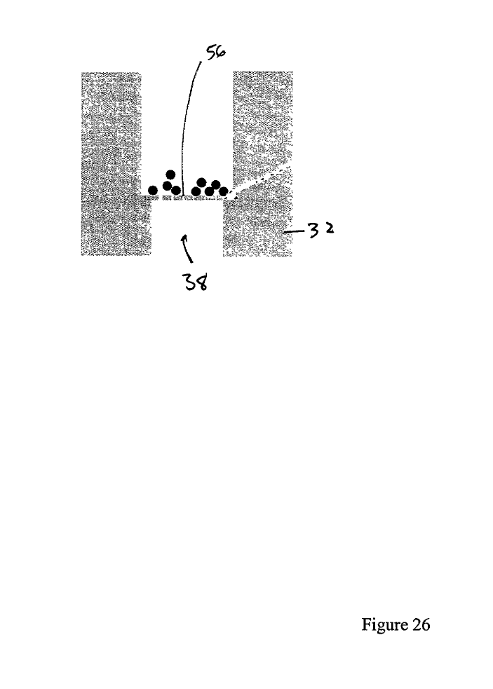

Laser Drilled Wells. Frits 56 may also be integrated into the plate itself. Laser drilling would leave a thin disk of material in each well 38 that would then be perforated by drilling small holes in the plate 32 material using either a laser or a very small drill (FIG. 26).

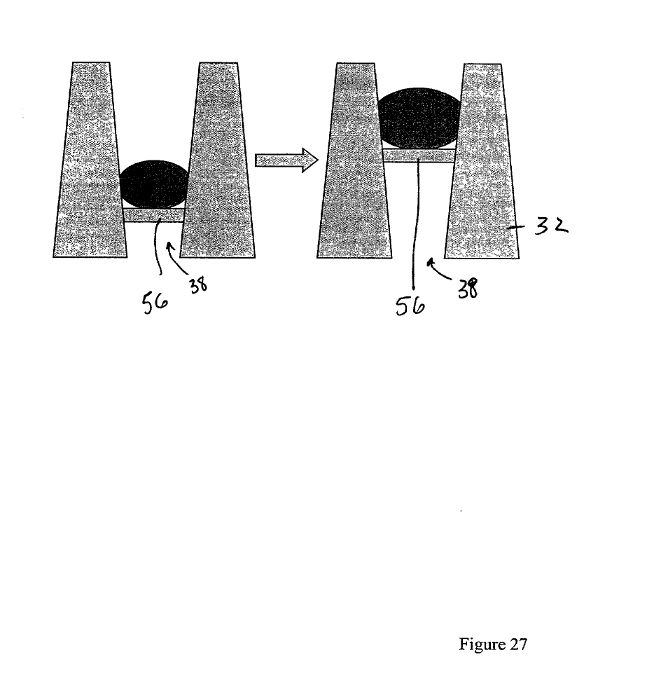

864-Well Design Scale-up. Material and well dimensions of the plate were studies using a 5″×5″ square Delrin plate, which was drilled with various well sizes. Angled wells did not solve completely the bubble problem. Since the well size for an 864-well plate is smaller than that of a 384-well plate, it is more favorable for bubbles to stay in contact with the well surfaces than to burst. In addition, 864-well format well diameter is limited to increases of less than, e.g., 0.116″. Widening the well size did not contribute significantly to reduce the bubble problem. Another possibility is to decrease the frit 56 depth (FIG. 27). Making the frit higher effectively forces the bubble to expand, but this also decreased reaction volume.

The plate material may also be altered in order to change the surface energy between the bubbles and the walls of the plate and the frit. When the plate is made out of Teflon™, bubbles tend to stick to the edge of the wells (instead of the bottom), which clog up the well and makes it unusable. Finally, the gas in the chamber was changed during synthesis, e.g., argon or helium. These two types of gas are relatively heavy. Helium was tested in a dry box with one of our well designs that had performed poorly. The change in the reaction gas solved the problem with excessive bubble formation.

Deblock Solvent. Another solution to the bubble problem was to change the solvent used in deblock. The current commercial deblock uses dichloromethane with 3% trichloroacetic acid. Chloroform and dibromomethane were substituted as solvents by dissolving 3% trichloroacetic acid into each, and depositing these new solutions onto the plate. The chloroform solution showed a slightly improved liquid flow as compared to commercial deblock. Bubbles still formed occasionally and became trapped inside wells. Tests also showed that adding surfactants (Tween 2000) into the deblock did not aid fluid flow using these reagents.

Car Washes

In order to deliver fluids evenly to the wells of the plate or “car”, delivery heads (e.g., a manifold, injectors, injector heads, spray heads or the like) were designed that act in a manner similiar to a car wash. The plate is driven using a linear drive under the injector heads that deliver chemicals to the surface of the plate. The present invention is an apparatus, system and method for directed, controlled chemical synthesis that is designed and built to deliver chemical reagent to a car that is driven under the car wash heads. Both 384-well and 864-well applications were studied, however, any number of shapes and sizes for both the plates and the wells in the plates will be useful.

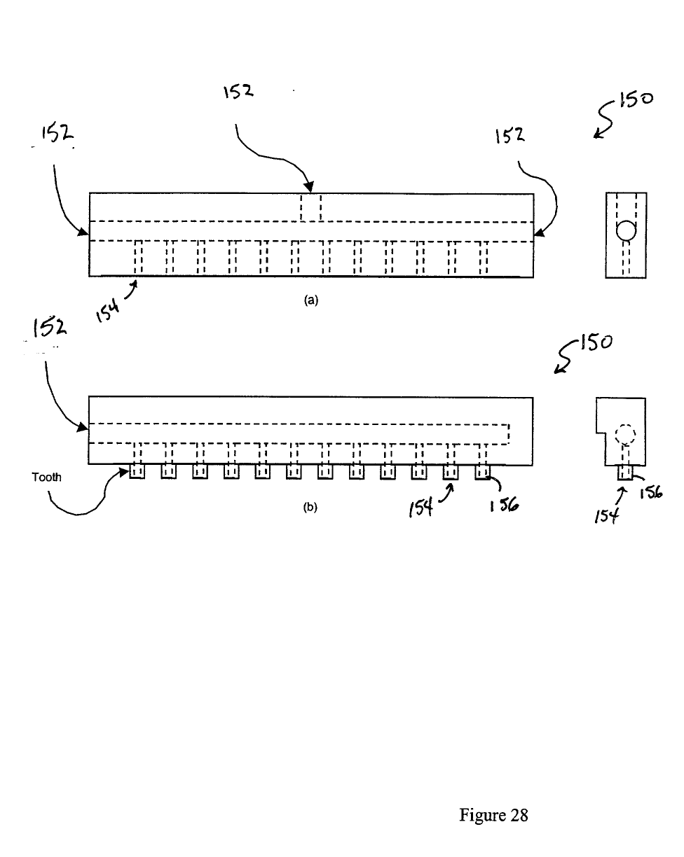

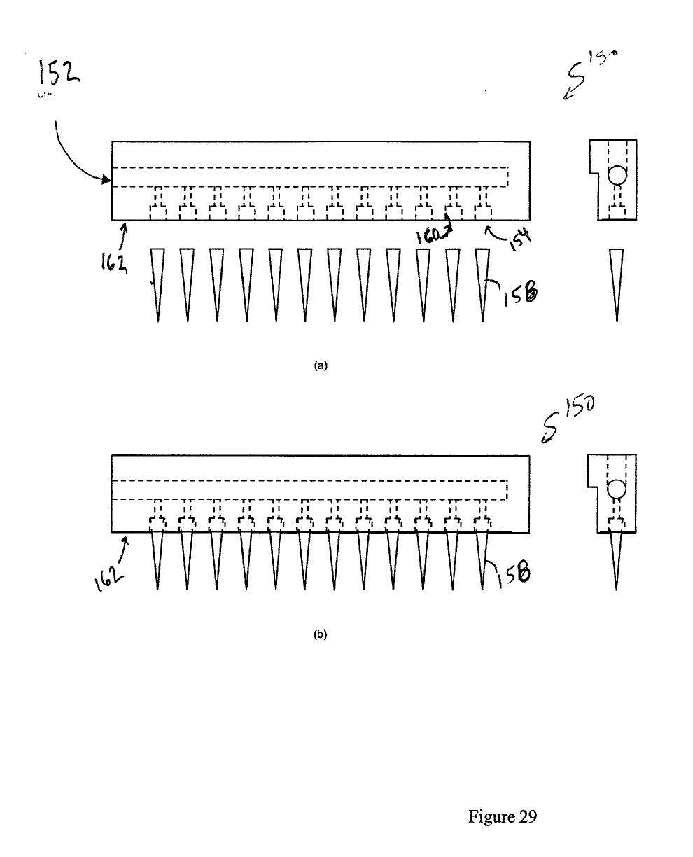

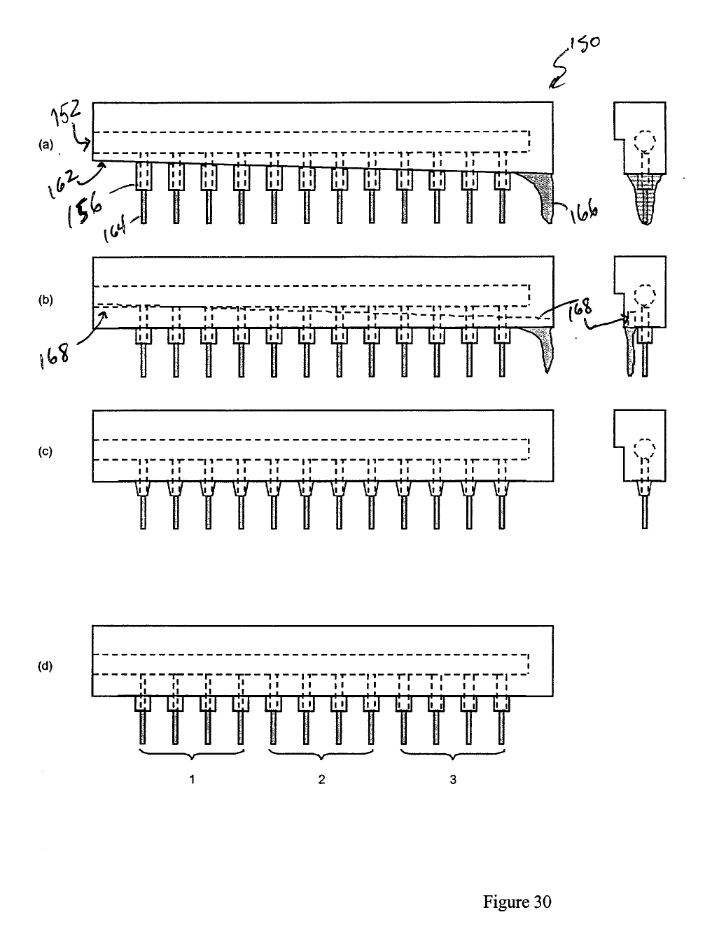

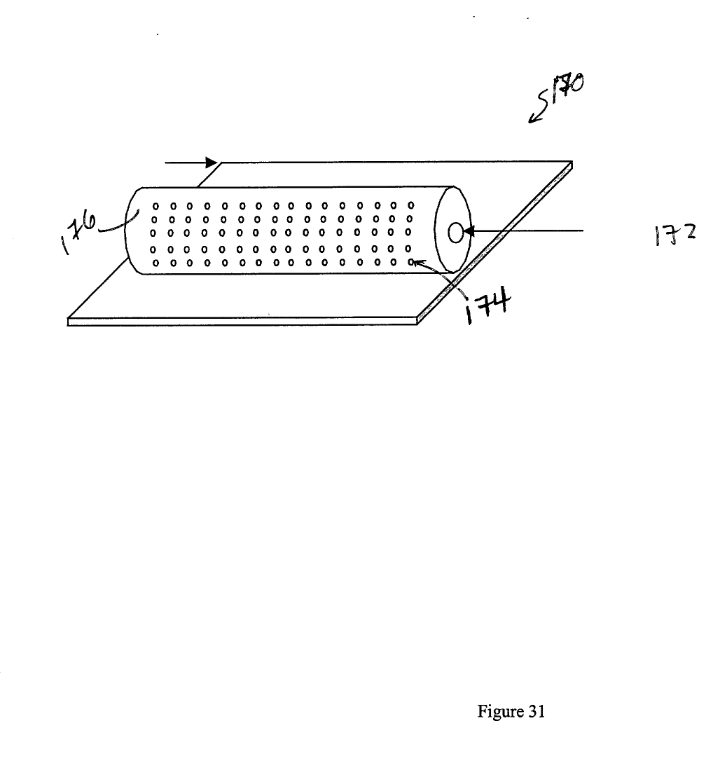

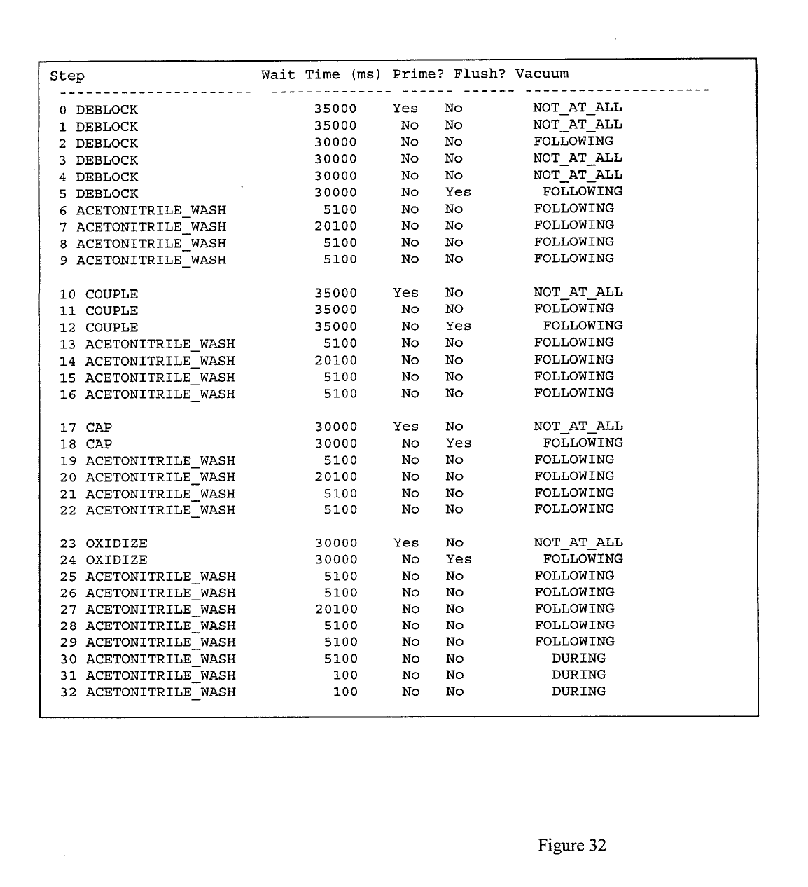

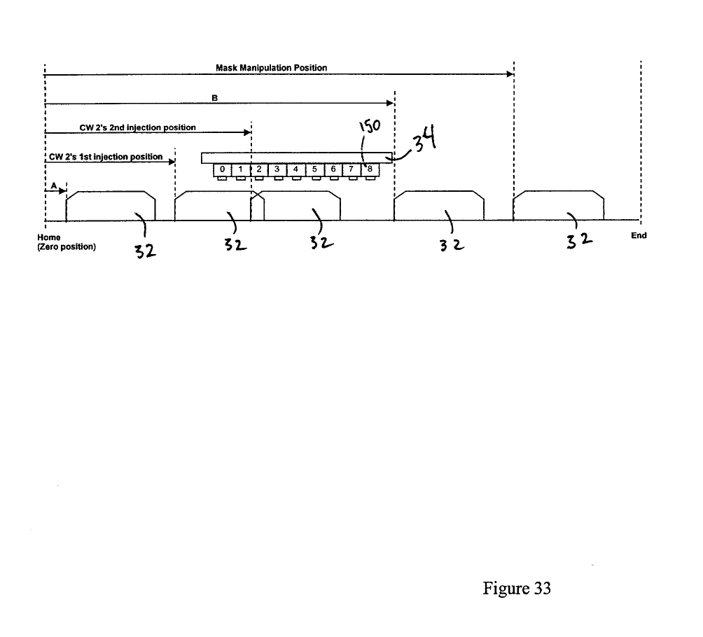

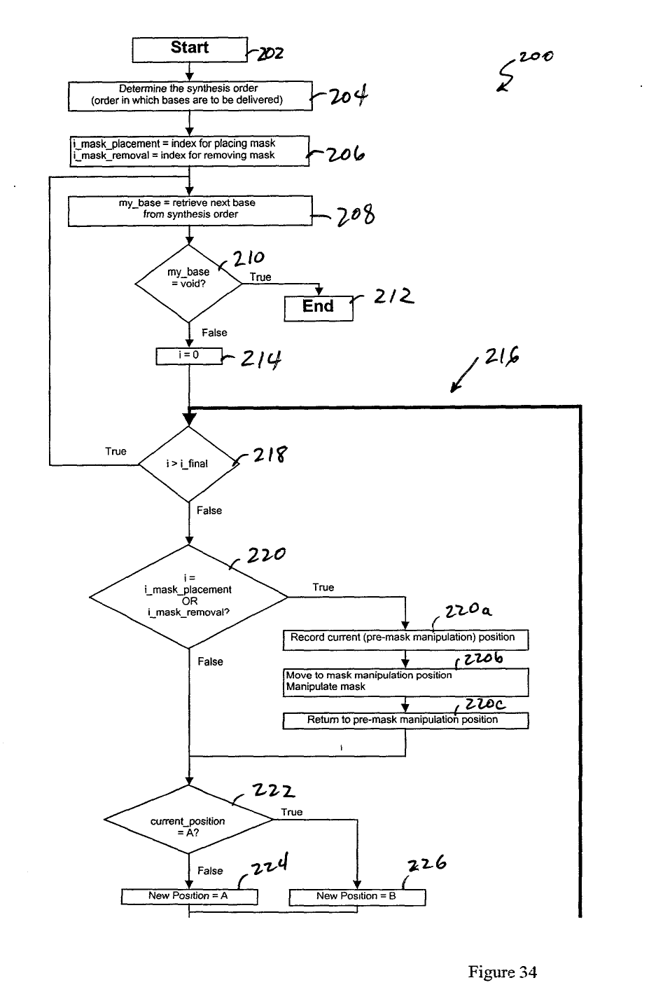

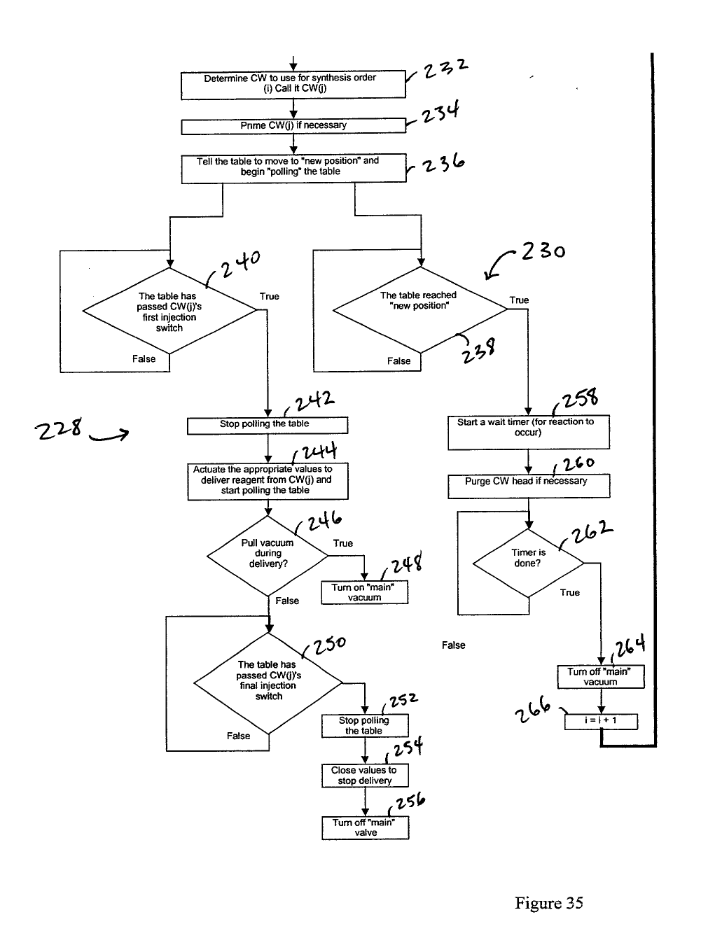

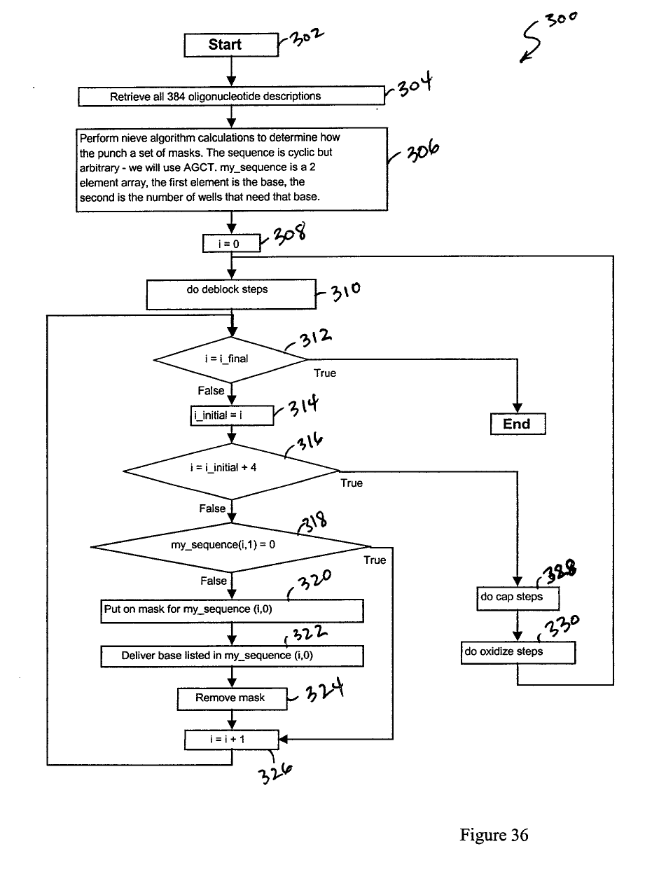

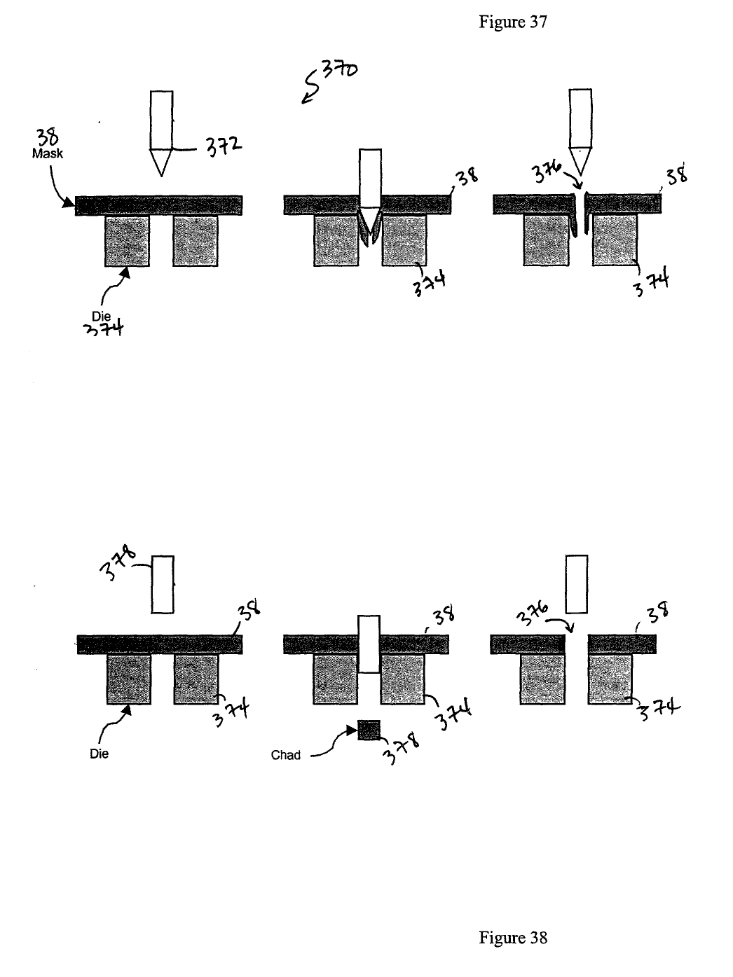

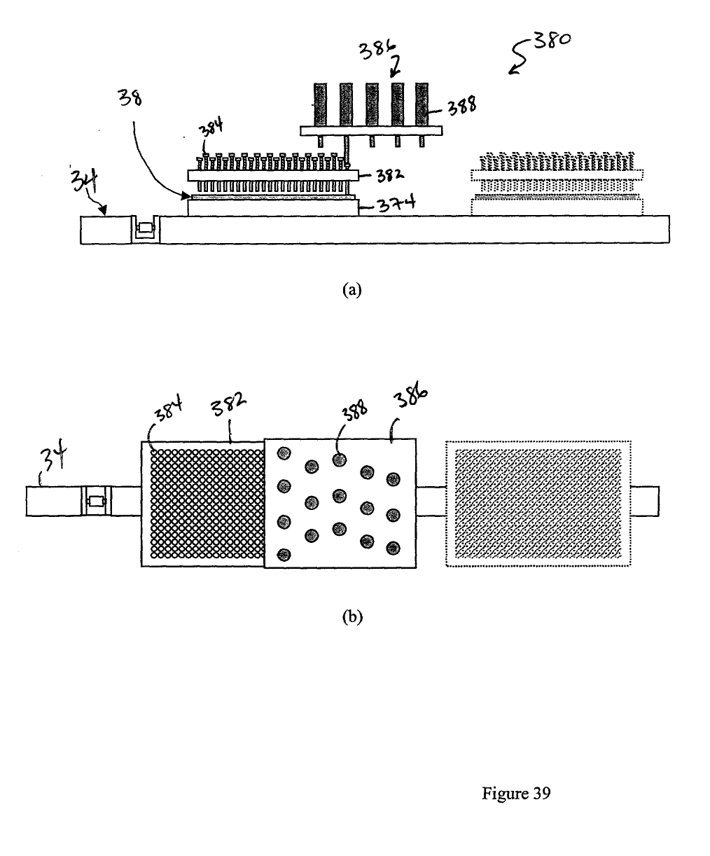

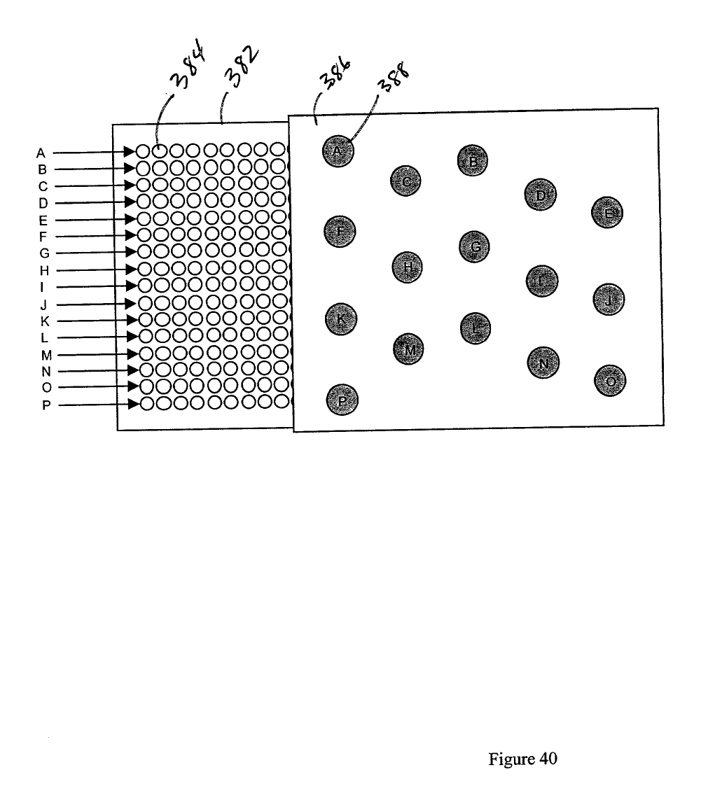

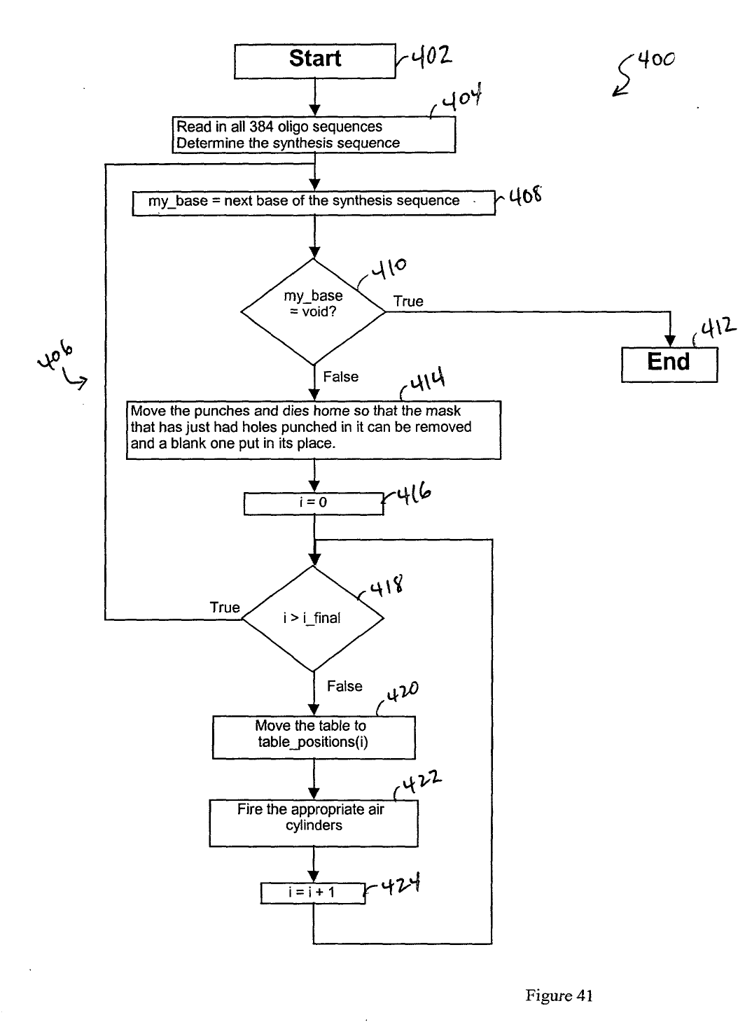

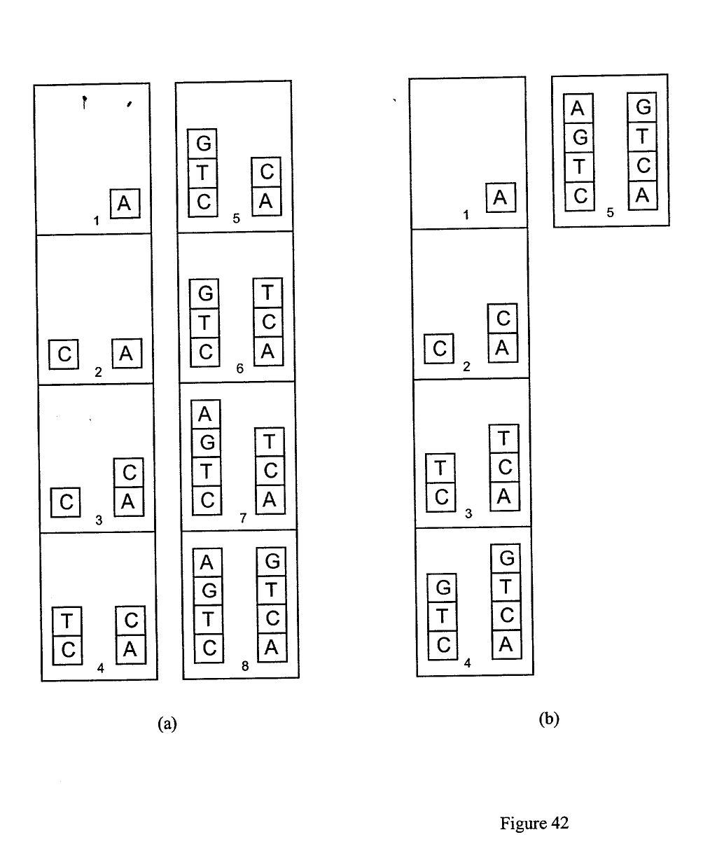

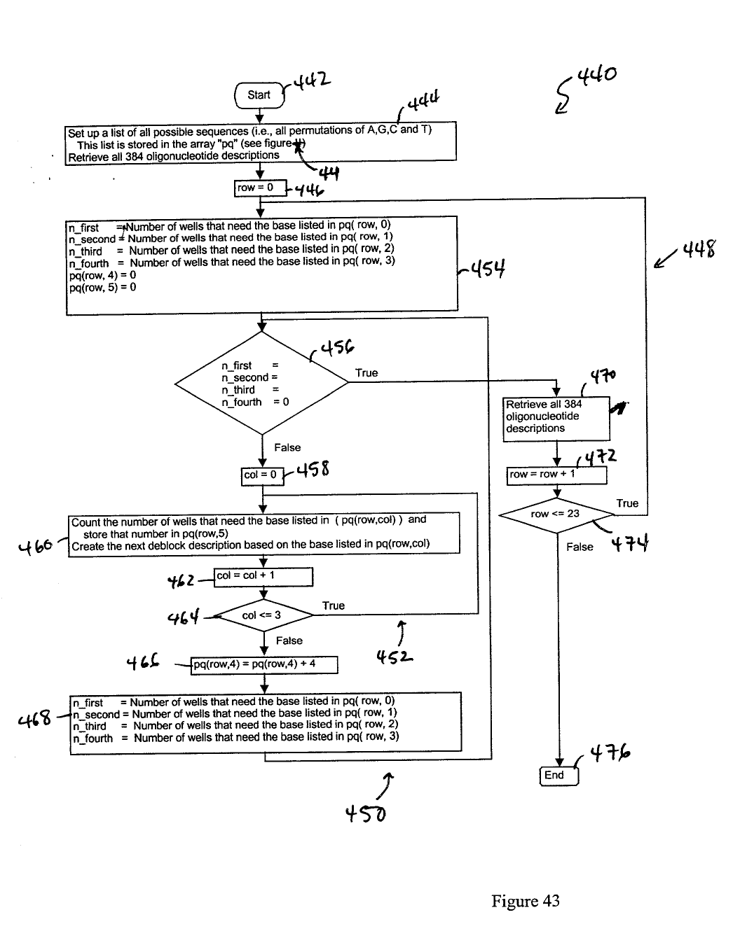

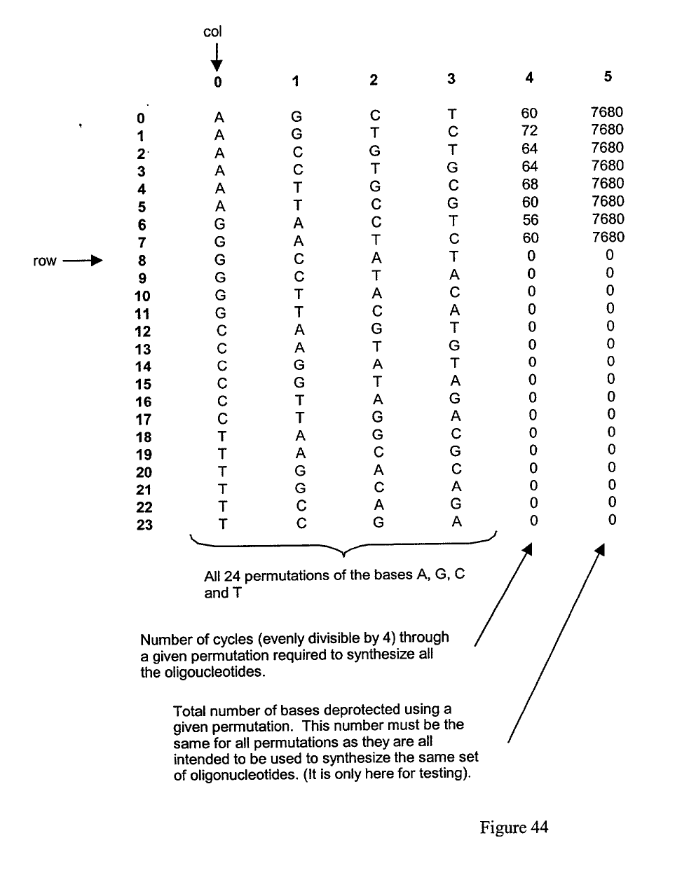

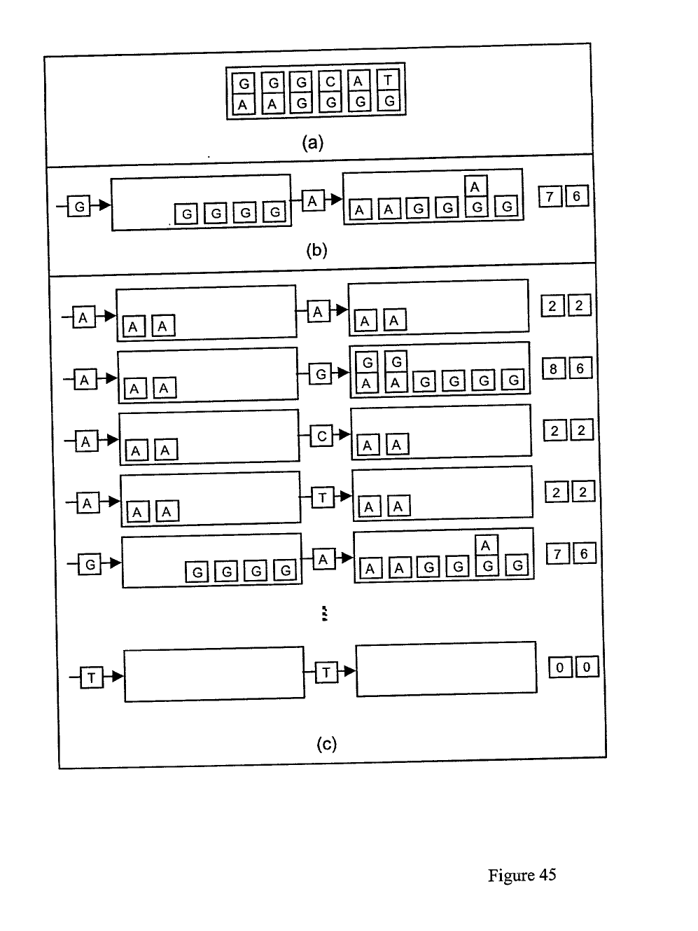

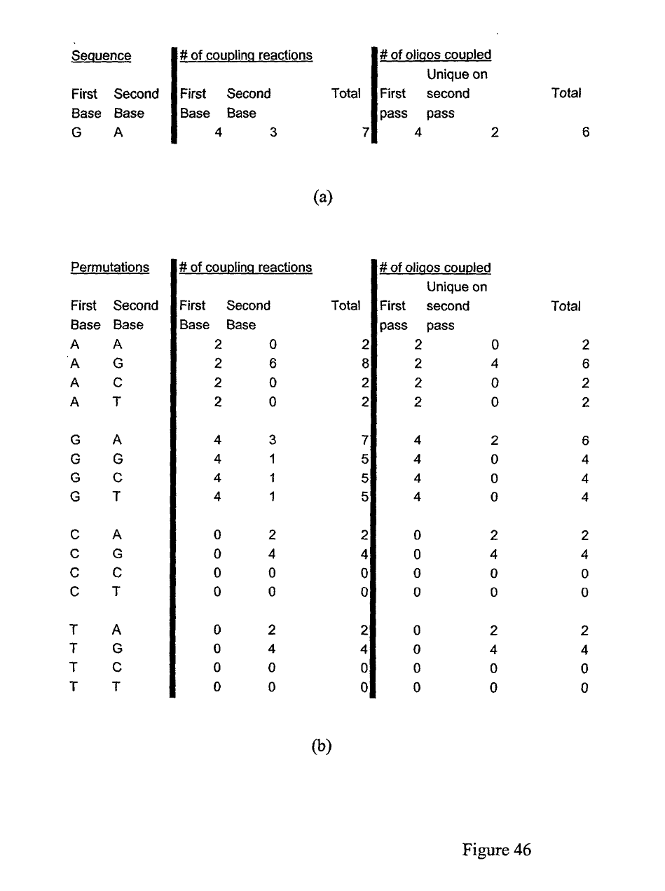

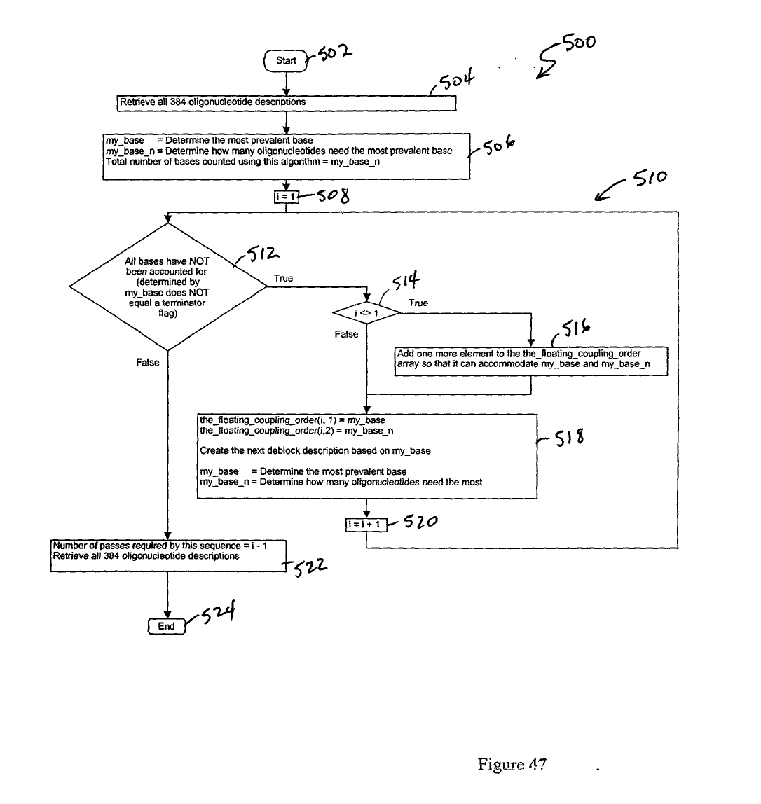

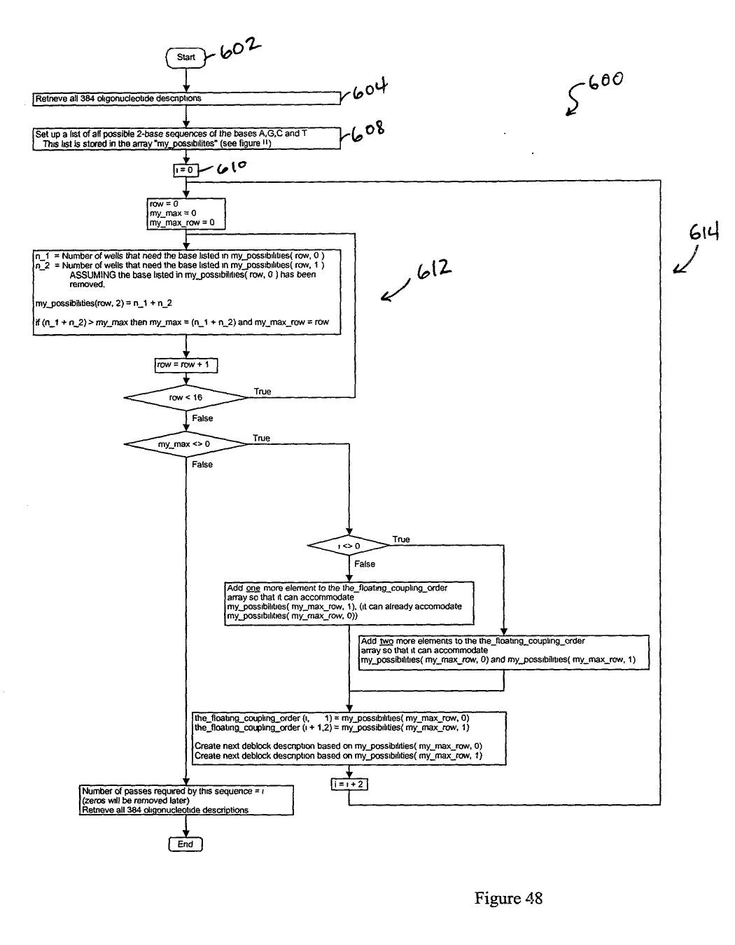

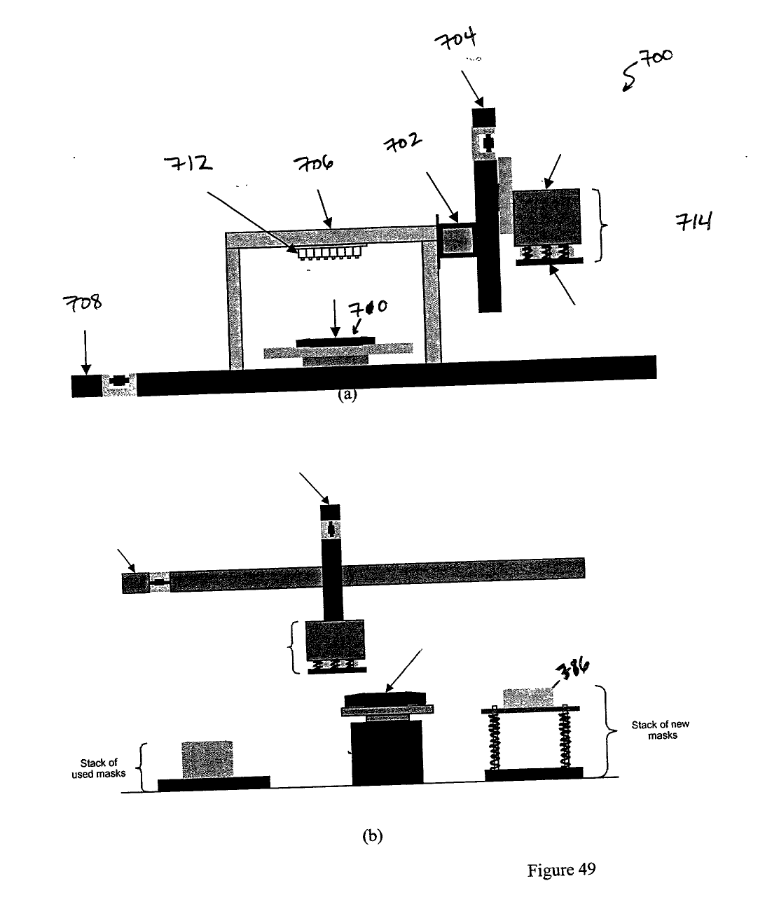

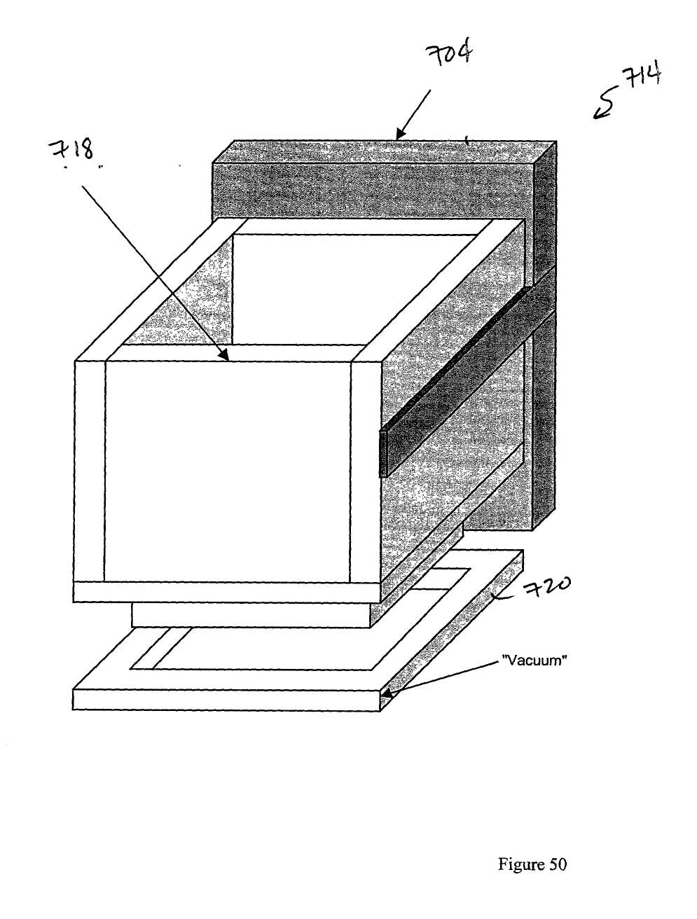

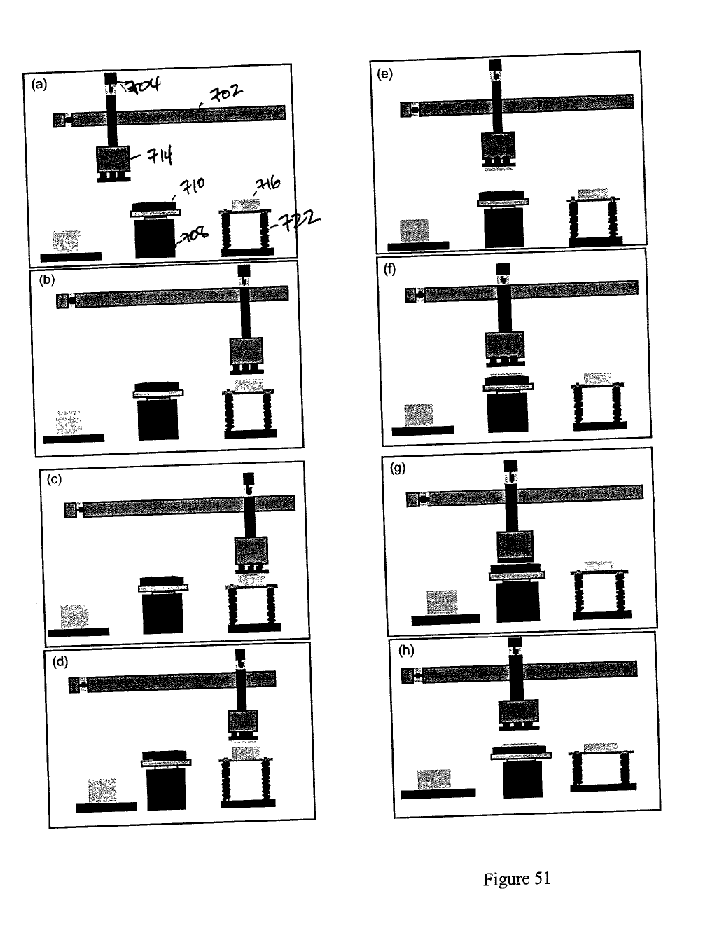

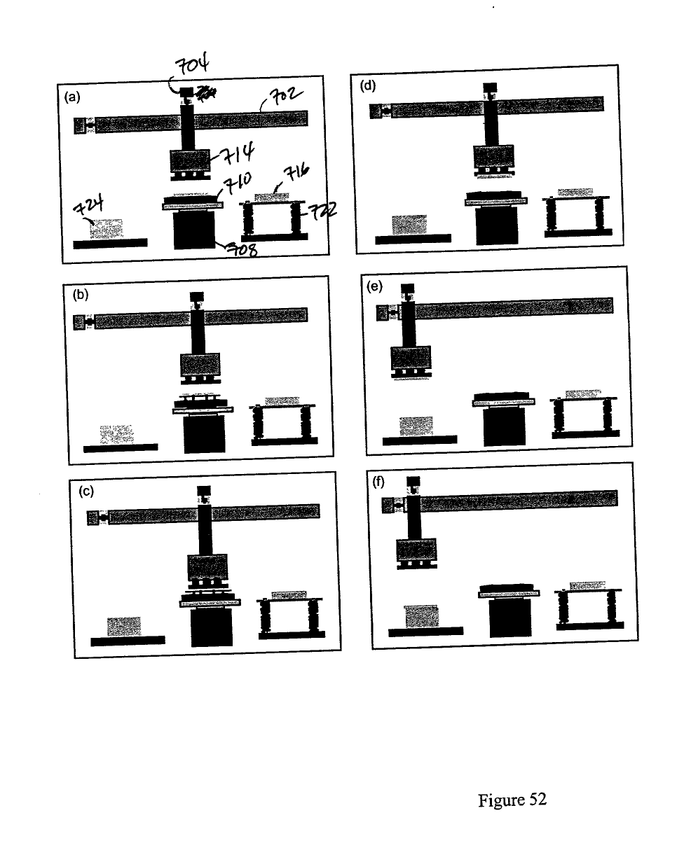

Design for 384-well plate. FIGS. 28a and 28b show an injector manifold 150, in which the most basic form of a “car wash” design is to drill holes in, e.g., Teflon™ tubing. The most general injector manifold 150 has three inlets 152 and a number of outlets 154. The inlets 152 may include one for the reagent (e.g., deblock, cap A, etc.), another for acetonitrile (to clean out the residual chemicals after reagent delivery) and an argon inlet to blow the injectors dry after it is cleaned with acetonitrile (to prevent chemical crystallization).

The injector manifold 150 may be made from a block of Delrin (a material with similar chemical compatibility to Teflon™) (FIG. 1a). In one embodiment, the block has a 0.125″ diameter hole drilled down its center, either end of which may be tapped for, e.g., a ¼-20 fitting for the reagent inlet line and the acetonitrile wash line. The block may also have, e.g, a ¼-20 hole at the top that serves as an Argon inlet. The outlets 154 have a spacing consistent with the well spacing of, e.g., a commercial 1,536 well plate (e.g., 0.0886″ apart in commercial versions). In general, the outlets 154 are spaced so as to line up with the wells of the plate and their number depends the number of rows in the plate: 16 for a 384-well plate (16×24), 24 for an 864-well plate (24×32) and 32 for a 1,536-well plate (32×48). The pressure needed to produce individual reagent streams out of the outlets 154 was large (approximately 20 psi), with a resulting stream that caused CPG to be displaced from the wells of the plate.

Car wash design. Several additional design modifications may be made to the injectors. The inlet for acetonitrile may not be necessary when 3-way valves are used in conjunction with 2-way valves. As a result the acetonitrile inlet may be removed. It was also found that it was not always necessary to dry the assembly with Argon following a wash with acetonitrile. As a result, the argon inlet is not always necessary. As depicted in FIG. 28b teeth 156 were added to the reagent outlets 154. The teeth 156 allowed the reagent pressure to be reduced to 10 psi without the loss of individual streams.

A spacer may also be built into each set of injectors. Spacers reduced significantly the amount of reagent that was travelling from the outlets 154 of injector to another injector outlet 154, assembly or rows (i.e., reduced the cross-contamination). The injectors for deblock, cap, A, T, C, G and oxidizer (i.e., all of them except for the one for acetonitrile) used have 16 teeth; each outlet 154 aligns with a row of the 384-well plate. This configuration minimized the amount of reagent that did not make it into the wells of the plate during reagent delivery. The acetonitrile injector manifold 150 may be used to deliver acetonitrile to the wells of the plate but also to wash the surface of the plate. And 18 injector teeth 156 design was made, 16 of which align with the rows of the plate. Additional teeth 156 were added to deliver acetonitrile to the edges of the plate. In one example, all of the injector manifolds, except for the one for deblock, are made out of Delrin. The deblock car wash may be made out of Teflon™ as it was observed that deblock may slowly dissolves Delrin. During some synthesis a flaky material building up was observed on the deblock car wash, which turned out to be Delrin.

864-well car washes. Studies were conducted with injectors designed for an 864-well plate. An 864-well plate has 24 rows of wells instead of the 16 of the 384-well plate. An 864-well car wash design was identical to the final 384-well design in all aspects but the number of exit holes; 24 for all reagents except acetonitrile which had 26 on a center-to-center spacing of, e.g., 0.116″ in a commercially available spacing. The machined teeth of the injector manifold did not completely stop streams from coming together and machining smaller teeth led to design changes.

The teeth may be replaced with, e.g., a segment of a cut polypropylene pipette tip that fits into a large hole drilled in the injectors on the center-to-center distance of 0.116″. Though the pipette tips fit snugly into these holes, two methods of further securing them into position were also tested. As shown in FIGS. 29a and 29b, the body of the injector manifold 150 was made out of Delrin and the pipette tips 158 were secured with, e.g., silicon adhesive onto the bottom surface 162 of the injector manifold 150, or even into a recessed opening 160. The tips of the pipette tips 158 may be attached to the polypropylene injector manifold 150 by melting them into place using a heat gun. Both of these methods were used successfully to seal the pipette tips 158 into place. No leakage was observed when they were used to delivery acetonitrile, however, the polypropylene injector manifold 150 warped noticeably due to the heating, which gives the silicon adhesive method a definite advantage when working with polypropylene.

The final design of the 864-well car wash head is essentially the same as that of the 384 injector manifold. All injector manifolds may be made out of Delrin except for the one for deblock, which may be made of Teflon™. As with the injector manifold for the 384-well plate they may have, e.g., 24 teeth with the modification for the acetonitrile injector, which may have 26 teeth 156 or other like extension. All the pipette tips 158 may be held in place with silicon adhesive.

Individual streams. As noted above, the outlets 154 of the injector manifold 150 are aligned generally with the rows of a plate. When multiple streams coalesce into a single stream two problems arise. First, some wells receive more reagent than expected leading to their overfilling. Second, other wells do not receive enough reagent that may lead to a chemical reaction not going to completion.

In FIGS. 30a-30d reagent is being delivered as individual streams 164 by the teeth 156 of the injector manifold 150. After a period of time excess reagent or fluid 166 begins to build up in between the teeth 156 as shown in FIG. 30b. Two streams 164 often coalesce into one which forms a mechanism for the fluid 166 build-up to drain. Once drained, the streams 164 stay together and the build-up does not occur again.

Several methods may be used to stop streams from coalescing. These include the following: (1) the injector manifold 150 may be made out of a more hydrophobic material. One choice is to use Teflon™ instead of Delrin though other materials may be used. The bottom 162 of the injector manifold 150 may be machined with a slant as shown in FIG. 30a. This slanted injector manifold 150 design was tested with Delrin. Instead of slanting the whole bottom 162 of the injector manifold 150, a groove 168 may be machine into the bottom 162 that runs along the entire length of the injector manifold 150. Various shapes and lengths for the teeth 156 are also shown in (FIGS. 30a-30d)

Positioning. During synthesis streams coming out of an injector manifold lead occasionally to displacement of CPG from the wells of the plate (i.e., the reagent splashes enough that CPG can be carried outside of a well). Loss of CPG is undesirable as it leads to cross-contamination of the oligos being synthesized and yield loss. The problem of CPG loss may be addressed, e.g., by changing the alignment of the injector teeth and the plate. Instead of aligning the injector streams directly in the center of the wells, the teeth may be aimed so that the streams hit the edge of the well wall. The streams may be directed to lose momentum before encountering the CPG thereby reducing splashing.

Injector manifold hole size. To get consistent synthesis results across the entire surface of the plate it was necessary to ensure that all the wells received the same volume of reagent. Though tests have shown that the volume delivered by the various outlet holes of the 16 tooth injectors (at a normal operating pressure of 10 psi) is the same, concern over injectors with more teeth was addressed. One possible solution was to make the size of the various outlet different. This is illustrated in FIG. 30d. The diameter of the outlets in group 1 are smaller than those in group 2, which are smaller than those in group 3.

Roller. FIG. 31 shows a roller 170. The roller 170 may have, e.g., a single inlet 172 and several outlets 174. The outlets 174 were at the center of ‘bumps’ on the roller 170 that were arranged on the surface 176 of the roller 170 so that as the roller 170 rolled the bumps pressed into the wells of the plate. This design has two main advantages. First, it minimizes the time a given reagent is in contact with the atmosphere. Synthesis in a dry atmosphere still contains some water, which terminates, e.g., DNA coupling reactions. Second, it minimizes the amount of reagent used. Main program

The computer code developed to implement the mask-based DNA synthesizer may be written using, e.g., Visual Basic (VB) and compiled using the Microsoft Visual Studio version 6.0 on a Windows NT Workstation, version 4.0. The code that controls the synthesizer (i.e., the movement of the tables and the actuation of the valves) when it is used in either the “mask-deblock” mode or the “mask-phosphoramidite” is discussed in detail hereinbelow. The code that determines the order in which bases are added (and thus which holes are punched in a set of masks and which mask to position over the wells) may be an integral part of the synthesizer itself. Alternatively, the hole-punching code may be performed by a separate mask-making machine.

The basic idea behind the operation of the present invention, using DNA synthesis as an example, may use a protocol as shown in FIG. 32. Every step of this 33-step protocol (numbered 0 to 32) includes the following: a description of the reagent to be flooded (deblock, acetonitrile); how long to wait after the flooding (in milliseconds); whether the injectors are primed before flooding; whether the injectors are flushed with acetonitrile after flooding; and when, and how, to apply vacuum to the plate and when to move the plate.

FIG. 33 shows how this protocol involves shuttling the plate 32 back and forth below the injector manifolds 150 (one for deblock, one for A phosphoramidite, etc.) between two positions, A and B. In neither position are the injector manifolds 150 directly above the plate 32. Reagent delivery occurs while the plate 32 is moving in either direction, A to B or B to A, and is triggered by the position of the plate 32 on its journey from one position to the other. For example, suppose the plate 32 starts from position A when injectors 2 deliver reagent. Injectors 2 will not begin flooding until the plate 32 reaches “injectors 2's first injection position” (i.e., on its way to position B) and will not stop flooding until the plate 32 reaches “injectors 2's second injection position” (also on its way to position B). Only one injector manifold 150 will generally deliver reagent on any given pass and which one performs the delivery may potentially change every pass.

Other mechanisms may also be added to enhance the efficiency of synthesis. First, the plate 32 will often need to wait for a period of time when it reaches position A or B to allow chemical reactions to take place. Second, the reagents must be removed from the wells by, e.g., pulling vacuum below all of the 384 wells of the plate 32 at once. Reagent removal may be done while a reagent is being delivered, after the reagent is delivered or both. Third, it is often necessary to prime the injectors of the injector manifold 150 with the reagent it is to deliver before it begins to flood (i.e., fill the injectors with reagent) and after to flush it with acetonitrile. Delivery of the correct reagent is achieved by moving the plate 32 to one of two positions underneath a given injector manifold so that reagent (or acetonitrile) can be deposited directly into a waste reservoir (i.e., not onto the plate itself). Flushing the injector manifold 150 may be accomplished while the plate 32 is waiting for a chemical reaction to take place since it does not involve adding or removing reagents from the wells. Finally, a mechanism of mask manipulation, of applying and removing of a mask, may be integral or apart from the reaction equipment.

FIGS. 34 and 35 illustrate the flow diagram 200 of the method and system of the present invention in “mask-deblock mode. The synthesis order is determined by the specific chemicals used for the reaction, in addition, the mask-making machine may inform the synthesizer of its synthesis requirements and the protocol indices that will trigger mask manipulation to be performed. The flow chart 200 begins at start 202 followed by the determination of the synthesis order 204, which is the basis of the highest level loop in the program and is controlled by the variable my_base. The next-highest loop is that which steps through the protocol of FIG. 32, here indexed by the letter i at step 206. Next, the next base is retrieved at step 208, followed by a decision block in which the program determines if all bases have been retrieved, if they have all been retrieved, the program ends at 212. If all the bases have not been retrieved, at step 214, then the program queries the mask retrieved loop 216.

Once within loop 216, a decision is made as to whether mask manipulation steps (218, 220) are performed (this is normally performed on the first deblock step and the second wash step following the last deblock step), the next position 222 to which the plate will shuttle (“new position” is set to either A or B (224 and 226, respectively)), the injectors that will flood reagent during this shuttling is determined (referred to as CW(j) in FIG. 35) and that injector manifold is primed. Once the linear drive or table is directed to move to this new position two paths are taken simultaneously (see FIG. 35).

In FIG. 35, the loops (228, 230) that control the table may be polled continuously concerning the position of the plate. At step 232, the injector manifold that will be activated for synthesis is determined from the synthesis order; and that injector manifold is primed at 234, if necessary. Next, the linear motion table is activated to position the plate at the new “wash” position at step 236. Once the plate location is achieved, two concurrent loops are entered, namely loop 228, in which the position of the plate relative to the injector that is delivering reagent is monitored; and loop 230, in which the table position initiates a timer upon reaching the position for reagent delivery 238. Once the table reaches “CW(j)'s first injection position” at 240, polling temporarily stops at 242, valves are actuated so that flooding begins at 224 and, if need be, vacuum is pulled below the wells (246, 248). Once this is done polling the table begins again 250. When the table reaches “CW(j)'s second injection position” polling stops at 252, flooding stops at 254 and the vacuum is stopped at 256. These operations end the first path.

In the second path 230 the table is polled continuously concerning the state of its movement at 238; if it is moving it must not have reached “new position” yet (from position B to position A if it started at B and from position A to position B if it started at A). Therefore, the direction of table movements is maximized, as the direction from which the wells in the plate are filled is generally not important. Once the table reaches “new position” a timer is started that measures the time the table will wait in a given position at 258. The injector may be purged at 260, and timer position determined at 262. Vacuum may be pulled starting sometime before the end of the wait time but it will generally finish at the same time as the chemical reaction wait time and then turned off at 265. This second path ends by returning to the top of the second highest loop in the program, the protocol loop (i.e., the one indexed by the variable i) by moving to the next step in the synthesis order at 266. Once this loop is finished, determined by i equaling i_final, a new base from the synthesis sequence is found. If none can be found, the program is at its end 211.

In FIG. 36 the flow diagram for performing a synthesis run in “mask-phosphoramidite” mode is shown 300. (Some of the detailed mechanisms shown in FIGS. 34 and 35 (e.g., timers for polling the table, etc.) are not shown in FIG. 36 though they are still used).

This flow diagrams starts at 302 by reading in the description for all 384 oligonucleotides at 304 and determining the synthesis sequence using a nieve algorithm at 306, which resets the counter at 308. The program then gets into a loop of (1) performing deblock steps at 310 and checking the completion of synthesis at 312, comparing the synthesis order 314 and ascertaining the next base for injection at 316. If the synthesis is not complete, then the correct mask is selected at 318 and the mask for phosphoramidite i is added at 320, next, at 322 the phosphoramidite i is added and the mask is then removed at 324 (this is done for for i=A, G, C and T), followed by performing one or more capping steps 328 and finally (4) performing oxidizer steps.

Mask-Making Machine

The present invention also includes an apparatus, method and system for making the masks for the high throughput chemical synthesizer. The mask-making apparatus determines which holes are punched in a set of one or more masks (thus, the order in which, e.g., bases are added—the synthesis sequence or order). The mask-making apparatus and the mask made therewith permits delivery of reagents to many independent reaction areas or wells at once on a plate or substrate. As already discussed, two approaches have been developed to provide high throughput and volume: when the deblock is step is “masked” and when the individual coupling steps are masked. It has been found that altering the order of delivery is immaterial in affecting the length of the synthesis run. Similar to the method and system that controls the mask-based synthesizer, the code for the mask-making machine may be written in, e.g., Visual Basic (VB) and compiled using the Microsoft Visual Studio version 6.0 on a Windows NT Workstation, version 4.0.

Basic operation. To exploit the time (and reagent) saving advantage that the mask-based synthesizer the masks may be made by a mask-making apparatus completely separate from the synthesizer itself. The mask-making machine includes generally two main components; a mechanism for physically making holes in a mask (the hardware) and a way of determining where those holes belong (the software). The hardware includes an accurate positioning system and a mechanism for putting a hole in the mask. Several possibilities have been developed, e.g., using heat to melt holes in the mask, using either a laser or high pressure water to cut holes in the mask or a multi-step photolithographic or chemical-etching process to produce the holes. In one embodiment, an object is simply driven through the mask to form a hole. The software used to determine where the holes are located in a set of masks is discussed at length in the section entitled ‘computer code’.

Two examples of methods for punching holes in masks are described that use a computer to control a solid-state relay with, e.g., a DC signal. The first method uses cylindrical solenoids that are actuated by, e.g., a 12V DC signal, using a 13 V DC power supply used to offset the 1 Volt protection diode. Solenoids for use with the present invention are available from a number of sources, e.g., Magnetic Sensor Systems. Features for solenoids include a reasonably compact size (i.e., with a diameter on the order of 1″) and that produced a maximum force of, e.g., 3 to 4 pounds. These solenoids may have their plungers sharpened with a grinder, e.g. making holes in a fiberglass tape with an adhesive mask. Depending on the features of the solenoid, it will be useful that the plunger of the solenoid create the hole in one hit or pass. It is also useful if the resulting hole is not ragged because it may create problems with the consistency of the fluid flow through the mask. Plungers that tear or rip a hole in the mask tended to close-up significantly when the hole was not punched with the mask on the plate (i.e., during synthesis itself), a process that affected some of the time-saving advantage of the mask-based synthesizer.

FIG. 37 is a side view of a mask making plunger 370 in which a plunger 372, shown sharpened, strikes a mask 38 on a die 374. The plunger 372 tears or rips an opening 376 in the mask 38 that leaves portions of the mask 38 as part of the opening 376.

Air cylinders provided another method for punching holes in a mask. These simple, reliable cylinders are commercially available from, e.g., McMaster Carr. Devices driven by air pressure may be controlled using, e.g., a 3-way valve that is actuated by a 12 VDC voltage signal (again, a 13 VDC power supply may be used to offset the 1 Volt protection diode). Air cylinders provide significantly more force than the solenoids tested, providing 44 pounds of force at 100 psi (McMaster Carr part #6498K27, 0.5″stroke), which provide enough force and/or velocity to punch, rather than tear, a hole in a mask.

As shown in FIG. 38, a punch 378 driven by an air driven piston may generally supply enough force so that the piece removed from the mask material leaves an opening 376, and a chad 378. Clean openings in the mask are conducive to reliable fluid flow. Because the openings produced with the air cylinders are clean, the openings do not need to be made in the synthesizer itself allowing a separate mask-making machine to be developed. Other methods of making masks may also be used, e.g., plastic injection in a mold that creates holes in the proper locations, laser, air or drill-bit drilling, and the like.

FIGS. 39a and 39b show a side view and a top view, respectively, of another example of a mask-making apparatus 380 that punches holes in a mask using a punch and die positioned accurately with respect to one another is depicted. A set of specially made 384 such pairs may be used as described in FIGS. 39 and 40. The punch template 382 may sit above with a round or even slotted die 374 below the mask 38. The individual punches 384, die 374 and the mask 38 may sit on a linear motion drive 34 that moves them beneath an array of, e.g,, 16 air cylinders 386. For example, a ball-screw linear motion table 34 with the same characteristics (or even the same) as that used on the mask-based synthesizer itself may provide the linear motion. The individual air cylinders 388 may be spaced such that each one of them it positioned above one of the 16 rows of the 384-well plate. This positioning reduces the number of individual air cylinders 388 and reduced the number of electronic components and software needed to actuate the air cylinders and create the holes.

FIG. 41 is a flow diagram 400 of the program that may control the mask-making machine. The program starts at 402 by reading in the description of all 384 oligos and determining a synthesis sequence at 404. Following this step, the highest-level loop 406 begins that loops over the bases of the synthesis sequence by determining the next base in the sequence at 408 and determining if synthesis is complete at 410 which ends the synthesis at 412. This loop starts by moving the punch at 414, die and mask to the home position that allows the user to remove the mask that has just been punched and put a new, unpunched mask, in its place. The loop over table positions, indexed by the variable i, then begins at 416. Once the loop is completed it begins for a new mask (i.e., for a new base in the highest level loop) at 418. For each new base the punch at 418 directs die and mask are put into a number of table positions at 420 and at each one some of the air cylinders are actuated at 422 leading to a hole being put in the mask.

Algorithms used to determine the synthesis sequence. The process and system described herein may be modified to plates of any well number and configuration. A wells arranged in an (n×m) array, a 16×24 array of wells (i.e., the arrangement of a 384 well plate) is discussed in the following examples. All of the flowcharts discussed below aim to solve the same basic problem, namely, to minimize the total synthesis time. Minimization is accomplished by reducing the total number of coupling steps, which in turn reduces the total number of cycles (deblock, couple, cap, oxidize) and thus the total synthesis time. The problem all the systems will generally need to address are described in the following example.

A 384-well plate will include an oligo sequence completely unique from every other oligo in the plate. In this example all sequences are made up of the four phosphoramidites A, G, C and T. Only certain wells will be deblocked before phosphoramidites are delivered because only certain wells sit below a hole in a mask.

Wells that have not been deblocked do not react with the phosphoramidites. The phosphoramidites are delivered to the plate in any order, although they will be delivered one at a time. When a phosphoramidite is delivered, it is delivered to every well of the plate.

The sequence that minimizes the total number of coupling steps required for the synthesis run, referred to as the ideal sequence, is some arbitrary sequence of the bases A, G, C and T (e.g., AAGTCCTG AAAATC . . . ). To find the ideal sequence requires solving an n-p complete problem. One solution for this problem is an empirical one, that is, every possible sequence must be tested, which is a time consuming problem. In this example, the total number of possibilities that need to be tested is on the order of 4⁶⁰ approximately 3×10³⁶ (it may be less, because AAAAAAA . . . AA, GGGGGGG . . . GGG, etc., are generally not found in natural target sequences except when directed to, e.g., poly T tails).

A simple way to determine the phosphoramidites addition sequence (refer to herein as the “naive” algorithm) is to add every oligomer's first base, then every oligomer's second monomer, e.g., a nucleotide base, etc. That is, all 384 oligomers could be polled; all those whose first base is, e.g., an A could be deblocked and then A phosphoramidite could be delivered (FIG. 42a). Following this, all those oligos whose first base is a G could be deblocked. The number of oligos that are polled has decreased because roughly ¼ of them just received an A and then G phosphoramidite could be delivered. This routine is followed for all oligos whose first base is a C and a T. Next, all wells whose second base is an A are deblocked and then A phosphoramidite could be delivered, all wells whose second base is a G could be deblocked and then G could be delivered, etc. Using the naive algorithm the order in which the 4 phosphoramidites are delivered to the plate is immaterial (i.e., AGCT, AGTC, ACGT, etc.) because there is absolutely no time advantage of doing one over the other; they all take the same number of steps.

An improvement to the above algorithm is to add the n^{th} base to some oligos while at the same time adding the m^{th} to another (FIG. 42b). This method begins the same way that the naive algorithm. All the oligos are polled and all those whose first base is an A are deblocked and then A is delivered. Next, all 384 oligos are polled to determine which wells need a G. For some of these wells G will be their first base but for some (some of those whose first base was an A) it will be their second base. Unlike the “naive” algorithm, the order in which the phosphoramidites are added is now very important and leads to different numbers of steps required to complete a synthesis run.

Both the time taken for the determination of the order of the holes in the mask and the making of the actual mask will generally be less that the synthesis time for monomer addition if maximum throughput is desired. Making the mask will be done generally while the synthesizer is running with a set of masks made previously (i.e., parallel processing) or even concurrently. For example, if the time to punch a single mask is on the order of 2 minutes, while the synthesizer will require on the order of 15 minutes to go through the process of adding one base (deblock, couple, cap, oxidize and the associated washes), then the system is operating in an efficient manner. That is, (15−2)/(15)=0.867=86.7% of the synthesis time can be used to make calculations of the best possible sequence. The other 11.3% will be used to so that they will be ready to go as soon as the synthesis run that is proceeding while the calculations are being made is finally finished. This relation may be expressed with the formula:

Time to make the calculations=Time to complete the synthesis run+Time to make the set of masks

“Best Sequence”. Another process that may be used in the “best sequence” algorithm used to empirically test repeating cycles using 24 permutations (4!=4*3*2*1=24) of the 4 phosphoramidites to find the one that minimizes the total number of steps in the synthesis process. That is, the algorithm determined the number of steps (by working all the way through the synthesis order in silico) required to complete a synthesis run if the phosphoramidites were delivered in the order AGCT AGCT AGCT . . . or AGTC AGTC AGTC . . . or . . . TCGA TCGA TCGA . . . . Studies performed so far have always led to at least one of these sequences requiring less steps (sometimes by only one or two steps) than that determined from a 1-base “greedy” algorithm (described hereinbelow). Using more that one processor or a dedicated digital signal processor allows more than one algorithm to be tested to determine the minimum number of masks required. These may even be preprocessed and the mask-making apparatus used to create the masks before they are needed, that is, they may be pre-punched and stored for later use.

The above permutations all contain the minimal number of phosphoramidites to work correctly, namely, each one contains 1 A, 1 G, 1 C and 1 T. An extension of this system is to test cycles that include more bases. Cycles that include AAGCT, GAGCT, CAGCT and TAGCT (i.e., 1 A, 1 G, 1 C, 1 T plus one more of either A, G, C or T) may also be pre-tested. The advantage of multiple base scans is that certain permutations may work better than any of the 24 permutations described previously. Another disadvantage is the increase in the number of permutations. For example, each of the 5 base cycles listed have 60 permutations ([5!]/[(2!)(1!)(1!)(1!)]), thus a total of 240 permutations (ten times as many as the permutations of 4 bases), which must be tested with only one more base having been added to the cycle. Going up to all 6 base permutations increases the total number to 2,640.

FIG. 43 is a flow diagram of the “best sequence” algorithm 440 for use with the present invention. “Best sequence” begins at 442 by reading in the description of all 384 oligos from a text file and setting up an array (named pq) at 444, which contains all the possible permutations of the bases A, G, C and T (see FIG. 44) with a two counter set to zero at 446. Each of these permutations may have two elements associated with them, one to record the number of cycles required to complete synthesis and the second for the number of bases deblocked while going through these cycles. The former is used when deciding which sequence to use while the latter is used as a simple check that the calculations have been performed correctly; that is, each cycle should lead to the same number of bases being deblocked.

The main body of the algorithm may include three loops. The first loop 448 is controlled by the collection of n_first, n_second, n_third and n_fourth, the second loop by the variable row 450, and the third loop by the variable col (or column) 452. The variables: n_first, n_second, n_third and n_fourth, are the number of wells that need the bases listed in the first, second, third and fourth columns of the row^{th} row of array pq respectively at 454. When all of these are zero at 456 the permutation on the row^{th} row has been completely tested (466, 468) and the next one can be tested. The variable col loops over the 4 columns (458, 460) of the array pq while row loops over all 24 rows of the array pq (462, 464). Once all 24 rows of the array have been tested (470, 472 and 474) the algorithm is finished at 476 and the sequence that requires the smallest number of cycles (i.e., based on the value in the 5^{th} element of pq) is used. The algorithms shown in FIGS. 43 and 44 do not account for zeros in the sequence, these are removed later.

“Greedy”. Unlike the “best sequence” method described above, greedy algorithms do not empirically test predetermined cyclic sequences to minimize the total number of steps in the synthesis cycle. Instead, “greedy” algorithms maximize the total number of coupling reactions over some number of base deliveries. For example, the simplest greedy algorithm, the 1-base greedy algorithm, maximizes the total number of coupling reactions that occur during one base delivery. That is, to decide which base to deliver on a given step, the 1-base greedy algorithm counts the number of coupling reactions that would occur if an A was delivered, a G was delivered, a C was delivered or a T was delivered. The base that leads to the maximum of number of coupling reactions is the next base added.

In general, an n-base greedy algorithm considers the number of coupling reactions that take place on the next n steps where n=1, 2, 3 . . . . To consider the number of coupling reactions, the number of coupling reactions for 4ⁿ permutations of the bases A, G, C and T must be considered. For example, the 2-base greedy algorithm counts the number of coupling reactions that would take place if bases were added in each of the 16 (=4²) sequences AA, AG, AC . . . TT (see FIGS. 45 and 46). The permutation that yields the maximum number of coupling reactions is the one that is used or implemented. The number of sequences that must be counted grows very quickly as a function of n and finally becomes the problem of finding the ideal sequence. A difference between a 1-base and a 2-base greedy algorithm is that maximizing the total number of coupling reactions over two base deliveries may require delivering a base that is not in the majority on the first pass. This is most easily illustrated with an example.

In FIGS. 45 and 46 a comparison of a 1-base and a 2-base greedy algorithm for adding two bases to a set of 6 oligos is shown. Using the 1-base greedy algorithm technique G is added on the first pass and an A is added on the second. A total of 7 coupling reactions take place. The 2-base greedy algorithm tests all the possible 2-base permutations (6 of which are shown in FIG. 46b) and determines that using a prescription of adding A and then G leads to total of 8 coupling reactions. Thus, the 2-base greedy algorithm performs more coupling reactions in 2 steps than the 1-base greedy algorithm, but had to test more possibilities.

The number of coupling reactions (that which is maximized in all the above discussions) and the number of unique oligos that participate in those reactions is not the same. Consider the “A→G” coupling sequence of FIG. 46. When the first base is delivered 2 coupling reactions occur. When the second base is delivered, 6 coupling reactions occur but only 4 of these occur on oligos that were not coupled during the first base delivery. Thus, the total number of coupling reactions that take place over the 2 steps is 8 (2 during the first base delivery and 6 during the second) but the total number of unique oligos that get coupled is 6 (2 during the first base delivery and 4 during the second). It is seen that two of the sequences tested by the 2-base greedy algorithm (A→G and G→A) lead to 6 oligos participating in coupling reactions, the maximum possible number for this example.

Though the 2-base greedy algorithm requires more processing it often reduces the number of masks needed to produce an array and, therefore, reduced synthesis time. The sequences considered by an n-base algorithm are also all considered by an (n+1)-base algorithm. For example, the 2-base sequence determined using the 1-base greedy algorithm (G→A) is one of the16, 2-base permutations tested by the 2-base greedy algorithm. Among the 4⁴=256 combinations of A, G, C and T (AAAA, AAAG, AAAC, . . . , TTTT) that the 4-base greedy algorithm considers are the 4!=24 sequences tested by the “best sequence” algorithm (AGCT, ACTC, . . . , TCGA). The difference is that the “best sequence” algorithm only tests permutations that include all four bases while a 4-base greedy algorithm tests all possible permutations of the 4 bases. This difference may prove to be a more powerful technique than the “best sequence” algorithm. Instead of the 4×24=96 simulated base additions per 4 base deliveries of the “best sequence” algorithm the 4-base greedy algorithm requires 4×256=1024 (=10.7×96).

The flow diagram of the 1-base greedy algorithm 500 is shown in FIG. 47. The 1-base greedy algorithm starts at 502 by simply reading in the description of all 384 oligonucloetides from a text file at 504 and sets-up the variable and a counter at 506 and 508. The main body includes a single loop 510 that determines which base is needed by the maximum number of oligos 512 followed by electronic delivery of that base (514, 516, 518, 520). The process is repeated until all the oligos have been synthesized 522 and ends 524. Although this method leads to fewer steps in the synthesis process than the naive algorithm, it has been determined empirically that the “best sequence” algorithm very often surpasses it, often by a base or two.

FIG. 48 shows a flow chart 600 for the 2-base greedy algorithm. This process is a hybrid between the “best sequence” and 1-base greedy flow charts. To begin, all 384 oligo sequences are read in from a text file at 604 and all 16 (=4*4) possible 2 base permutations are listed in an array named my_possibilities at 608 with a counter set at 610. The main body of the algorithm includes 2 loops. The first loop 612, determines which 2 base permutation maximizes the total number of couplings. Loop 612 is nested inside another loop 614 that electronically delivers these bases to the array and then adds them to the synthesis sequence. This process is repeated until all the oligos are synthesized.

Representative Sequences. The ways to determine the synthesis sequence may be broken into two groups. In the first group the number of cyclic permutations are empirically tested (“best sequence”). In the second group the number of coupling reactions that occur over some number of steps are counted (“greedy”). Those of skill in the art will appreciate that these are just two methods of selecting the synthesis order out of the large number of possible sequences. In fact, any sequence order is a possibility that can be tested. Along these lines, the sequence of each of the 384 oligos on the 384-well plate can themselves be tested as potential synthesis orders. The advantage of this method is that using one of these sequences will get rid of at least one oligo (perhaps others with a shorter length). That is, the oligo whose sequence is used will be completely synthesized after running through this synthesis order. A synthesis order for the “leftover” sequences of the oligos that were not completely synthesized may then be used. The synthesis sequence may be the sequence of the longest remaining fragment or it can be found using some method such as the “best sequence” or greedy algorithm.

Branching. In the discussions of both the “best sequence” and “greedy” algorithms it was always assumed that the sequence (or base(s)) that maximized the total number of coupling reactions for a given set of steps would be chosen as the sequence to use for that set of steps. Yet another alternative is to branch the synthesis sequence determination for every sequence that has this maximum value, e.g., for every sequence whose total number of steps is within some small percentage of the maximum. For example, using a 1-base greedy algorithm to determine the synthesis sequence for 384 oligos, on the mth step it is found that the number of coupling reactions that will be performed with an A, G, C and T are 115, 45, 115 and 109 respectively. The greedy algorithm selects the base that maximizes the total number of coupling reactions as the next base, but it cannot choose only one base because both A and C have the “maximum” value of these numbers. To deal with this the determination of the synthesis sequence now “branches,” that is, two synthesis sequences are now considered. These sequences are identical in their first (m−1) bases but differ in the m^{th}, one has an A and the other a C. This discrepancy may occur again on one branch without it occurring on the other branch and then three synthesis sequences would be under consideration at once. This procedure is not limited to a 1-base greedy algorithm, branching can be used with any type of synthesis ordering algorithm.

Clustering. Maximizing the total number of coupling reactions that takes place during a single step does not always lead to the synthesis sequence with the smallest number of steps (for example, the comparison of the “best sequence” and 1-base greedy algorithms). It may be beneficial to ensure that none of the oligos ever become drastically shorter or longer than any of the others by “clustering” all the oligos into m groups based on lengths. The lengths of the oligos in the i^{th} group (i goes from 1 to m) would be between the following values:

$$Length of the shortest + ( i - 1 ) * \frac{\begin{matrix}Length of the longest - \\ Length of the shortest\end{matrix}}{m}$$

$$Length of the shortest + i * \frac{\begin{matrix}Length of the longest - \\ Length of the shortest\end{matrix}}{m}$$

wherein “Length of the shortest (longest)” is the length of the shortest (longest) oligo in the population of all 384 oligos. If the number of oligos in any of these groups ever becomes significantly larger that ¼ of the total number of oligos then the base which would lead to the most of them heading out of this group and into one of the ones that presumably have fewer than ¼ of the oligos (they must have come from somewhere) would be chosen as the next base in the sequence.

Uniqueness. All of the algorithms that have been discussed have been may be used for general design purposes in which the addition sequence for each well is completely unique from one another. In practice, however, this may not be the case. Significant (approximately 20 out of 40 bases) lengths of each and every oligos may be completely identical. The ideal sequence to use for this length is thus known, e.g., 20 identical bases. The lack of uniqueness may be exploited by separating the process of finding the synthesis sequence into two parts; that which includes finding the sequence for the sections of the oligos that are common to all the oligos and those that include finding the sequence for the parts of the oligos that make them unique. For the later, any of the algorithms for finding a synthesis sequence discussed above (i.e., “best sequence”, 1-base greedy, etc.) can be used.

Mask-Changing Machine

Another aspect of the present invention is a “mask-changing” apparatus that positions masks into different positions during a synthesis run. The “mask-changing” apparatus performs two basic duties: (1) just prior to the flood steps that require a mask (the “mask-required” steps—i.e., either flooding deblock or flooding phosphoramidite), the “mask-changing” apparatus puts a mask in place on the plate; and (2) after the “mask-required” steps are performed the “mask-changing” apparatus removes the mask from the car.

The detailed mechanism for “mask-changing” depends on the design of the mask. If the masks are soft and are delivered to the synthesizer as a piano-roll (see section on masks) then an accurate rotation table may be used for positioning the mask. In one embodiment that uses hard masks (e.g., individually molded pieces of rigid material), the hard mask is positioned by a “mask-changing” apparatus that picks up a single mask from a stack of new (unused or recycled) masks, delivers it to the plate and pushes the mask into place on the plate. Removal of the mask is accomplished by picking the mask up and placing it on a stack of used masks.

FIGS. 49a and 49b show side views of a “mask-changing” apparatus 700, which includes: two, orthogonal, linear motion tables 702 and 704 (y and z) situated on a gantry 706 above the x-table 708 that shuttles the synthesis plate 710 back and forth under the injector manifolds 712. The y and z tables (702, 704) are used to position a “vacuum-mass” 714 (see also FIG. 50). The vacuum-mass 714 serves generally two purposes; to hold a mask 716 as it is being moved from one place to another and to press the mask 716 into the plate 710 causing it to form a good seal with the plate 710. In one embodiment the vacuum-mass 714 picks up a mask 716 by pulling vacuum on top of the wings of the mask 716 (the parts of the mask outside the 384 divots). To press the mask 716 onto the plate 710, the vacuum-mass 714 sits down on top of the mask 716 so that the full-weight of the vacuum-mass 714 is supported by the mask 716. The vacuum-mass 714 simulates the technique used to seal the mask 716 by hand. Other methods may be used, e.g., using a commercially available air cylinder to press the mask 716 down or conversely to suck it down onto the plate 710 surface.

As discussed in the section on masks, when the divots of the mask are pressed into the wells of the plate they deform slightly, which leads to a good seal between the mask and the plate. When the mask is positioned securely it cannot be pulled off the plate using the vacuum available from the vacuum-mass 714. To address this issue, the plate may be redesigned so that it is in two pieces as shown in FIG. 50. The vacuum-mass 714 has two components, a mass 718 and a vacuum 720. In the two-piece embodiment the outer edge of the plate pushes the mask off the plate (i.e., it has vertical motion actuated by, e.g., air cylinders). Once the mask has been pushed off the plate the mask may be picked up by the vacuum-mass 714 and repositioned.

Synthesis

A number of parameters were identified that were needed to synthesis, e.g., oligonucleotides using the present invention. These design and implementation parameters were identified to determine if the machine was performing to specifications, namely: (1) did the method of flooding work for synthesizing DNA?; (2) did the mask seal properly (i.e., no cross-contamination observed)?; and (3) did reagent flow through the reaction wells?

During these studies it was determined that an optimal synthesis protocol based on an analysis of the trityl removed during the deblock steps (as indicated by the orange color observed during this step) and an analysis of post-synthesis Matrix Assisted Laser Desorbtion Ionization Mass Spectroscopy (MALDI) and High Performance Liquid Chromatography (HPLC) data could be used to track performance.

These test runs were categorized based on the method of synthesis being tested, e.g., mask-based, hybrid-based, magnetic CPG (MPG) and/or MPG-based. As already mentioned, the hybrid synthesizer differed from the mask-based machine in its method of delivering deblock. The former was used with a set of 16 individual valves to deliver deblock in the development of the mask-based machine. DNA was also successfully synthesized on MPG immobilized on a magnetic stir bar. A number of synthesis runs were performed including hybrid and MPG data.

Mask Based. The mask-based machine was tested either with or without masks. When masks are not used, deblock is flooded into every well of the 384-well plate (i.e., just like every other reagent), and 384 identical oligonucleotides result. The success of such studies proved that the method of flooding synthesis reagents may be used to synthesize DNA.

Without Masks. Synthesis runs without masks involved making poly T, the simplest oligo since T is the most stable of the four phosphoramidites. Oligos were made with a mixed sequence of A and T and then scaled up to making full (A, G, C and T) mixed sequence oligos. All of these studies involved making relatively short oligos, of approximately 12 bases, followed by approximately 33 mers and approximately 20 mers. Finally, a commonly used 27 mer (PCR primer) was synthesized and tested for functionality. Oligos may even be synthesized without masks after a few hardware modifications, e.g., by adding Y and Z tables, changing the fluidic lines, etc. Synthesis without masks is useful for high throughput commercial synthesis of, e,g., universal primers.

Soft Masks. Using a 0.005″ Thickness Teflon™ Mask, holes were cut in the mask using a store-bought hole punch. While experiencing leakage problems and wicking between the mask and the plate, oligos having lower quality and consistency were made. Another example of a soft mask was a Teflon™ Coated Fiberglass Tape Mask. Yet another soft mask is a fiberglass backed Teflon™ tape (Cole Parmer, USA) was used as a mask in a synthesis run. Although some specificity was achieved (i.e., no cross contamination was observed in some locations), different masks (i.e., different pieces of tape) behaved differently. Furthermore, the adhesive on the tape eventually dissolved in deblock solution. The availability of adhesives that are both chemically resistant to deblock and that cure quickly will benefit the consistency and reliability of adhesive-backed soft masks.

DNA Analysis Technique. The oligonucleotides made may be tested using several techniques. One such technique is Matrix Assisted Laser Desorbtion Time of Flight Mass Spectroscopy (MALDI-TOF MS). MALDI is a very quick, accurate analytical device that is based on ionizing, and then accelerating, a sample in a vacuum tube. The longer an ionized sample (or analyte) takes to “fly” a given distance, the more massive it must be. MALDI is quick (96 samples may be analyzed in two hours), however, it does not produce quantitative data because the relative peak heights in the resulting spectrum do not imply relative amounts of the analyte to which those peaks correspond. Thus, the mass of the various analytes and, from that, the identity of that analyte in a sample, may be determined but the absolute amount of each cannot. The theoretical mass of a single stranded DNA sample is given by the following equation:

$$\begin{matrix}Theoretical mass ( amu ) = ( number of base A * 312.2 ) + \\ ( number of base T * 303.2 ) + \\ ( number of base C * 288.2 ) + \\ ( number of base G * 328.2 ) - 61\end{matrix}$$

Analyzing samples yielded a spectrum that contained a peak at a predetermined position, referred to as the “full-length product” (FLP) peak, sitting on top of a background of noise. Both errors during synthesis and impurities in the sample also lead to peaks in the data and, as a result, the resulting spectra often contain some of the following: (1) peaks in the spectrum that correspond to the mass of a piece of single stranded DNA that are shorter than the FLP are referred to as “n minuses” or “n-1's” (which result from incomplete deblocking or coupling of some bases during the synthesis process); and (2) peaks observed above the expected FLP peak (these are referred to as “n plusses” or “n+1's” and can result from contamination between wells during a deprotection step. For example, an improperly sealed mask can lead to deblock entering a well unintentionally. The oligo in that well is then deprotected and can couple on the next step). A peak 390.11 amu above the FLP peak if often observed in the spectra (these peaks may be due to some plastic additives present in the sample preparation containers). A peak at half the mass of the FLP can sometimes be observed in the data, which may result from some of the sample becoming doubly charged in the ionization process (MALDI spectra actually show the mass to charge ratio, not the mass). A peak at 23 atomic mass units above an oligo peak (FLP, n−1 or n+1) is consistent with a sodium adduct (the water uses during the sample preparation is purified and deionized, sodium is still present and may bind to the negatively charged oligonucleotides. These adducts are unfavorable and may be removed by mixing the samples with anionic exchange beads). Peaks observed at integer multiples of 56 amu above oligo peaks (FLP, n−1 and n+1) (these peaks may be due to beta-cyanoethyl adducts on the oligo and result from incomplete deprotection during post synthesis. These adducts inhibit PCR and the oligos may not be functional. Longer time and/or higher temperature are required to deprotect the oligos in ammonium hydroxide.).

The studies were calibrated using a standard of known mass, a 10 mer of poly-T synthesized on a Mermade synthesizer (CBI, Dallas, Tex.). Often, peaks in the spectra are slightly different from their expected theoretical value, which may be due to calibration error.

High Pressure Liquid Chromatography (HPLC). HPLC separate molecules based on their size. Unlike the data obtained from a mass spectrometer, HPLC data is quantitative and the exact amounts of the various analytes in a sample may be determined. The samples are dissolved in water and are passed through an anionic exchange packed column. The longer DNA strands take longer time to elute through the column. Typically, a 20-mer takes about approximately 25 minutes to analyze. HPLC is significantly slower than MALDI, however, with HPLC both n−1 s and n+1 s can be detected because this process does not involve ionization of the sample, peaks corresponding the ½ the FLP peak are not observed. Further, peaks at 390.11 above the FLP are never seen because of different sample preparation techniques. Finally, beta-cyanoethyl peaks will not be resolved in the HPLC spectrum.

FIG. 51 shows the placing of a mask on a plate using the mask changing apparatus as described in FIGS. 49a, 49b and 50. In FIG. 51a the starting condition is shown; the plate 710 is waiting for a mask 716 to be placed on top of the plate 710. In FIGS. 51-51d the vacuum-mass 714 moves to the stack of new masks 716 and retrieves the top one. The stack of masks 716 may be, e.g., on a spring-loaded platform 722 that always positions the top mask 716 at the same height. The mask 716 is moved to a position above the plate 710 and dropped in FIGS. 51e and 51f. In FIG. 51g the vacuum-mass 714 is shown sitting on top of the mask 716—the vacuum-mass 714 presses the mask 716 down onto the plate 710. FIG. (51h) shows the end of the process—the plate 710 has a mask 716 pressed onto it and is now on its way to the “mask-required” steps.

A similar chain of events may be used to remove a mask from the plate. FIG. 52a shows the starting condition for this process; the plate 710 with a mask 716 on top of itself is ready for the mask 716 to be removed. In FIG. 52b the edges of the plate 710 push the mask 716 off the plate 710. FIGS. 52c and 52d show the mask 716 being picked up off the plate 710 by the vacuum-mass 714. Finally, the mask 716 is moved to a position over the stack of used masks 724 and dropped in FIGS. 52e and 52f.

While the invention has been described in reference to illustrative embodiments, the description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An apparatus for combinatorial chemistry on a substrate comprising:
a manifold having one or more outlets positioned to deliver one or more chemicals to the substrate; and
a linear drive for moving the substrate below the manifold.

2. The apparatus of claim 1, wherein the manifold is defined further as comprising one or more outlets that form linear delivery spray heads.

3. The apparatus of claim 1, wherein the manifold delivers one or more chemicals for nucleic acid synthesis to the substrate.

4. The apparatus of claim 1, wherein the manifold delivers one or more chemicals for peptide synthesis.

5. The apparatus of claim 1, wherein the manifold delivers one or more chemicals for nucleic acid synthesis.

6. The apparatus of claim 1, wherein the manifold delivers one or more chemicals for oligomer synthesis.

7. The apparatus of claim 1, wherein the manifold is further defined as one or more manifolds comprising:
an acetonitrile manifold;
an oxidizer manifold;
a capping reagent manifold;
one or more monomer manifolds; and
a deblock manifold.

8. The apparatus of claim 1, further comprising a mask containing one or more holes positioned between the manifold and the substrate.

9. The apparatus of claim 1, wherein the substrate comprises a chemically nonreactive material.

10. The apparatus of claim 1, wherein the substrate comprises Delrin.

11. The apparatus of claim 1, wherein the substrate comprises Polyethylene.

12. The apparatus of claim 1, wherein the substrate comprises Fiberglass.

13. The apparatus of claim 1, wherein the substrate comprises Glass Micro-fiber filter (GMFF).

14. The apparatus of claim 1, wherein the substrate comprises a material coated with a chemically non-reactive coating.

15. The apparatus of claim 1, wherein the substrate comprises a top surface and wherein the top surface is slanted.

16. The apparatus of claim 1, wherein the substrate comprises one or more wells.

17. The apparatus of claim 1, wherein the substrate comprises a multi-well plate.

18. The apparatus of claim 1, wherein the substrate comprises a multi-well filter plate.

19. The apparatus of claim 16, wherein the one or more wells of the plate further comprise a slanted interior edge.

20. The apparatus of claim 16, wherein the plate is further define as a multi-well filter plate and comprises:
a top and a bottom plate containing one or more wells; and
a semi-permeable membrane positioned between the top and bottom plates.

21. The apparatus of claim 16, wherein the wells comprise a slanted cross-section.

22. The apparatus of claim 16, wherein the wells comprise a slanted cross-section and a frit.

23. The apparatus of claim 16, wherein the wells comprise first and second slanted portions.

24. The apparatus of claim 16, wherein the wells comprise first and second slanted portion, and wherein at least one frit is fixed within the first or second slanted portion of the well.

25. The apparatus as in claim 16, wherein each of the one or more wells further comprise a synthesis substrate.

26. The apparatus of claim 1, further comprising a computer connected to and controlling the linear drive.

27. The apparatus of claim 1, further comprising one or more chemical reservoirs in fluid communication with one or more manifolds.

28. The apparatus of claim 1, further comprising a computer connected to and controlling one or more valves that control the flow of fluid between the one or more chemical reservoirs with the one or more manifolds.

29. The apparatus of claim 1, further comprising:
one or more chemical reservoirs in fluid communication with the one or more manifolds; and
one or more valves control the flow of fluid from the chemical reservoirs to the one or more manifolds.

30. The apparatus of claim 1, further comprising a mask positioned between the manifold and the substrate.

31. The apparatus of claim 30, wherein the mask positioned between the manifold and the substrate is layered on the substrate.

32. The apparatus of claim 30, wherein a mask is positioned further comprises one or more through-holes generally over one or more reaction sites of the substrate.

33. The apparatus of claim 30, wherein the mask comprises Teflon™.

34. The apparatus of claim 30, wherein the mask comprises Teflon™ between 0.002 and 0.25 inches thick.

35. The apparatus of claim 30, wherein the mask comprises polyethylene.

36. The apparatus of claim 30, wherein the mask comprises fiberglass.

37. The apparatus of claim 30, wherein the mask comprises Delrin.

38. The apparatus of claim 30, wherein the mask comprises polypropylene.

39. The apparatus of claim 30, wherein the mask comprises single-sided Teflon™ tape.

40. The apparatus of claim 30, wherein the mask comprises molded polypropylene and further comprising divots that generally match one or more wells of a substrate.

41. The apparatus of claim 30, wherein the mask comprises molded polyethylene and further comprising divots that generally match one or more wells of a substrate.

42. The apparatus of claim 30, wherein the mask comprises a magnetically attractive material.

43. The apparatus of claim 30, wherein the mask comprises an electrostatic charge opposite an electrostatic charge on the substrate.

44. The apparatus of claim 1, further comprising a vacuum in communication with the substrate.

45. The apparatus as in claim 1, wherein the substrate comprises one or more reactive group protected from a chemical reaction by one or more removable protecting groups.

46. The apparatus of claim 45, wherein the one or more removable protecting groups is removed by addition of a deblocking reagent.

47. The apparatus of claim 45, wherein the substrate comprises one or more monomers for nucleic acid synthesis.

48. The apparatus of claim 45, wherein the substrate comprises one or more monomers for peptide synthesis.

49. The apparatus of claim 45, wherein the substrate comprises one or more monomers for peptide nucleic acid synthesis.

50. The apparatus of claim 45, wherein the substrate comprises one or more monomers for carbohydrate synthesis.

51. The apparatus of claim 45, wherein the substrate further comprises a linker.

52. The apparatus of claim 45, wherein the substrate comprises a small molecule library.

53. The apparatus of claim 1, wherein the substrate comprises 6, 12, 48, 96, 384, 864, 1,536 or more reaction sites.

54. The apparatus of claim 1, wherein the substrate is rectangular.

55. The apparatus as in claim 1, wherein substrate comprises one or more wells, and the one or more wells are canted.

56. An apparatus for combinatorial chemistry comprising:
a substrate comprising one or more reaction sites;
a mask positioned on the substrate;
a one or more manifolds positioned to deliver one or more chemicals to at least a portion of the substrate; and
a linear drive for moving the substrate and the mask below the one or more linear manifolds.

57. An apparatus for combinatorial chemistry comprising:
a substrate comprising one or more reaction sites;
a mask comprising one or more through holes positioned generally over the one or more reaction sites of the substrate;
a one or more linear manifolds positioned to deliver one or more chemicals to the substrate;
a linear drive for moving the substrate and the mask below the one or more linear manifolds; and
a vacuum below the one or more reaction sites of the substrate.

58. An apparatus for synthesizing oligomers comprising:
a substrate comprising one or more reaction sites;
a mask comprising one or more through holes positioned generally over the one or more reaction sites of the substrate;
one or more linear manifolds positioned to deliver one or more chemicals to the substrate comprising:
an acetonitrile manifold;
an oxidizer manifold;
a capping reagent manifold;
one or more monomer manifold; and
a deblock manifold;
a linear motion table that moves the substrate and the mask below the one or more manifolds; and
a vacuum below the one or more reaction sites of the substrate.

59. A method for controlling a chemical reaction in one or more reaction sites protected by a mask comprising the steps of:
positioning a mask comprising one or more wells over a substrate comprising one or more reaction sites;
flooding a deblock reagent over the surface of the mask, wherein the deblock reagent will only enter unmasked reaction sites;
removing the mask;
flooding a mix of activator and one reactive monomer into all reaction sites;
flooding a mix of cap A and B reagents into all reaction sites;
flooding and oxidizing reagent into all reaction sites; and
repeating the above steps for the other reactive monomers.

60. A method for controlling a chemical reaction in one or more reaction sites protected by a mask comprising the steps of:
(a) flooding a deblock reagent into all the reaction sites of a substrate;
(b) positioning a monomer-specific mask for a specific monomer over a substrate;
(c) flood a specific monomer and activator over the substrate, wherein only those reaction sites with open holes in the mask will receive one or more specific monomers;
(d) removing the mask; and
(e) repeating steps (b) through (d) for each specific monomer;
(f) flooding a mix of cap A and B reagents into all reaction sites; and
(g) flooding an oxidizing reagent into all reaction sites.

61. A mask for chemical synthesis comprising:
a non-reactive sheet having a top and a bottom surface;
one or more through-holes that form an array that generally match the position of one or more wells of a substrate.

62. The mask of claim 61, wherein the substrate comprises a multi-well plate.

63. The mask of claim 61, wherein the substrate comprises a multi-well filter plate.

64. The mask of claim 61, wherein the mask comprises a substantially chemically non-reactive material.

65. The mask of claim 61, wherein the mask comprises a Teflon™-coated polymer.

66. The mask of claim 61, wherein the mask comprises polyethylene.

67. The mask of claim 61, wherein the mask comprises fiberglass.

68. The mask of claim 61, wherein the mask comprises Delrin.

69. The mask of claim 61, wherein the mask comprises polypropylene.

70. The mask of claim 61, wherein the through-holes are further defined as having one or more nozzles on the bottom surface.

71. The mask of claim 70, wherein the through-holes are further defined as having one or more nozzles on the bottom surface, wherein the nozzles have an angle that matches the angle of the wells in the multi-well plate.

72. The mask of claim 70, wherein the through-holes are further defined as having one or more nozzles on the bottom surface, wherein the nozzles have an angle that is more than the angle of the wells in the multi-well plate.

73. The mask of claim 70, wherein the through-holes are further defined as having one or more nozzles on the bottom surface, wherein the nozzles have an angle that is less than the angle of the wells in the multi-well plate.

74. A method of determining synthetic order of monomer addition comprising the steps of:
determining the synthesis order for the addition of a specific monomer;
deciding whether a mask is to be positioned on a substrate;
moving the substrate to a preselected position for chemical addition;
adding a specific monomer;
washing the substrate; and
repeating the above steps if another monomer is to be added.

75. The method of claim 74, wherein the step of catalyzing the addition of a monomer is defined further as comprising the steps of:
performing a deblock step;
putting on a mask to protect sites in which a monomer will not be added;
delivering one or more monomers;
performing a capping steps and performing an oxidizer step.

76. A method for producing polymers comprising the steps of:
placing a reactive compound on one or more reaction sites of a substrate;
protecting one or more reaction sites of a substrate with a mask; and
controlling a chemical reaction in the one or more reaction sites not protected by the mask.

77. The method of claim 76, wherein the step of controlling a reaction is defined further as not deblocking the reactive compound

78. The method of claim 76, wherein the step of controlling a chemical reaction comprises the steps of:
flooding a deblocking reagent over the surface of the mask;
flooding a coupling reagent over the surface of the mask, wherein the coupling reagent comprises one or more reactive compounds;
flooding a capping reagent over the surface of the mask; and
flooding oxidizing reagent over the surface of the mask.

79. The method of claim 76, wherein the one or more reactive compounds are defined further as phosphoramidite comprising compounds.

80. The method of claim 76, wherein phosphoramidite comprising compounds include one or more protected phosphoramidite nucleic acid bases A, G, C, T, U or derivatives thereof.

81. The method of claim 76, wherein chemical reaction is the addition of one or more monomers for carbohydrate synthesis.

82. The method of claim 76, wherein chemical reaction is the addition of one or more monomers for nucleic acid synthesis.

83. The method of claim 76, wherein chemical reaction is the addition of one or more monomers for peptide synthesis.

84. The method of claim 76, wherein the capping agent further comprises a cap A and a cap B reagent and wherein they acetylate unreacted termini.

85. A method of determining the mask pattern for monomer addition comprising the steps of:
reading the sequence of one or more monomer sequences;
setting up an array that contains all the possible permutations of the monomers wherein each of these permutations having a first and a second element, wherein the first element records the number of cycles required to complete synthesis and the second element records the number of monomers to be deblocked;
selecting a variable number that equals the total number of required monomers types;
selecting a second variable that contains the total number of wells; and
testing the array for the minimum number of masks that are required to complete all the monomer additions; and
selecting the array that contains the minimum number of masks.

86. The method of claim 85, further comprising the step of pre-determining areas with sequences in common within the sequences of the one of more monomers and preparing masks for those areas of with sequences in common independent from the determination of the array.
